(19) United States
(12) Patent Application Publication
(10) Pub. No.: US 2026/0368717 A1
(43) Pub. Date: Nov. 19, 2026

(54) SYSTEMS AND METHODS FOR MULTI-STRATEGY DIGITAL ASSET YIELD MANAGEMENT USING OPTIMIZED ALLOCATOR VAULTS

(71) Applicant: Omni Ltd., Hamilton (BM)

(72) Inventors: Philip Zudemberg, Hamilton (BM); Max Shean, Hamilton (BM); Serafin Lion Engel, Hamilton (BM); Apurv Mishra, Hamilton (BM)

(21) Appl. No.: 19/676,363

(22) Filed: May 13, 2026

Related U.S. Application Data
(60) Provisional application No. 63/805,898, filed on May 14, 2025.

(51) Int. Cl. G06Q 20/36; G06Q 20/38

(52) U.S. Cl. CPC G06Q 20/367; G06Q 20/389

(57) ABSTRACT

Systems and methods are disclosed for managing digital assets using a multi-strategy allocator vault. A vault core receives deposits of a deposit asset, mints vault shares, maintains an idle-asset balance and records of strategy positions, and determines total asset value from idle assets and redeemable values of assets deployed to multiple approved yield-generating strategies. A strategy interface registry can include native interfaces and wrapper-based interfaces for heterogeneous strategies. A rebalance routine determines target strategy-position values and, subject to guardrails, withdraws value from over-allocated positions and deposits value into under-allocated positions. The system can also harvest and convert reward assets, realize fees by minting additional vault shares, process withdrawals including delayed-liquidity withdrawals using pending withdrawal records, and maintain cross-chain settlement records that preserve an accounting relationship between issued shares and managed asset value across multiple blockchain networks.

### CROSS-REFERENCE TO RELATED APPLICATIONS

This application claims the benefit of U.S. Provisional Patent Application No. 63/805,898, filed May 14, 2025, the disclosure of which is incorporated herein by reference in its entirety.

### FIELD OF INVENTION

The present disclosure relates generally to digital asset management systems and, more particularly, to systems and methods for dynamically managing and reallocating tokenized assets across disparate strategies.

### BACKGROUND

Digital asset users increasingly seek automated systems that can deploy deposited assets into one or more yield-generating strategies, such as lending, staking, liquidity provisioning, market making, structured products, or other on-chain or off-chain financial arrangements that can produce a return.

Existing systems often suffer from fragmentation, because different strategies may expose different interfaces, may operate on different blockchain networks, may report value using different conventions, and may offer different liquidity profiles, reward structures, and operational constraints. As a result, users and operators frequently can manage multiple positions manually, track disparate redemption mechanics, and determine asset allocation using incomplete or inconsistent data.

Existing yield-aggregation arrangements may also fail to provide a reliable framework for valuing heterogeneous positions in a common unit, comparing current allocations against desired allocations, and performing rebalancing in a manner that respects execution constraints such as slippage, stale data, movement limits, whitelist restrictions, and capacity limitations.

Further, some strategies provide immediate liquidity while others impose cooldown periods, queue periods, notice periods, asynchronous settlement periods, or other delays before tokens can be redeemed. Conventional vault arrangements may inadequately handle such delayed-liquidity conditions, thereby causing poor user experience, inaccurate accounting, or unpredictable settlement timing.

Cross-chain deployment introduces additional complications. A user may prefer to deposit on one network while value is deployed to a strategy on another network. Conventional systems often fail to maintain a coherent accounting relationship between issued vault shares and value deployed across multiple chains while also addressing message verification, settlement records, and orderly returns of value for withdrawal or rebalance.

Accordingly, there remains a need for improved systems and methods that provide a unified vault architecture for digital asset deposits, share-based accounting, heterogeneous strategy integration, guarded rebalancing, delayed-liquidity withdrawal handling, reward harvesting and reinvestment, and optional cross-chain coordination.

### SUMMARY

The present disclosure provides systems and methods for dynamically managing and reallocating tokenized assets across disparate strategies.

In an example embodiment, a digital asset management system is provided. The system can include one or more processors and memory storing instructions. The instructions, when executed by the one or more processors, cause the one or more processors to obtain, at a vault, a request to transfer a number of tokens for a user from a user device and a set of parameters specific to the user. The instructions further cause the processors to generate a first smart contract to transfer the number of tokens from a wallet associated with the user device and a wallet associated with the vault, and append a blockchain to include information relating to the first smart contract.

The instructions further cause the processors to mint a number of vault tokens that correspond to the number of tokens deposited by the user and a first value for the number of tokens, and append the blockchain to include the number of minted vault tokens. The instructions further cause the processors to assign a first portion of the tokens to be held in an idle asset balance at the vault and a second portion of the tokens to be deployed via one or more strategies based on the set of parameters specific to the user. The instructions further cause the processors to determine a subset of the second portion of the tokens to be deployed according to each of the one or more strategies, each of the one or more strategies having a target value for the subset of the second portion of the tokens to be deployed for each strategy.

The instructions further cause the processors to, for each determined strategy, generating a second smart contract for the subset of the second portion of tokens to be deployed according to each strategy, and appending the second smart contract to the blockchain. The instructions further cause the processors to continuously monitoring each of the determined strategies to determine whether a triggering event is present.

The instructions further cause the processors to, responsive to determining that a triggering event is detected for a first strategy, determine whether the first strategy is within a set of reallocation guidelines. If the first strategy is within the reallocation guidelines, the instructions further cause the processors to generate a third smart contract to disassociate the subset of the second portion of tokens associated with the first strategy, and append information relating to the third smart contract to the blockchain. If the first strategy is not within the reallocation guidelines, the instructions further cause the processors to deny reallocation of the subset of the second portion of tokens associated with the first strategy.

In some instances, the instructions further cause the processors to record the number of tokens, the first smart contract, and the number of vault tokens to a vault record, responsive to generating the second smart contract, update the vault record to include the second smart contract, and responsive to generating the third smart contract or determining that the first strategy is not within the reallocation guidelines, update the vault record to include the third smart contract or information relating to the denial of the reallocation of the first strategy.

In some instances, the triggering event comprises a determination that any of the determined strategies has a value that exceeds a target value threshold or determining that any of the determined strategies have one or more risk parameters that exceed a threshold.

In some instances, the set of reallocation guidelines include whether a slippage amount exceeds a threshold or whether a reallocation of the subset of the second portion of tokens exceeds a threshold percentage of tokens relative to a total of the number of tokens.

In some instances, the instructions further cause the processors to generate a strategy interface registry that stores a number of interfaces for each strategy, wherein at least one of the interfaces comprises a wrapper or adapter exposing a standardized valuation or redemption instructions for any strategy lacking a native standardized vault interface.

In some instances, the instructions further cause the processors to obtain a number of reward tokens from any of the one or more strategies, mint a new set of vault tokens that corresponds with the number of reward tokens, and append the blockchain to add the new set of vault tokens to the blockchain.

In some instances, the instructions further cause the processors to store the number of reward tokens to the idle-asset balance or identifying any of the one or more strategies to deploy the number of reward tokens based on the set of parameters specific to the user.

In some instances, the instructions further cause the processors to obtain a request to withdraw the number of tokens, determine whether all of the number of tokens are capable of being unassigned from any of the one or more strategies, responsive to determining that all of the number of tokens are capable of being unassigned, generate a fourth smart contract to unassign the tokens from the one or more strategies, append the fourth smart contract to the blockchain, and initiate a withdrawal of the number of tokens that corresponds with vault shares associated with the user.

In some instances, the target value is determined using one or more inputs comprising a quoted yield, a realized yield, a current liquidity, a reward rate, a reward-token conversion rate, a slippage estimate, a total value locked, a total capacity, a transaction amount, a bridge amount, and/or risk data.

In some instances, the instructions further cause the processors to implement a cross-chain coordination routine configured to maintain a settlement record associating issued vault shares with the number of tokens deployed across at least a first blockchain network and a second blockchain network, and to update the settlement record in response to verified cross-chain communications.

In another example embodiment, a computer-implemented method is provided. The method can include assigning, at a vault, a first portion of the tokens to be held in an idle asset balance at the vault and a second portion of the tokens to be deployed via one or more strategies based on the set of parameters specific to the user.

The method can also include determining a subset of the second portion of the tokens to be deployed according to each of the one or more strategies, each of the one or more strategies having a target value for the subset of the second portion of the tokens to be deployed for each strategy.

The method can also include for each determined strategy, generating a second smart contract for the subset of the second portion of tokens to be deployed according to each strategy, and appending the second smart contract to the blockchain. The method can also include continuously monitoring each of the determined strategies to determine whether a triggering event is present. The method can also include responsive to determining that a triggering event is detected for a first strategy, determining whether the first strategy is within a set of reallocation guidelines.

If the first strategy is within the reallocation guidelines, the method can include generating a third smart contract to disassociate the subset of the second portion of tokens associated with the first strategy, and appending information relating to the third smart contract to the blockchain. If the first strategy is not within the reallocation guidelines, the method can include denying reallocation of the subset of the second portion of tokens associated with the first strategy.

In some instances, the method can also include obtaining a request to transfer a number of tokens for a user from a user device and a set of parameters specific to the user, generating a first smart contract to transfer the number of tokens from a wallet associated with the user device and a wallet associated with the vault, and appending a blockchain to include information relating to the first smart contract.

In some instances, the method can also include minting a number of vault tokens that correspond to the number of tokens deposited by the user and a first value for the number of tokens, and appending the blockchain to include the number of minted vault tokens.

In some instances, the method can also include recording the number of tokens, the first smart contract, and the number of vault tokens to a vault record, responsive to generating the second smart contract, updating the vault record to include the second smart contract, and responsive to generating the third smart contract or determining that the first strategy is not within the reallocation guidelines, updating the vault record to include the third smart contract or information relating to the denial of the reallocation of the first strategy.

In some instances, the triggering event comprises a determination that any of the determined strategies has a value that exceeds a target value threshold or determining that any of the determined strategies have one or more risk parameters that exceed a threshold.

In some instances, the set of reallocation guidelines include whether a slippage amount exceeds a threshold or whether a reallocation of the subset of the second portion of tokens exceeds a threshold percentage of tokens relative to a total of the number of tokens.

In some instances, the method can also include generating a strategy interface registry that stores a number of interfaces for each strategy, wherein at least one of the interfaces comprises a wrapper or adapter exposing a standardized valuation or redemption instructions for any strategy lacking a native standardized vault interface.

In some instances, the method can also include obtaining a number of reward tokens from any of the one or more strategies, minting a new set of vault tokens that corresponds with the number of reward tokens, and appending the blockchain to add the new set of vault tokens to the blockchain.

In some instances, the method can also include storing the number of reward tokens to the idle-asset balance or identifying any of the one or more strategies to deploy the number of reward tokens based on the set of parameters specific to the user.

In some instances, the method can also include obtaining a request to withdraw the number of tokens, determining whether all of the number of tokens are capable of being unassigned from any of the one or more strategies, responsive to determining that all of the number of tokens are capable of being unassigned, generating a fourth smart contract to unassign the tokens from the one or more strategies, appending the fourth smart contract to the blockchain, and initiating a withdrawal of the number of tokens that corresponds with vault shares associated with the user.

In some instances, the target value is determined using one or more inputs comprising a quoted yield, a realized yield, a current liquidity, a reward rate, a reward-token conversion rate, a slippage estimate, a total value locked, a total capacity, a transaction amount, a bridge amount, and/or risk data.

In some instances, the method can also include implementing a cross-chain coordination routine configured to maintain a settlement record associating issued vault shares with the number of tokens deployed across at least a first blockchain network and a second blockchain network, and to update the settlement record in response to verified cross-chain communications.

In other example embodiments, a digital asset management system includes a vault core configured to receive deposits of a deposit asset from users, mint vault shares representing proportional interests in managed assets, maintain an idle-asset balance, maintain records of positions deployed to multiple approved yield-generating strategies, determine a total asset value based on idle assets and redeemable values of deployed positions, and process redemption requests using the total asset value and outstanding shares.

In some embodiments, the system further includes a strategy interface registry storing interfaces associated with approved strategies. At least some of the interfaces may correspond to strategies that natively expose standardized vault functionality, while one or more other interfaces may comprise wrappers or adapters that expose standardized valuation, deposit, withdrawal, preview, conversion, or redemption functionality for strategies that do not natively expose such functionality.

In some embodiments, the system further includes a rebalance routine configured to determine target strategy-position values or target strategy-position weights, compare such targets to current strategy-position values, and generate instructions for withdrawing value from over-allocated strategy positions and depositing value into under-allocated strategy positions.

In some embodiments, execution of a rebalance is conditioned on a guardrail routine. The guardrail routine may enforce one or more operational conditions, such as whitelist status, drift thresholds, slippage limits, stale-data rejection, movement-size limits, transaction-cost limits, manual-approval thresholds, bridge-risk limits, or strategy capacity limits.

In some embodiments, the system is configured to harvest reward assets, convert harvested reward assets into the deposit asset or another selected asset, and redeploy resulting value into one or more strategies or into an idle reserve.

In some embodiments, the system realizes one or more fees, such as deposit fees, management fees, performance fees, or combinations thereof, by minting additional vault shares to a fee recipient, thereby reducing or avoiding forced liquidation of managed assets for fee collection.

In some embodiments, the system processes withdrawals by determining a first portion of a withdrawal request that can be satisfied using currently available liquidity and a second portion associated with assets locked in a delayed-liquidity strategy, initiating an exit process for the second portion, maintaining a pending withdrawal state or withdrawal record, and completing deferred settlement when liquidity later becomes available.

In some embodiments, the system updates an approved strategy set by exiting one or more removed strategies, transferring resulting value to an idle balance, modifying the strategy registry, setting or updating target allocations, and rebalancing into one or more remaining or newly added strategies.

In some embodiments, the system further includes cross-chain coordination functionality through which a first-chain vault ledger is associated with value deployed to one or more second-chain strategies, and verified cross-chain messages are used to maintain a settlement record that preserves a defined accounting relationship between issued vault shares and managed asset value.

The foregoing general description of the illustrative embodiments and the following detailed description thereof are merely exemplary aspects of the teachings of this disclosure and are not restrictive.

### BRIEF DESCRIPTION OF FIGURES

FIG. 1 is a schematic diagram illustrating an example digital asset management system in accordance with some embodiments.

FIG. 2 is a flow diagram illustrating an example deposit and share-minting process in accordance with some embodiments.

FIG. 3 is a schematic diagram illustrating an example valuation process in accordance with some embodiments.

FIG. 4 is a flow diagram illustrating an example rebalance control process in accordance with some embodiments.

FIG. 5 is a flow diagram illustrating an example delayed-liquidity withdrawal process in accordance with some embodiments.

FIG. 6 is a flow diagram illustrating an example reward harvesting and fee realization process in accordance with some embodiments.

FIG. 7 is a flow diagram illustrating an example strategy migration process in accordance with some embodiments.

FIG. 8 is a schematic diagram illustrating an example cross-chain coordination architecture in accordance with some embodiments.

FIG. 9 is a schematic diagram illustrating an example wrapper or adapter normalization architecture in accordance with some embodiments.

FIG. 10 is a flow diagram illustrating an example guardrail evaluation process in accordance with some embodiments.

FIG. 11 illustrates an example vault core in accordance with some embodiments.

FIG. 12 illustrates an example networked computing arrangement in accordance with some embodiments.

FIG. 13 shows an example computing device which may be used in the systems and methods described herein.

FIG. 14 is a schematic diagram illustrating an example AI Sentinel risk-monitoring module having a layered detection ensemble and a tiered response policy, in accordance with some embodiments.

FIG. 15 is a schematic diagram illustrating an example Sentinel-Vault single-strategy configuration, in accordance with some embodiments.

FIG. 16 is a flow diagram illustrating an example multi-source signal-consensus and pre-signed pause execution path used by the AI Sentinel risk-monitoring module, in accordance with some embodiments.

FIG. 17 is an example diagram of an AI rebalancer engine, in accordance with some embodiments.

FIG. 18 is an example diagram of a True APY (tAPY) calculation engine.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the particular embodiments. In other instances, well-known data structures, timing protocols, software operations, procedures, and components have not been described in detail so as not to unnecessarily obscure aspects of the embodiments herein.

A blockchain is a decentralized, digital ledger that records transactions across a vast network of computers, ensuring that no single entity has total control over the underlying data. Unlike databases managed by a central authority, such as a bank or a government, a blockchain uses cryptographic principles to make information transparent, immutable, and verifiable by anyone. Each block of data in a blockchain is linked chronologically to the one before it, creating a permanent chain. This architecture eliminates the need for intermediaries, as the network itself validates the authenticity of every entry, making it a popular foundation for secure, peer-to-peer interactions in a digital-first world.

Decentralized Finance (DeFi) is a transformative application of blockchain technology that seeks to provide capabilities of traditional finance providers without the need for centralized institutions like banks or brokerages. By utilizing smart contracts, self-executing pieces of code that trigger based on pre-defined conditions, DeFi allows users to engage in complex financial activities directly with one another.

With DeFi, users can generate a yield on crypto tokens by associating the tokens with various protocols (e.g., transaction platforms, liquidity pools, or staking contracts). Generally, deriving a yield using crypto tokens can require users to manually identify high-yield opportunities, move tokens between protocols, claim reward tokens, convert the reward tokens into base tokens, and subsequently associate the tokens with a new protocol. This process can generally be complex, fragmented, and error-prone. Non-expert users face a steep learning curve to manage keys, face phishing risk, multiple protocols, and different token standards across blockchain networks. Even for experienced users, actively monitoring and reallocating tokens to return an optimal yield of tokens can be time-consuming and often infeasible.

Many yield aggregator solutions have attempted to simplify this process. For example, other solutions can use contracts that allow a user to deposit tokens and have the contract deploy it into a predefined strategy that auto-compounds returns. However, these vaults typically suffer from one or more limitations.

For example, many vaults can follow static, pre-programmed, or manual allocation strategies. They may not continuously adjust allocations as market conditions change. This can result in tokens missing out on higher yields or, conversely, remain overexposed to a strategy that has continually become riskier or less profitable.

As another example, to diversify across different strategies, tokens can be split among multiple vaults or protocols. This can result in manual claiming and transferring reward tokens with subsequent swapping such reward tokens into other tokens to be later reallocated into one or more other protocols. This can include multiple steps to transfer crypto tokens that incur gas fees and other penalties along with significant slippage (i.e., a token value impact when converting tokens), which can erode actual returns.

Further, a presented yield (e.g., an Annual Percentage Yield (APY)) of DeFi platforms can be misleading. Standard yield figures can assume ideal conditions (e.g. continuous compounding of reward tokens at a constant value and no conversion loss). In reality, the actual yield can be much lower due to factors like reward token value volatility, irregular compounding intervals, conversion fees, slippage, etc. Other systems may not accurately model or communicate these factors, leading to inflated yield expectations and potential user distrust.

As another example, generating a yield from crypto tokens can carry technical and market risks. Protocols can be exploited or fail, and abnormal conditions (such as a sudden drop in liquidity or a de-pegging event) can increase risk of loss of value of tokens. Other vaults can lack active monitoring for such abnormal strategy behavior or protocol-level threats. If a problem arises in the underlying strategy, users may not be alerted in time and could suffer losses of token value before they can react.

Users often may have little visibility into what other vault systems are doing to manage crypto tokens. The status of the vault (e.g., the status of each allocated crypto token, any pending locks or risks) might not be readily available to the user (e.g., via a user interface (UI)). This opacity can deter risk-averse users or institutions that require clear reporting.

Further, many DeFi vault providers can sustain their operations by applying fees (for example, performance fees on yield or management fees on deposits). Many solutions can deduct fees in ways that reduce user principal or use manual accounting. Poorly implemented fee mechanisms can cause confusion or be used by timing deposits/withdrawals around fee assessments.

Many high-yield strategies can impose lock-up periods or cooldowns on withdrawals (for instance, a protocol may require a seven-day waiting period to unstake crypto tokens). If a vault allocates tokens in such strategies, an attempt to withdraw tokens might be forced to wait or could receive only a partial transfer if the vault cannot immediately transfer those locked tokens. Vaults might avoid offering strategies with cooldown periods altogether, simply to avoid the added complexity of handling delayed withdrawals.

The DeFi ecosystem spans multiple blockchain networks (Ethereum, Binance Smart Chain, Polygon, etc.), each with unique yield opportunities and token standards. Transferring tokens across chains (via bridges) and dealing with native vs. wrapped token formats manually is daunting. Many yield systems typically operate on a single chain and do not provide a unified cross-chain strategy, thus limiting the scope of accessible yield or forcing users to manage multiple separate vaults on different chains.

Further, some vaults allocate tokens to only one strategy or protocol at a time. If a more advantageous opportunity arises elsewhere, the entire vault may need to be migrated or the user may withdraw and transfer the tokens manually. This single-strategy approach may not simultaneously capture and account for multiple yield streams or spread risk.

In some instances, many systems may not support tiered user cohorts. Access may be limited to a fixed set of whitelisted addresses, with no fine-grained control over user privileges or feature exposure.

In some instances, the technical environment of decentralized finance, in which adverse events such as smart-contract exploits, oracle failures, depeg events, and bridge compromises propagate within minutes of detection, presents a problem that many yield-aggregation arrangements have not adequately addressed. Despite individual building blocks such as multi-strategy vaults exposing standardized share interfaces, real-time third-party threat-detection services, decentralized monitoring networks emitting anomaly alerts, decentralized oracle networks providing redundant price feeds, and parameter-recommendation methodologies based on agent-based simulation being described, there may not be any designs that integrate these features into an architecture. Such an architecture can have (a) protective action initiated by a multi-source consensus condition rather than by any single monitoring source, (b) a halt-class action held in pre-signed hot-standby and a fund-movement-class action is gated to a separate role multi-signature, (c) administrative exit functions remain callable while the vault is paused with respect to user deposits and withdrawals, and (d) the same vault contract instance, without redeployment, support both an automated-incident-response single-strategy configuration and a yield-optimization multi-strategy configuration. The interaction of these features can produce both the speed required to respond to rapid-onset risk events and the safety present to prevent automated machinery from itself becoming a loss vector.

Furthermore, many yield-aggregation arrangements have generally taught away from embedding automated incident response at the vault layer, citing operational concerns including unbounded gas costs of pre-execution simulation against every transaction, governance risks associated with automated movement of user funds, false-positive risks associated with single-source anomaly detection, and the difficulty of designing a halting mechanism that is both fast enough to outrun an exploit and selective enough not to disrupt routine yield operations. The arrangements as described herein address these concerns through, among other features, the dual-speed protective-action pathway, the role-decoupled access control, the consensus-gated activation predicate, and the hysteresis-gated tier ladder, as further described herein.

In summary, there is a clear need for a unified, intelligent yield management system that overcomes the limitations of other systems. Such a system can seamlessly allocate tokens across multiple strategies (even across chains), automatically adapt to changing conditions using AI-driven logic, accurately represent real returns, actively monitor and mitigate risks, and present information transparently to users. The present embodiments as described herein address these needs with a combination of smart contract architecture and AI modules to create a next-generation yield aggregator vault.

The present embodiments provide systems and methods relating to decentralized finance (DeFi) and digital asset management. More particularly, the present embodiments provide an intelligent yield management system that manages token assets and is implemented via blockchain smart contracts. The system as described herein can implement multi-strategy allocator vaults that can interact with artificial intelligence (AI) based processes for dynamic token allocation, risk monitoring, and yield optimization. The present embodiments provide systems at the intersection of smart contract-based asset custody, automated token implementation strategies, and AI-driven decision support in the field of DeFi yield aggregation.

As used herein, a “deposit asset” can refer to one or more digital assets accepted by a vault for purposes of issuing vault shares and managing value within the system. In various embodiments, the deposit asset may be a native blockchain asset, a wrapped native asset, a stable asset, a governance asset, a liquid staking token, a liquid restaking token, a synthetic asset, or another tokenized asset.

As used herein, a “vault share” can refer to a digital representation of a proportional interest in assets managed by the vault. The vault shares may be fungible tokens, ledger entries, or other representations of account balance. In some embodiments, the vault shares conform to a tokenized-vault standard or another standardized representation.

As used herein, an “idle-asset balance” can refer to value held by or attributable to the vault but not currently deployed to a yield-generating strategy. The idle-asset balance may be used for liquidity management, rebalancing, pending settlements, strategy migration, or risk-off positioning.

As used herein, a “strategy” can refer to any arrangement capable of deploying value to generate yield, income, rewards, or other return. A strategy may include, by way of example, staking, liquid staking, re-staking, lending, borrowing, providing liquidity, automated market making, fixed-income style arrangements, derivatives positions, credit arrangements, vault compositions, or combinations thereof.

As used herein, a “strategy interface” can refer to logic used by the vault to interact with a strategy, including one or more functions for deposit, withdrawal, preview, redemption, conversion, valuation, reward claiming, state inspection, or combinations thereof.

As used herein, a “wrapper” or “adapter” can refer to logic that exposes a standardized or normalized interface for a strategy that does not natively provide the interface expected by the vault. In some embodiments, a wrapper receives a deposit asset or another supported asset, interacts with the underlying strategy according to the native mechanics of that strategy, and exposes a common interface for the vault to determine redeemable value and to enter or exit the strategy.

As used herein, a “redeemable value” can refer to the value, denominated in a common unit or translated into the deposit asset or another accounting asset, that can be attributed to a strategy position if previewed, redeemed, converted, or otherwise valued according to the applicable strategy interface or wrapper.

As used herein, a “guardrail” can refer to an operational constraint or validation step used to approve, block, delay, limit, or modify an execution action such as a rebalance, migration, withdrawal, reward conversion, or bridge transfer.

As used herein, a “pre-signed pause transaction” can refer to a smart-contract pause invocation that has been cryptographically signed by an authorized wallet in advance and held in hot-standby for broadcast upon satisfaction of a configured activation condition, where the pause invocation takes no parameters dependent on the activation condition and may be broadcast with a configured priority gas fee.

As used herein, a “multi-source consensus condition” can refer to a logical predicate evaluated over confidence scores from a plurality of independent signal sources, where the predicate is satisfied only when a configured number, weighted sum, or probabilistic combination of source confidences crosses a configured threshold, and where no single signal source is capable of satisfying the predicate alone above a configured response tier.

As used herein, an “off-chain decision engine” can refer to a computing process that executes outside any blockchain consensus protocol and that produces, as outputs, candidate values for use by a smart contract, where the on-chain effect of the engine's output is contingent on subsequent on-chain validation by a guardrail routine and on subsequent on-chain transaction submission by a role-gated wallet.

As used herein, an “on-chain commitment record” can refer to a fixed-size cryptographic digest, emitted by a smart contract as part of an on-chain event, that commits to a structured payload describing inputs, parameters, version identifiers, and outputs of an off-chain decision engine, where the structured payload is stored on a content-addressed off-chain storage system and referenced by the digest such that the off-chain decision is independently reproducible from the committed payload.

As used herein, an “effective annual yield” or “tAPY” can refer to a yield value computed as a closed-form function of at least a base annual percentage yield, an incentive-reward annual percentage yield, a reward-token conversion rate, a slippage factor, a compounding frequency, and a per-cycle operational cost, and may further include net-of-fee adjustments and stochastic-sampling-derived confidence intervals.

As used herein, a “pre-execution stress-test layer” can refer to a computing process that simulates the effect of a candidate target weight vector on protocol state, user balances, or solvency invariants under one or more scenarios prior to permitting on-chain execution of the candidate, where the simulation may employ agent-based simulation, Monte-Carlo sampling over a calibrated joint distribution, or a deterministic worst-case scenario set.

As used herein, a “unified risk score” can refer to a scalar value, normalized to a configurable range, computed by aggregating a plurality of static per-strategy risk vectors and a plurality of dynamic detector outputs through a weighted-average, calibrated-probabilistic, or other aggregation function, optionally subject to time-weighted smoothing through a hysteresis-gated state machine.

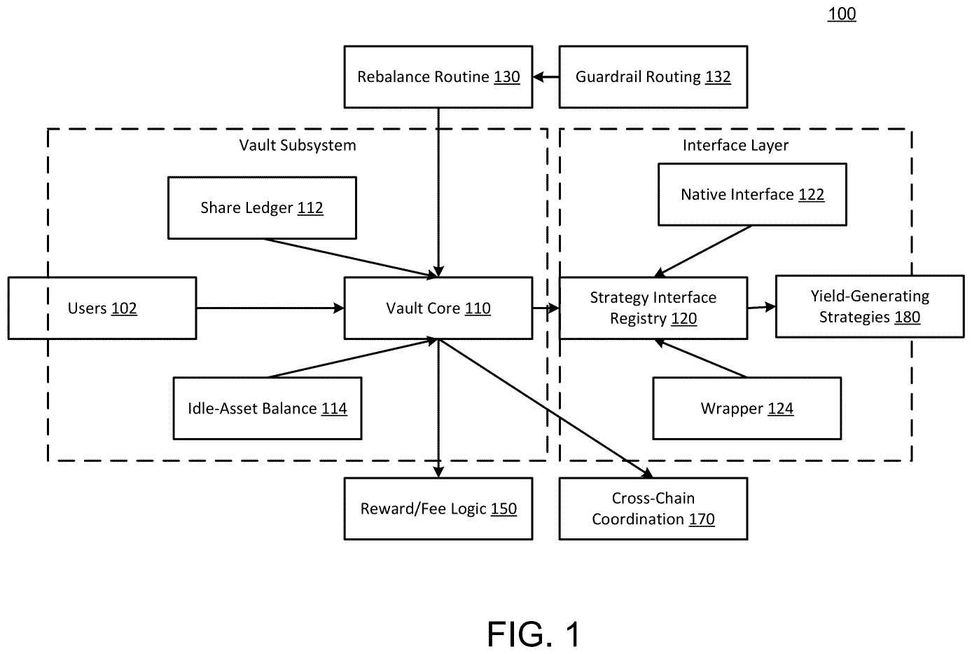

FIG. 1 is a schematic diagram illustrating an example digital asset management system 100. The system 100 can include a vault core 110, a share ledger 112, an idle-asset balance 114, a strategy interface registry 120, a rebalance routine 130, a guardrail routine 132, reward and fee logic 150, approved yield-generating strategies 180, and optional cross-chain coordination components 170.

A user, via a user device, can interact with the vault core. The vault core can maintain ownership and liquidity records and can reach strategies through the interface registry. Allocation changes can be driven by the rebalance routine but filtered by the guardrail routine. Rewards, fees, and optional cross-chain settlement can feed back into the core system. The underlying logic can be that the system provides a controlled vault architecture, not merely a ranking engine.

Users 102 can include external actors interacting with the vault via a user device. The users 102, via user devices (e.g., computer, mobile phone, token wallet), can deposit tokens into, and redeem tokens from, the vault.

Vault Core 110 can include the central operating element. Vault core 110 can receive token deposits, handles redemption requests, tracks managed token values, and acts as the operational heart of the vault.

Share Ledger 112 can include a record of issued vault shares. Share ledger 112 can support proportional ownership accounting and is what ties user entitlements to vault value over time.

Idle-Asset Balance 114 can represent token value held but not currently deployed into strategies. Idle-Asset Balance 114 tracks tokens that are not deployed, as some tokens can be retained for withdrawals, migration, or controlled execution.

The vault can hold user value in two main forms. The first is idle assets, which are unallocated deposit-asset balances held directly by the vault core contract. Idle assets serve multiple operational roles: they provide immediate withdrawal liquidity, absorb new deposits before redeployment, hold tokens during transitions between strategies, accommodate strategy capacity caps, hold proceeds returned from the reward-compounding pipeline before redeployment, and act as a risk-off buffer during protocol pauses or anomalies.

The second form is deployed strategy positions, which are held as strategy shares or “meta-assets” inside whitelisted underlying strategies. For ERC-4626-compliant strategies, the vault holds these strategy shares directly. For non-ERC-4626 strategies, exposure is held indirectly through wrapper or adapter contracts that translate the underlying strategy into an ERC-4626-style accounting interface.

For example, if a user deposits 10,000 USDC into the vault, the vault might immediately retain 500 USDC as idle balance, allocate 6,000 USDC into a first USDC strategy, and allocate 3,500 USDC into a second USDC strategy. The 500 USDC remains directly inside the vault contract, while the other 9,500 USDC is represented on-chain as first and second strategy shares (meta-assets) held by the vault.

Security and custody are enforced primarily at the smart contract and governance level. The vault can use role-based access control to separate privileges between admin, strategist, rebalancer, harvester, configurator, and pauser roles. Tokens can be restricted to flow only between the vault and whitelisted strategies, and reward-claim execution is bound to allowlisted call paths through the Reinvester. Critical administrative actions can be designed to be held by multisig wallets rather than single externally owned accounts, with a path toward client-controlled multisig signing or co-signing for high-impact actions. The system can also incorporate a global pause capability, restricted operator wallets that lack admin authority, and protections preventing removal of strategies that still hold non-dust balances.

Strategy Interface Registry 120 can include the layer through which the vault knows what strategies are approved and how to interact with them. Strategy Interface Registry 120 can be the routing and normalization point between the vault and external yield sources.

Native Interface 122 can represent a strategy that already exposes a usable or standardized interface. Wrapper/Adapter 124 can represent the normalization layer for strategies that do not natively match the vault's expected interface. This can let the same vault manage heterogeneous strategies under one common control model.

Rebalance Routine 130 can determine how tokens should be shifted among strategies. Guardrail Routine 132 can act as a gatekeeper for execution, validating whether a proposed rebalance or other action should be allowed.

The guardrail routine can include a multi-layer control structure that constrains both off-chain decision-making and on-chain execution. Off-chain, it can operate within the automation layer that produces target weights. The decision engine can compare newly computed target weights against current on-chain weights, applies a drift threshold to determine whether the proposed change is significant enough to justify execution, and skips execution when drift is below the threshold. The engine also applies TVL-and capacity-aware penalties, treats invalid or missing inputs (such as missing APY) as zero or otherwise penalized, and writes auditable snapshots that capture inputs, outputs, algorithm version, parameters, the human-readable rebalance reason, and execution status.

On-chain, the guardrail routine takes the form of access-control restrictions, allowlists, and structural constraints. The execution wallet used in automated mode holds only REBALANCER_ROLE, which can limit its authority to setting weights and calling rebalance functions. It may not move tokens to non-whitelisted destinations, cannot grant or revoke roles, and cannot reconfigure economic parameters. Reward harvesting and compounding can be bound to allowlisted external calls and incorporate slippage protection in the reinvestment flow. The vault also enforces protections such as preventing strategy removal where balances remain and supporting global pause through PAUSER_ROLE.

For example, suppose the off-chain engine recommends shifting weights from 50/50 between AAVE USDC and MORPHO USDC to 49/51. The drift is only 1%, which is below the configured drift threshold, so the routine records the attempt as “skipped” and does not submit a transaction. If instead the engine recommends a shift to 0/100 because MORPHO APY has materially outperformed AAVE, the drift exceeds the threshold, the target strategy is whitelisted, the operator wallet has REBALANCER_ROLE, and the transaction is submitted. If the same operator wallet attempted to send tokens to a non-whitelisted contract, the call would revert at the contract level.

Reward/Fee Logic 150 can handle harvested rewards and fee realization. This can provide that reward compounding and fee mechanics are part of the same integrated system rather than separate sub elements. Cross-Chain Coordination 170 can capture an omnichain or cross-chain embodiment, where value or accounting may span multiple networks. Approved Yield-Generating Strategies 180 can include the downstream destinations where value is actually deployed to earn yield.

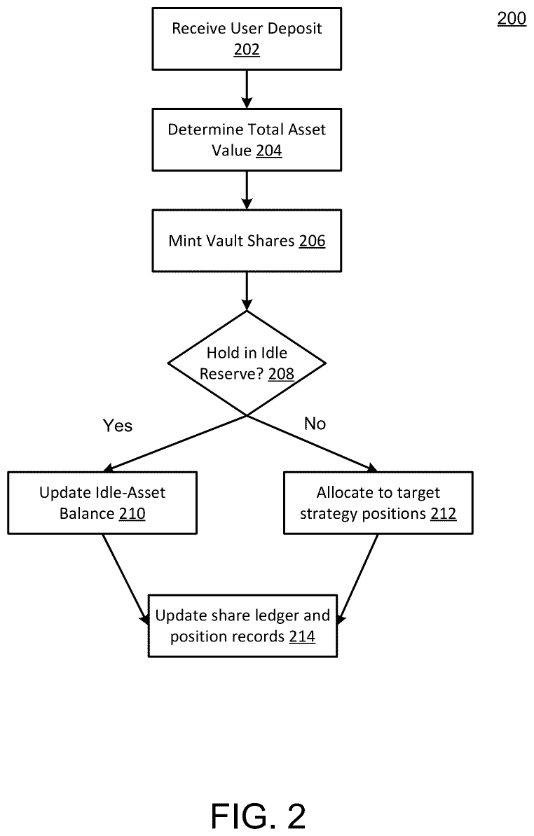

FIG. 2 is a flow diagram 200 illustrating an example deposit and share-minting process in which a user token deposit is received, total asset value is determined, vault shares are minted, and deposited value is assigned to an idle reserve and/or allocated toward one or more strategy positions.

The high-level logic can provide that deposits are not merely “received and invested.” Instead, the vault can first determine value, then issue proportional ownership, and decide whether to keep liquidity idle or deploy it. That sequencing can help support the token accounting and control architectures as described herein.

At step 202, a user token deposit can be received and accepted by the vault. The tokens can be received at the vault via smart contracts migrating the tokens from the user wallet to one or more secure wallets maintained by the vault. The tokens can be swapped across one or more separate blockchains (e.g., bitcoin blockchain, Ethereum blockchain).

Token transfer can be implemented through the ERC-4626-compliant vault contract. The user submits a deposit transaction in the deposit asset, such as USDC. The vault first realizes outstanding fees as needed so that share pricing is correct at the moment of issuance, then computes the number of shares to mint based on the ratio of totalAssets( ) to total share supply. The user can receive net shares after applicable deposit fees, which are realized by minting a portion of newly issued shares to a designated fee recipient rather than by liquidating managed assets.

Once received, the deposit asset can be retained as idle balance in the vault or allocated into whitelisted strategies during a subsequent rebalance, depending on current target weights and any idleWeight configuration. From an accounting perspective, this corresponds to converting user Assets into vault Shares at the vault layer, while the underlying assets may later be exchanged for Meta-Assets (strategy shares) at the strategy layer. The vault's totalAssets( ) view aggregates idle balances and the redeemable underlying value of all active strategy positions to maintain a single coherent share price across heterogeneous positions.

For example, a user holding USDC in their wallet calls deposit (1000 USDC, userAddress) on the vault. The user's wallet first approves the vault to pull 1,000 USDC, then the Vault executes a transferFrom to move the USDC into itself. If totalAssets( ) is currently 1,000,000 USDC and the total share supply is 950,000 vault shares, the vault mints approximately 950 vault shares to the user (less the deposit fee, which is minted to the fee recipient). The newly received 1,000 USDC is held as idle balance until the next rebalance redeploys it according to target weights.

At step 204, a total asset value can be determined. The system can determine a value of the tokens in the vault before or in connection with issuing new shares. This can include comparing the number of tokens from the user against third-party conversion rates for the tokens with a stablecoin or other currency. This can be performed because share minting can be tied to managed value, not done blindly.

At step 206, vault shares can be minted. The user can receive shares representing a proportional interest in the managed assets. In an example, vault shares can include tokenized assets minted on a blockchain (a unique blockchain for the vault or part of an existing blockchain infrastructure) and assigned to the user wallet via smart contract. In another example, the vault shares can include assignable assets that can be redeemed for token assets upon withdrawal from the vault as described herein.

At decision step 208, it can be determined whether to deploy any or all of an amount of user tokens into a selected strategy. A strategy can include a selected mechanism for returning a yield. Example strategies can include swapping the user token into another blockchain token type via a smart contract, staking the user tokens to return additional tokens after a time duration, etc. All or part of the user tokens can be selectively deployed based on a variety of factors, such as a risk level of the user, broader token environment parameters, current yields for various tokens, etc. Part of the tokens can be held in the vault to be subsequently deployed or held in case of change of any of the above factors.

At step 210, if the decision in step 208 is positive, an Idle-Asset Balance update can occur. The update can cover the case where deposited tokens are parked in reserve.

Reserve logic can be implemented through the concept of idle allocation, expressed as an idleWeight parameter in the vault or, equivalently, through a null strategy allocation in the technical architecture. The reserve serves several purposes: it ensures readily available liquidity for user withdrawals, accommodates strategies with capacity caps, supports orderly transitions when strategies are added, removed, or reweighted, holds proceeds returned from the reward-compounding pipeline before redeployment, and supports a risk-off posture in response to market or protocol anomalies.

The size of the reserve can be configured by the operator or client and enforced through setWeights( ) and rebalance( ), which align actual vault state with target weights, including the idle target. The decision to deploy or retain idle balance also interacts with the drift threshold, since rebalances that would only marginally reduce drift may be deferred to avoid unnecessary cost.

For example, a vault might be configured with an idleWeight of 5%, an AAVE USDC weight of 60%, and a MORPHO USDC weight of 35%. On a vault with 1,000,000 USDC of total assets, this targets 50,000 USDC idle, 600,000 USDC in a first strategy, and 350,000 USDC in a second strategy. If the strategist temporarily increases idle to 25% during a market event, a subsequent rebalance withdraws funds from the first strategy and the second strategy until 250,000 USDC is held idle in the Vault itself. Once the event passes, the strategist restores normal weights and the next rebalance redeploys the idle balance.

At step 212, if the decision in step 208 is negative, an allocation can be made toward target strategy positions. This can cover the case where value is routed into strategy exposure consistent with the vault's current allocation targets.

Target strategy positions can be determined within the set of whitelisted strategies for a given vault. The off-chain optimization layer can collect time-series strategy metrics including APY, TVL, and any available capacity or cap constraints, and reads the current on-chain allocation by calling functions such as previewRedeem( ) or convertToAssets( ) against each strategy. It then runs a pluggable decision engine to compute new target weights expressed in basis points.

Two algorithmic approaches can be supported. The first can include a TVL-adjusted APY chaser, which maximizes aggregate APY while penalizing concentration in low-TVL strategies. It can use a gradient-ascent search over weights with a TVL-based penalty that prevents over-allocation into thinly capitalized strategies, and treats missing or invalid APY values as zero and missing or zero TVL as heavily penalized. The second can include a max APY algorithm, which serves as a baseline by allocating one hundred percent to the highest-yielding valid strategy. Users may also override the engine entirely and set fixed weights manually.

The mathematical framing can express this as a constrained optimization. The total expected yield can be modeled as a sum across strategies of the quoted APY adjusted by a slippage factor that grows with deposit size relative to TVL. Allocation weights can be non-negative and sum to one. The optimizer alternates a gradient step with a projection step onto the simplex to maintain constraints. A key consequence is that the optimal allocation is not always concentrated in the single highest-APY strategy; under realistic slippage assumptions, a diversified allocation across multiple strategies typically yields higher realized APY.

For example, suppose a vault has three whitelisted strategies: AAVE USDC at 4.0% APY with very large TVL, MORPHO USDC at 5.5% APY with mid-sized TVL, and Yearn USDC at 4.8% APY with sizeable TVL. A naive max-APY policy would allocate 100% to MORPHO. The TVL-adjusted APY chaser, recognizing that allocating a large deposit into a smaller-TVL strategy would degrade realized yield through slippage, instead converges on a diversified target weight such as approximately 25% AAVE, 30% MORPHO, and 45% Yearn. A client running a more conservative policy may instead manually set fixed weights of 60% AAVE, 25% Yearn, and 15% MORPHO.

Strategy selection can be configured at the vault level by the client or operator, rather than per individual user.

At step 214, share ledger and position records can be updated. These can be updated responsive to any change in the deployed user tokens, such as changing token deployment allocations, movement of tokens to/from blockchains via smart contracts, deployed tokens generating a yield of additional tokens, tokens increasing in value past a specified threshold, etc. The records and ledger can be dynamically updated for each user to individually record user token asset numbers, valuations, transaction dates, smart contracts, etc.

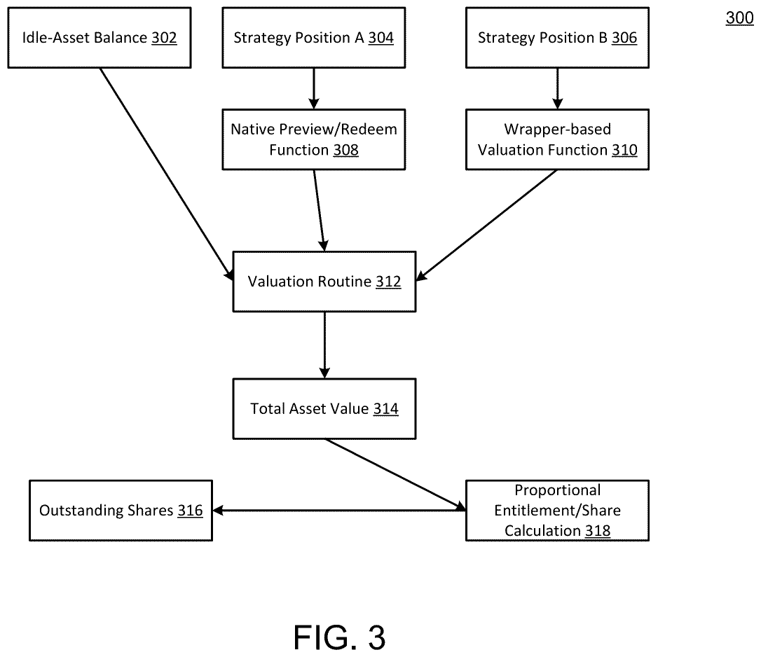

FIG. 3 is a schematic diagram 300 illustrating an example valuation process in which idle assets and multiple strategy positions, including at least one position valued through a native strategy interface and at least one position valued through a wrapper-based interface, are used to determine a total asset value and a proportional share relationship.

An idle-asset balance 302 can be the undeployed portion of value already held by the vault. As noted above, the idle-asset balance can include a portion of the user tokens that are not deployed into any strategy position. This balance can be later implemented in response to changing parameters (e.g., underlying value of a token lowering) or based on a risk profile of the user.

Strategy Position A 304 can represent one deployed strategy position. Strategy Position B 306 can represent another deployed strategy position, potentially different in interface or mechanics. For example position A 304 can include a staked crypto token strategy, while position B represents a strategy where tokens are swapped into multiple unique blockchain tokenized assets via smart contracts. Each strategy can be implemented with differing weights and portions of user tokens and can be unique to each user. While two positions 304, 306 are described, any number of strategy positions can be implemented.

Native Preview/Redeem Function 308 can illustrate how a strategy that already exposes a usable interface can provide redeemable value information directly. This information can provide a user, via a user device, a platform to view vault data, user tokens, strategy positions, yields to date, etc., as well as an ability to initiate a redemption of user tokens or to change any parameters, such as to change weights in how user tokens are deployed.

A redemption can proceed in three logical phases. First, the user can submit a redeem or withdraw request specifying either a number of vault shares to burn or a target amount of deposit asset to receive. Second, the vault can compute the corresponding underlying value owed to the user using its share-price model, then determines which strategy positions to draw from. Third, the vault can call into each underlying strategy to redeem the necessary value, either through native ERC-4626 functions such as previewRedeem( ) and redeem( ), or through equivalent wrapper-exposed functions for non-ERC-4626 strategies. The recovered deposit asset is then transferred to the user, and the corresponding number of vault shares is burned.

For example, suppose a user holds 950 vault shares and wishes to redeem all of them. The Vault computes the underlying value using the current share price: if totalAssets( ) is 1,050,000 USDC and total supply is 1,000,000 shares, then 950 shares correspond to approximately 997.5 USDC. The Vault checks idle balance—say 10,000 USDC is idle—and uses idle USDC to satisfy the redemption directly without touching strategies, transferring 997.5 USDC to the user and burning 950 shares. If the redemption were instead for 100,000 USDC and idle balance was only 10,000 USDC, the Vault would call previewRedeem and redeem against AAVE and MORPHO strategies in proportional amounts to recover the remaining 90,000 USDC, then transfer the full 100,000 USDC to the user.

Wrapper-Based Valuation Function 310 can provide an illustration of how a non-standard strategy can still be valued consistently by passing through a wrapper or adapter. A wrapper, also referred to as an adapter, can include a minimal smart contract that allows the vault to interact uniformly with a strategy whose native interface does not match the vault's expected ERC-4626-style interface. The wrapper can forward user assets into the underlying protocol when the vault deposits, holds the resulting protocol-specific position internally, and exposes a normalized interface back to the vault consisting of standardized functions such as deposit, withdraw, mint, redeem, totalAssets, previewRedeem, and convertToAssets. Through this layer, the vault can treat heterogeneous strategies as uniform vault-like positions for accounting, valuation, allocation, rebalancing, and redemption purposes.

For example, an AAVE USDC wrapper accepts USDC from the Vault, deposits it into the AAVE V3 USDC market, and receives aUSDC tokens in return. The wrapper can hold aUSDC internally, but exposes its position to the vault (or OAV) through standardized functions. When the vault calls previewRedeem(1000 wrapper-shares), the wrapper computes the equivalent aUSDC and converts it to USDC at the current AAVE exchange rate, returning, say, 1,032 USDC after accrued interest. When the vault later calls redeem(1000 wrapper-shares), the wrapper withdraws the corresponding aUSDC from AAVE, receives USDC back, and transfers the USDC to the vault. From the Vault's perspective, the AAVE-wrapped strategy looks identical to a native ERC-4626 strategy.

A valuation routine 312 can include the normalization point. This can collect values from idle assets and strategy positions and translates them into a common valuation basis.

The valuation routine can determine the vault total assets under management at any point in time so that share pricing remains consistent across deposits, withdrawals, fee realization, and rebalancing. It can be centered on the totalAssets( ) view of the vault. This view sums two components. The first can be the idle balance of the deposit asset held directly by the vault. The second can be the redeemable underlying value of each active strategy position, computed by querying each strategy through its standardized interface, typically using previewRedeem( ) or convertToAssets( ) either directly on ERC-4626 strategies or via the wrapper layer for non-ERC-4626 strategies.

Because all strategies are exposed through a uniform ERC-4626-style abstraction, the valuation routine can produce a single coherent vault-level value regardless of how heterogeneous the underlying positions are. The vault share price can then be derived from the ratio of totalAssets( ) to total share supply. Fee realization can be integrated with valuation: management and performance fees are realized through harvest( ), which can mint new shares to the fee recipient based on time elapsed and growth in vault value since the last checkpoint, ensuring that fee accrual is reflected in pricing without requiring forced liquidation of managed assets.

For example, a vault with 5,000 USDC idle, an AAVE position whose previewRedeem returns 600,000 USDC, and a MORPHO position whose previewRedeem returns 395,000 USDC has a totalAssets( ) value of 1,000,000 USDC. If the total share supply is 950,000 shares, the price per share is approximately 1.0526 USDC. Any subsequent deposit, withdrawal, or rebalance is priced against this view, ensuring consistent treatment of all share holders.

A total asset value 314 can include the resulting aggregate vault value. This can include an aggregate value of all deployed user tokens and tokens in the idle-asset balance. The total value can be derived using valuation metric measurements and by requesting user token data from the strategy interface registry.

Outstanding shares 316 can represent the denominator of ownership accounting. Proportional Entitlement/Share Calculation 318 can include how total value and share count are tied together to determine per-share proportionality or user entitlement.

The underlying logic is that the system can unify different kinds of positions into one coherent vault balance sheet. That is important both technically and legally, because it supports the idea that the vault manages heterogeneous strategies through a common valuation model, including positions that use wrappers rather than native interfaces.

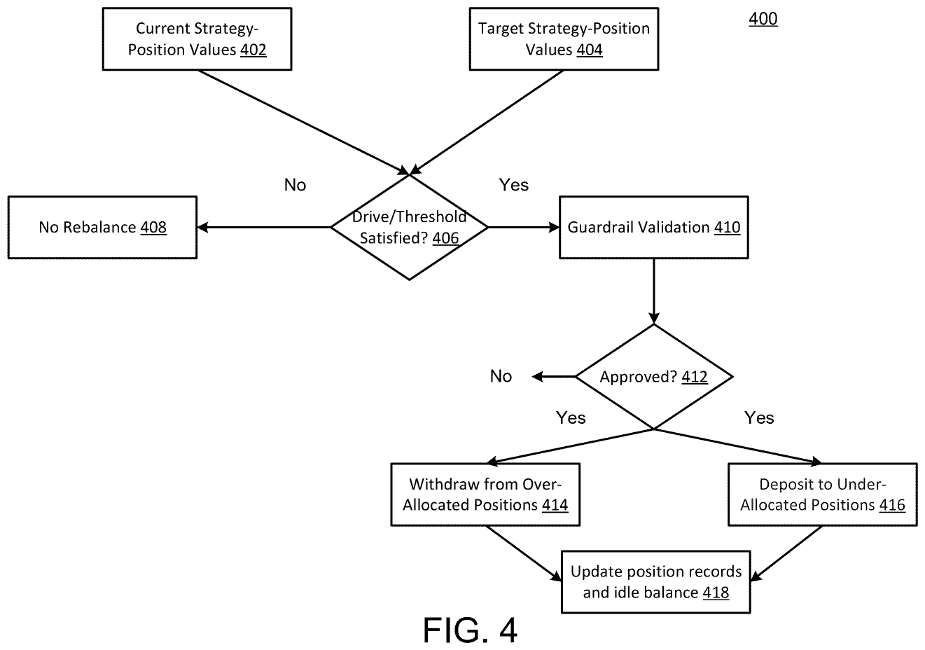

FIG. 4 is a flow diagram 400 illustrating an example rebalance control process in which current strategy-position values are compared with target strategy-position values, one or more guardrails are evaluated, and value is withdrawn from over-allocated positions and deposited into under-allocated positions.

Current Strategy-Position Values 402 can include the actual live allocation values. Target Strategy-Position Values 404 can include the desired allocation values as determined by the vault's allocation logic. A target value can be based on a third-party valuation, such as a current valuation of a crypto token, for example. For instance, if an eth token has an initial value in relation to another currency (e.g., a stablecoin), the target value can be an increased value in relation to that same currency.

A decision can be made whether a Drift/Threshold is Satisfied at 406. This determination can be based on whether the difference between current and target positions is large enough to justify action.

Drift identification can compare actual on-chain allocation against target allocation. Actual allocation can be determined by reading the OAV's strategy share balances and converting each into the underlying deposit-asset value through previewRedeem( ) or convertToAssets( ), including any wrapper-based equivalents. The result can be a set of current weights, typically expressed in basis points. Target allocation can be produced by the off-chain decision engine, either through the TVL-adjusted APY chaser, the max APY algorithm, or a manually configured fixed-weight policy.

Drift can then be computed as the deviation between current weights and target weights, including idle weight where applicable. The system can apply a configured drift threshold to determine whether to proceed with execution. When drift is below the threshold, the rebalance is recorded as “skipped” in the auditable snapshot rather than executed, which prevents unnecessary transaction costs and avoids portfolio churn. Each rebalance attempt can be logged together with its inputs, outputs, algorithm version, parameters, and human-readable rebalance reason for transparency and post-hoc review.

For example, suppose target weights are 60% AAVE, 35% MORPHO, and 5% idle, while current measured weights are 59.2% AAVE, 35.5% MORPHO, and 5.3% idle. The maximum drift across positions is 0.8%. If the configured drift threshold is 1%, the engine records the run as “skipped: drift below threshold,” preserving APY and TVL inputs and the proposed weights for audit. Some weeks later, MORPHO APY rises sharply and the engine produces target weights of 30% AAVE, 65% MORPHO, 5% idle. Drift now exceeds the threshold, so the engine generates a setWeights and rebalance transaction and records the snapshot as “executed” along with the resulting transaction hash.

If the drift threshold at 406 is not satisfied, no rebalance is made 408. In this step, the system may do nothing because the drift is too small or otherwise not actionable.

If the drift threshold at 406 is satisfied, guardrail validation 410 can be performed. This can include a compliance/control step where the proposed action is checked against operational constraints.

Guardrail validation can operate as a sequence of pre-execution checks. First, the proposed reallocation can target only whitelisted strategies maintained by STRATEGIST_ROLE, ensuring that capital does not flow into unvetted destinations. Second, the rebalance can be initiated by an account holding the appropriate role, typically REBALANCER_ROLE, with high-impact administrative actions using DEFAULT_ADMIN_ROLE held by a multisig. Third, the off-chain decision engine can evaluate whether drift exceeds the configured threshold and whether allocation choices are consistent with TVL and capacity-aware penalties, treating invalid metrics as zero or otherwise penalized.

Fourth, reward harvesting and compounding flows can be constrained to allowlisted reward-claim calls executed through the Reinvester, with slippage protection applied during swaps performed by the Swapper. Fifth, the system can maintain an immutable audit record of decisions and outcomes, recording inputs, outputs, algorithm version, parameters, rebalance reason, and execution status. Sixth, governance configurations can allow for propose-only and client co-signing modes, in which automated proposals can be reviewed and signed by a client-controlled multisig before execution.

For example, if the optimization engine produces a target allocation that includes a strategy address not on the whitelist, the on-chain setWeights call reverts because the contract checks that every weighted strategy is in the meta-assets list. If the engine produces a valid target but the operator wallet attempts to also drain tokens to an external address, the contract reverts because REBALANCER_ROLE does not include that authority. If a reward-compounding swap is attempted with output far below expected, the slippage check in the Swapper reverts the swap.

Another decision at 412 can be whether the execution of an action is approved. Even if drift exists, the rebalance can only proceed if the guardrails permit it. If the execution is not approved, the action can be denied. If the execution is approved, at 414, tokens can be withdrawn from over-allocated positions to reduce positions that exceed targets. Further, if the execution is approved, at 416, tokens can be deposited into under-allocated positions to increase positions that are below targets. At 418, position records and idle balance can be updated. This can finalize the rebalance by updating the vault's books.

The system may not rebalance continuously or blindly. Rather, the system can compare current positions to targets, tests whether action is warranted, applies guardrails, and only then moves tokens. The system can comprise a controlled execution framework, not just a recommendation engine.

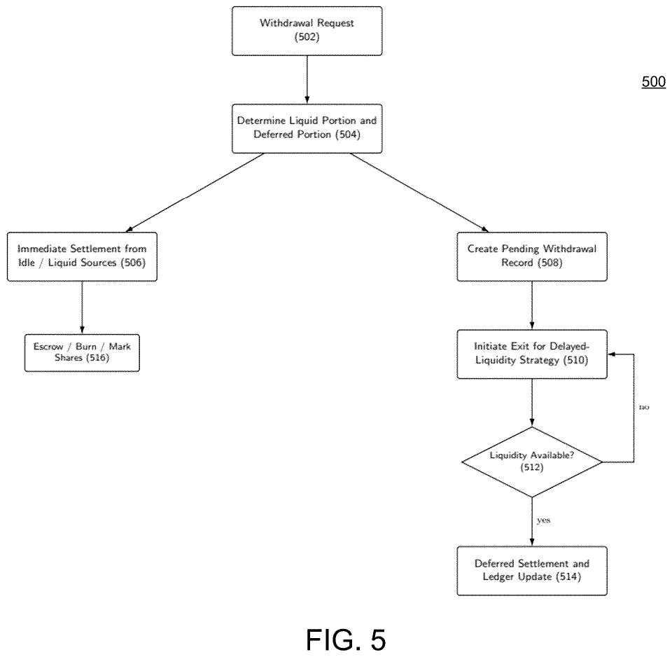

FIG. 5 is a flow diagram 500 illustrating an example delayed-liquidity withdrawal process in which a withdrawal request is divided into an immediately satisfiable portion and a deferred portion, a pending withdrawal record is created, an exit process is initiated for a delayed-liquidity strategy, and deferred settlement is completed when liquidity becomes available.

At 502, a withdrawal request can include the incoming user redemption request. This can be received from a user device. Alternatively, this can be automatically triggered based on parameters being met, like a staking period ending or a target value being met.

These steps relate to the delayed-liquidity withdrawal flow, in which a user withdrawal may not be fully satisfied immediately because some underlying strategies impose cooldowns, lock-ups, or asynchronous settlement.

Step 504 corresponds to receiving a withdrawal request and computing the user's entitlement based on share count and current totalAssets( ). Step 506 corresponds to partitioning the entitlement into two portions: an immediately satisfiable portion supported by idle balance and any liquid strategies, and a deferred portion that depends on illiquid or cooldown-bound strategies. Step 508 corresponds to settling the immediate portion to the user using idle balance and liquid strategy redemptions. Step 510 corresponds to opening a pending withdrawal record for the deferred portion, which marks or escrows the corresponding shares so that the user's claim is preserved even though the underlying value has not yet been recovered. Step 512 corresponds to initiating the exit process from the cooldown-bound strategy. Step 516 corresponds to completing settlement once liquidity becomes available, transferring the remaining underlying assets to the user and burning the previously escrowed shares.

For example, a user redeems 5,000 vault shares worth 5,250 USDC. Idle balance covers 1,000 USDC, an AAVE position covers an additional 2,250 USDC immediately, and the remaining 2,000 USDC sits in a strategy with a 7-day cooldown. The vault sends 3,250 USDC to the user immediately, opens a pending withdrawal record marking 1,905 of the user's 5,000 shares as awaiting deferred settlement, and initiates the cooldown exit. Seven days later, when liquidity becomes available, the vault transfers the remaining 2,000 USDC to the user and burns the previously escrowed shares.

At 504, a liquid portion and deferred portion can be determined for user tokens. The system can determine what can be satisfied now and what is tied up in delayed-liquidity strategies. At 506, an immediate settlement from idle/liquid sources can include the amount the vault can pay right away.

At 508, a pending withdrawal record can be created that provides a formal record for the deferred portion that cannot yet be settled. At 510, an exit for delayed-liquidity strategy can include the necessary process for unwinding the illiquid position.

At 512, a decision can be made as to whether liquidity is available. This can include determining when deferred tokens can actually be released. At 514, a deferred settlement and ledger update can complete the payout and updates system records once the delayed tokens become available. At 516, escrow/burn/mark shares can reflect the accounting treatment associated with the withdrawal, ensuring that ownership records remain consistent while part of the payout is pending.

The logic is that withdrawals are not treated as all-or-nothing. Instead, the system can partition the request into immediately payable and deferred components, tracks the deferred piece explicitly, and settles it later in an orderly way.

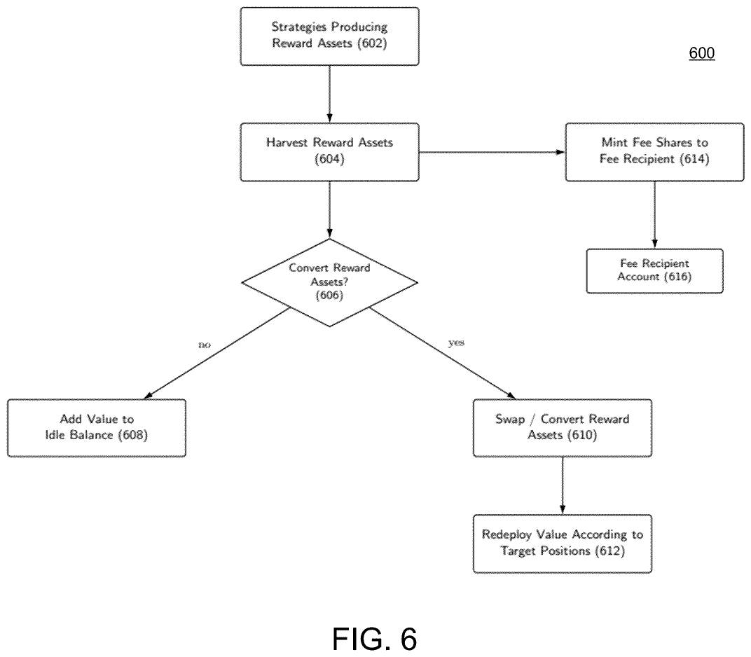

FIG. 6 is a flow diagram 600 illustrating an example reward harvesting and fee realization process in which reward assets are harvested from one or more strategies, optionally converted into a selected asset, redeployed or added to an idle balance, and one or more fees are realized by minting vault shares to a fee recipient.

At 602, strategies producing reward assets can include the sources of incentive or reward tokens. Reward sources can include both protocol-native incentives associated with the strategies in which the vault is deployed and external incentive distribution systems. Examples of incentive mechanisms include protocol-issued reward tokens earned by liquidity providers, lenders, or stakers, and external campaign-based reward distributions such as Merkl.

From a blockchain perspective, these incentives can accrue to the vault on-chain positions and are made claimable through specific contract calls exposed by the relevant protocols or distribution systems. The vault may not autonomously interact with these reward systems. Instead, it routes claims through the Reinvester, which executes a defined set of allowlisted reward-claim calls corresponding to the integrated reward sources. This allowlist can constrain reward extraction to vetted, expected pathways, both for security and to prevent execution of arbitrary external calls.

For example, a vault with USDC deposited into a Compound-style lending market earns a protocol incentive token (such as a COMP-style reward) that accrues to the vault lending position. Separately, an vault deployed in a MORPHO USDC strategy may be eligible for a Merkl-distributed campaign that pays rewards in a third token. Both reward streams are claimable via specific contract calls registered in the Reinvester's allowlist; an attempt to call any other contract through the Reinvester would not be permitted by its configuration.

At 604, harvest reward assets can include a collection step to collect reward assets (tokens). Harvesting and reward compounding can be initiated on-chain via the vault function compoundRewards( ), which is gated by HARVESTER_ROLE.

The vault can call into the Reinvester contract, which can perform any of three operations. First, it executes the configured set of allowlisted reward-claim calls against the underlying protocols and distribution systems, transferring the resulting reward tokens to itself. Second, it forwards the reward tokens to the Swapper, which executes the conversion into the OAV's base deposit asset using an external swap router such as Uniswap's Universal Router. Third, it returns the resulting deposit-asset balance to the vault.

Once the deposit asset arrives in the vault, it can sit as idle balance until the next rebalance redeploys it across whitelisted strategies according to current target weights. The compounding pipeline can therefore be split between three contracts, Vault, Reinvester, and Swapper, each with a narrow, auditable responsibility, and reward-claim execution that can be constrained by the allowlist and slippage controls.

For example, a HARVESTER_ROLE wallet calls compoundRewards( ) on the vault. The Reinvester then claims, for example, 1,500 reward tokens from a lending protocol and 800 reward tokens from a Merkl campaign. The Swapper sells these tokens through Uniswap's Universal Router, receiving 2,300 USDC after slippage protection. The Reinvester transfers the 2,300 USDC to the Vault, which now holds 7,300 USDC idle (5,000 USDC previous idle plus 2,300 USDC compounded). The next rebalance( ) call deploys a portion of this idle balance into AAVE and MORPHO strategies according to current target weights.

At 606, a decision can be made whether to convert reward assets. In some cases the system may keep the harvested form; in others it converts rewards into a preferred asset.

The default conversion target can be the vault base deposit asset, for example USDC, because the vault is designed to present a clean, single-asset exposure to users and to redeploy compounded value back into the same asset across strategies. Conversion of reward tokens can be decided as part of the routine compounding flow, executed through the Reinvester and Swapper, and may be triggered on a periodic cadence by HARVESTER_ROLE.

Preferred assets can be those that match the vault's deposit asset, ensuring deterministic redeployment and consistent share-price behavior. Non-preferred assets can be reward tokens that need to be converted before they can be reinvested; these include incentive tokens distributed by lending or DEX protocols and external reward systems, which are typically volatile and not directly redeployable into the vault's strategies. Conversion timing also takes slippage and gas economics into account, since small or low-value conversions may be deferred to avoid eroding yield.

For example, in a USDC-denominated vault, USDC can be the preferred asset. Reward tokens such as a protocol governance token or a Merkl distribution token are non-preferred, since the vault cannot directly redeploy them into AAVE USDC, MORPHO USDC, or Yearn USDC. If the Reinvester accumulates only 5 USDC worth of a reward token, conversion may be skipped because the gas cost of swapping would exceed the value recovered. If it accumulates 2,000 USDC worth of reward tokens, conversion proceeds through the Swapper and the resulting USDC is returned to the Vault for redeployment.

At 608, add value to idle balance shows one path, where harvested value is retained as liquidity. At 610, swap/convert reward assets can show the conversion path. The conversion path can run through three contracts. The Reinvester can claim reward tokens from underlying protocols using allowlisted calls. The Swapper can execute the actual ERC-20 to ERC-20 conversion through an external swap router such as Uniswap's Universal Router. The Reinvester then can return the resulting deposit asset to the Vault, where it accumulates as idle balance for redeployment. The Swapper can be intentionally lightweight and non-custodial: it measures token balances before and after the swap to ensure correct delivery and does not retain rewards.

Tracking can be achieved through standard on-chain transaction visibility: claim, swap, and transfer events are recorded on-chain with transaction hashes, and combined with the off-chain audit framework, which logs reallocation snapshots, decision metadata, and execution status. This can enable post-hoc reconstruction of how reward flows were converted and redeployed.

For example, a single compounding cycle produces three on-chain transactions: a claim transaction that pulls reward tokens from a lending protocol into the Reinvester; a swap transaction routed through Uniswap's Universal Router, where the Reinvester's pre-swap balance, post-swap balance, and resulting USDC delta are observable; and a transfer transaction returning USDC from the Reinvester back to the Vault. The off-chain audit record links these transaction hashes to the corresponding OAV, the rebalance reason, and the resulting change in idle balance.

At 612, value of tokens can be redeployed according to target positions. This can show how converted rewards can be reinvested in line with the vault's current strategy targets.

After the Reinvester and Swapper return converted rewards as deposit assets, those assets can enter the vault as idle balance. They may not auto-deploy. Redeployment occurs when REBALANCER_ROLE triggers the rebalance( ) function, which can compare current weights against target weights and moves capital between idle and whitelisted strategies to bring the portfolio into alignment. The drift threshold can also be applied at this stage to determine whether the rebalance is significant enough to execute.

Decisions about how to redeploy converted rewards can be the same as decisions about how to allocate any new capital: target weights produced by the off-chain decision engine, or by manual configuration, govern the post-compounding allocation. Compounding therefore can feed yield directly back into the same allocation logic that governs deposits and structural reallocations.

For example, after a compounding cycle increases idle USDC from 5,000 to 7,300 , the off-chain engine computes target weights of 60% AAVE, 35% MORPHO, and 5% idle. Total assets are now 1,002,300 USDC, so the targets are 601,380 USDC in AAVE, 350,805 USDC in MORPHO, and 50,115 USDC idle. The next rebalance( ) deposits roughly 1,380 USDC into AAVE and 805 USDC into MORPHO, leaving about 50,115 USDC as idle balance, while preserving share-price continuity for users.

At 614, the system can mint fee shares to fee recipient. The fee shares that are minted can represent fee realization through share minting rather than forced asset liquidation. The fee shares can represent minted tokens and appended to the blockchain via smart contract that represent yields or fees realized through the strategies as described herein.

At 616, a fee recipient account can be the recipient endpoint for those minted shares. The smart contract can specify the recipient account or wallet specifying ownership of the newly minted tokens.

The underlying logic can be that the vault not only allocates principal but also manages the full lifecycle of rewards and fees. Reward tokens can be harvested, converted, and redeployed. Fees can be realized in a way that preserves token deployment rather than forcing asset sales.

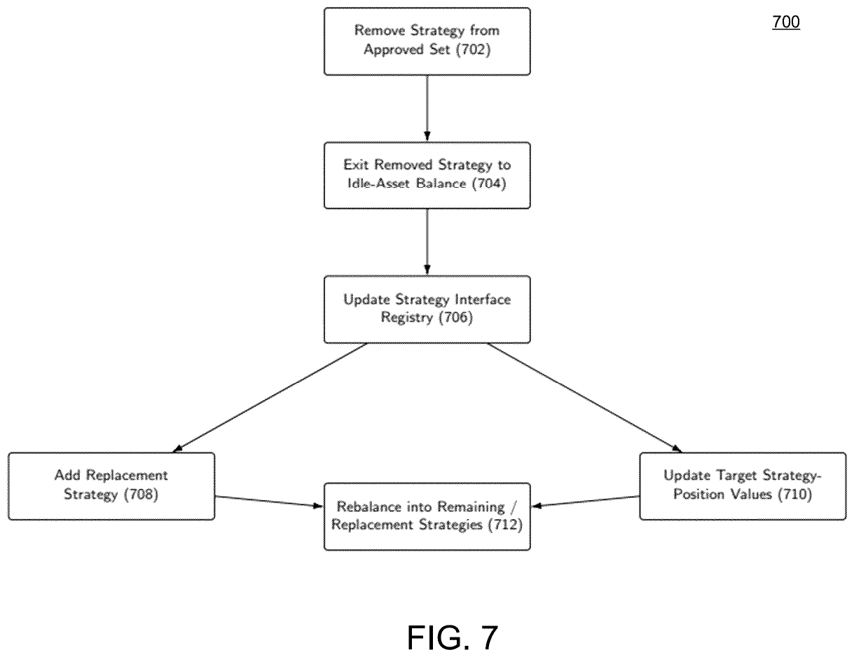

FIG. 7 is a flow diagram 700 illustrating an example strategy migration process in which a strategy is removed from an approved strategy set, value is exited to an idle-asset balance, a strategy interface registry is updated, a replacement strategy is added, and value is rebalanced into one or more remaining or replacement strategies.

At 702, a strategy can be removed from an approved set. This can identify the strategy being phased out.

A strategy can be phased out because the DeFi opportunity set is dynamic. Yields, capacities, risk profiles, incentives, and protocol availability change over time. The off-chain optimization layer monitors APY, TVL, and capacity signals across whitelisted strategies, and the system supports lifecycle changes when an underperforming or higher-risk strategy should be exited or replaced with a better-suited alternative. Strategy phase-out can be part of a continuous capital-efficiency lifecycle rather than a one-time event.

For example, an OAV initially whitelists AAVE USDC and MORPHO USDC, with substantial allocations to both. Over time, MORPHO APY declines and capacity tightens, while Yearn USDC emerges with stronger risk-adjusted returns. The strategist phases out MORPHO by exiting its position, removing it from the whitelist, adding Yearn USDC, updating target weights, and rebalancing into the new mix.

The strategy migration sequence can be a four-step on-chain workflow, executed across two roles. First, if the retiring strategy still holds non-dust balance, REBALANCER_ROLE calls manualExit( ) to unwind the position and move the recovered deposit asset into idle balance. Second, STRATEGIST_ROLE calls setMetaAssets( ) to update the whitelisted strategy set, which can mean adding a new strategy, removing an existing strategy, or replacing one with another. Third, REBALANCER_ROLE calls setWeights( ) to update target weights so the new strategy composition is reflected in the allocation policy. Fourth, REBALANCER_ROLE calls rebalance( ) to redeploy idle assets into the updated set of strategies according to the new weights.

The contract can enforce protections against unsafe migrations, including the rule that a strategist cannot remove a strategy that still holds a non-dust balance, ensuring tokens are not orphaned. Each migration step can be auditable and bounded by role permissions, so that no single operator can both add or remove a strategy and freely move user tokens outside the whitelisted set.

For example, replacing MORPHO USDC with Yearn USDC proceeds as follows. REBALANCER_ROLE calls manualExit(MORPHO) to withdraw all MORPHO tokens back to the Vault, increasing idle balance by, for example, 250,000 USDC. STRATEGIST_ROLE calls setMetaAssets( ) to remove MORPHO from the whitelist and add Yearn. REBALANCER_ROLE calls setWeights( ) with the new target distribution: 60% AAVE, 35% Yearn, 5% idle. Finally, REBALANCER_ROLE calls rebalance( ), which deploys the idle balance into Yearn and adjusts AAVE as needed to match the new weights. Throughout, share price is preserved because no value is lost in the transition; only the composition of underlying positions changes.

At 704, a removed strategy can be exited to idle-asset balance. This can show that tokens are first brought back into a controlled idle state. At 706, a strategy interface registry can be updated, which can reflect the administrative/control update to the approved strategy list.

At 708, a replacement strategy can be added, which can identify the new destination strategy. At 710, a target strategy-position value can be recalculated where tokens should go under the updated strategy set. At 712, a rebalance into remaining/replacement strategies can execute the migration by redeploying value.

The logic can include exiting first, updating the registry, adding the new strategy, refreshing targets, then redeploying token. This can help illustrate that strategy-set changes are performed through an orderly migration process that preserves accounting and control over token movement.

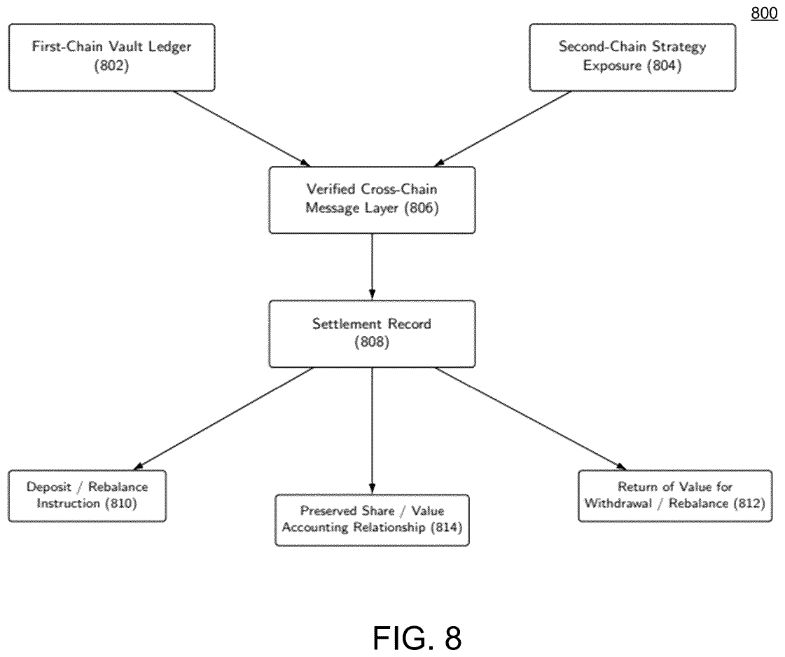

FIG. 8 is a schematic diagram 800 illustrating an example cross-chain coordination architecture in which a first-chain vault ledger, a second-chain strategy exposure, a verified cross-chain message layer, and a settlement record cooperate to preserve an accounting relationship between issued vault shares and managed asset value across multiple blockchain networks. The cross-chain embodiment can use verified messaging and a settlement record to keep share accounting coherent across chains.

Cross-chain operations can be implemented through an optional ovault layer that extends the vault with omnichain capabilities. The architecture can be a hub-and-spoke model. The vault, the Reinvester, the Swapper, and the actual strategy execution remain on a single hub chain. Spoke chains do not run independent strategies; instead, they can provide a user-facing entry point for deposits, redemptions, and share transfers that route to the hub.

The cross-chain mechanism can use LayerZero-style messaging for cross-chain instructions and Omnichain Fungible Token (OFT) representation for vault shares. When a user deposits or redeems on a spoke chain, the OVault module can encode the action as a cross-chain message, sends it to the hub, and the hub-side vault processes it as if it had originated locally. Share-side accounting is preserved through OFT representation, so a user's share balance remains coherent regardless of the chain they interact from. The user does not need to manually bridge assets or supply gas on the hub chain.

For example, a user holding USDC on Arbitrum wants exposure to a USDC OAV whose hub is Base. The user calls deposit on the Arbitrum-side OVault contract. The OVault encodes the request and sends a LayerZero message, with the USDC bridged to Base. The hub-side Vault receives the USDC, mints OAV shares using the standard ERC-4626 flow, and the corresponding OFT shares are delivered to the user's Arbitrum address. From the user's perspective, they deposited on Arbitrum and received vault shares on Arbitrum; from the system's perspective, all strategy execution remains on Base, and accounting is unified on the hub.

A first-chain vault ledger 802 can include the ledger where the user-facing share relationship is recorded on the primary chain. A second-chain strategy exposure 804 can represent a value deployed on another chain. A verified cross-chain message layer 806 can include the trusted communication layer used to coordinate state changes across chains.

A settlement record 808 can include the central record that ties together the multi-chain state and preserves the relationship between shares and deployed value. A deposit/rebalance instruction 810 can show the outbound control path for moving or allocating value cross-chain.

A return of value path 812 can represent the inbound control path by which value is repatriated from the second-chain strategy exposure 804 to the first-chain vault ledger 802 to satisfy a withdrawal or a rebalance. A preserved share/value accounting relationship 814 can represent the invariant maintained by the settlement record 808 such that the relationship between issued vault shares and managed asset value remains consistent across the first blockchain network and the second blockchain network.

Wrapper/Adapter 908 can include the translation layer for a non-standard strategy. A wrapper, also called an adapter, can be a thin smart contract layer that exposes a standardized ERC-4626 interface on the vault-facing side while internally bridging to a protocol whose native interface differs from ERC-4626. A non-standard strategy can be any underlying yield source that does not natively expose the ERC-4626 deposit, withdraw, mint, redeem, and valuation functions in the form the OAV expects. This can include lending markets such as AAVE, where positions are represented as native interest-bearing tokens (such as aUSDC) rather than ERC-4626 vault shares, as well as other yield mechanisms whose accounting model differs from ERC-4626.

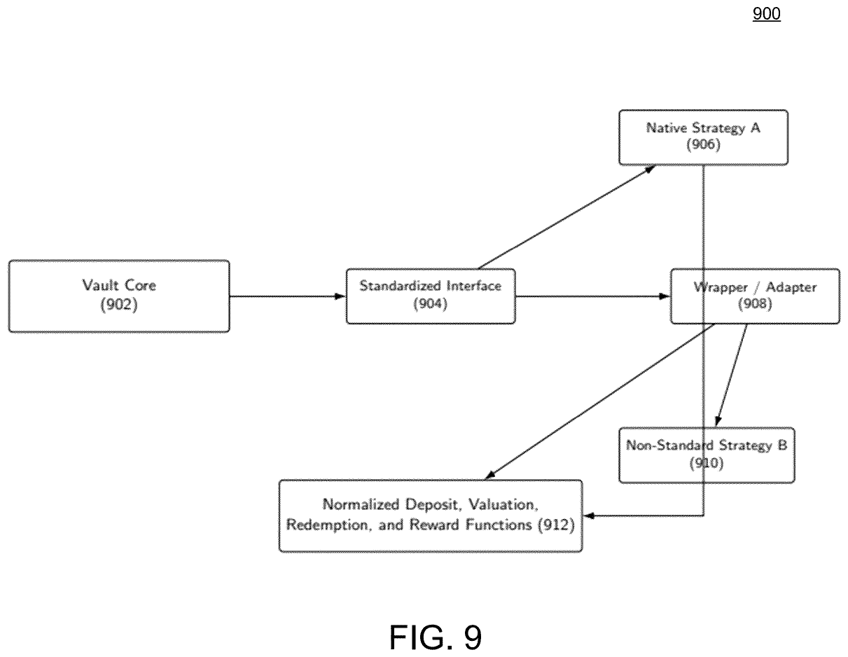

FIG. 9 is a schematic diagram 900 illustrating an example wrapper or adapter normalization architecture in which a vault core 902 interacts through a standardized interface 904 with both a native strategy 906 and a non-standard strategy 910 supported through a wrapper or adapter 908 that exposes normalized deposit, valuation, redemption, and reward functions 912.

Non-Standard Strategy B 910 is the underlying strategy that does not natively expose the expected interface. A non-standard strategy can be an underlying yield source whose native interface does not conform to ERC-4626. The vault may not interact with such strategies directly; instead, exposure can be achieved through a wrapper that exposes a standardized ERC-4626-style interface to the vault while internally bridging to the protocol-specific mechanics of the underlying source. A representative example is an AAVE V3 USDC lending position integrated through a dedicated wrapper that holds aUSDC internally and exposes a normalized ERC-4626 interface to the OAV. Other examples include yield sources whose accounting is based on protocol-native receipt tokens or on continuously accruing balances that do not natively follow the ERC-4626 share-and-asset model.

Beyond accounting, the vault can expose the operational interface used by privileged roles. STRATEGIST_ROLE manages setMetaAssets, REBALANCER_ROLE manages setWeights, rebalance, manualAllocate, and manualExit, HARVESTER_ROLE manages harvest and compoundRewards, CONFIGURATOR_ROLE manages economic parameters such as fees and the Reinvester, PAUSER_ROLE manages global pause, and DEFAULT_ADMIN_ROLE manages the role hierarchy itself. This division of responsibilities can be core to the security model: routine operational privileges and high-impact administrative privileges are intentionally separated.

For example, a single OAV instance might hold meta-assets=[AAVE_USDC, MORPHO_USDC, Yearn_USDC], weights=[60%, 25%, 10%], idleWeight=5%, fee recipient=client treasury multisig, and Reinvester=configured Reinvester contract. STRATEGIST_ROLE updates the strategy list when a new whitelisted strategy is approved, REBALANCER_ROLE updates weights and triggers rebalance( ) based on optimizer output, HARVESTER_ROLE periodically calls harvest( ) and compoundRewards( ), and PAUSER_ROLE retains the ability to pause the contract in case of incident.

A standardized Interface 904 can include a common interface through which the vault communicates with separate modules or computers implementing various strategies.

The standardized interface can be ERC-4626. It can define a uniform set of functions that strategies can expose to the Vault, including deposit, withdraw, mint, redeem, totalAssets, previewRedeem, and convertToAssets. Through this interface, the vault can deposit deposit-asset value into a strategy, redeem deposit-asset value back from a strategy, query its share-based accounting, and value its position uniformly with all other strategies in the portfolio.

For a strategy that is natively ERC-4626-compliant, the vault can interact with it directly. For a strategy that is not natively ERC-4626-compliant, the vault can interact with it through a wrapper that exposes the same function signatures while internally bridging to the underlying protocol. A representative example can include an AAVE-based lending strategy: the wrapper deposits underlying assets into the lending market, holds the resulting interest-bearing position, and exposes its proportional value to the OAV through the standard ERC-4626 interface.

Native Strategy A 906 can include a strategy that can plug into that interface directly. A native strategy can include a strategy that the Vault can interact with directly because it already conforms to the ERC-4626 standard. It may not require a wrapper, since its native interface already exposes the deposit, withdraw, mint, redeem, and valuation functions the vault expects. Representative examples include trusted blue-chip ERC-4626-style USDC vaults from protocols such as MORPHO, Yearn, and Euler. Any of these can serve as a representative “Native Strategy A” example, as their vaults already expose the standard ERC-4626 interface that the Vault specifies.

Wrapper/Adapter 908 can include the translation layer for a non-standard strategy. A wrapper, also called an adapter, can be is a thin smart contract layer that exposes a standardized ERC-4626 interface on the vault-facing side while internally bridging to a protocol whose native interface differs from ERC-4626. A non-standard strategy can be any underlying yield source that does not natively expose the ERC-4626 deposit, withdraw, mint, redeem, and valuation functions in the form the OAV expects. This can include lending markets such as AAVE, where positions are represented as native interest-bearing tokens (such as aUSDC) rather than ERC-4626 vault shares, as well as other yield mechanisms whose accounting model differs from ERC-4626.

The wrapper can translate between the OAV's standardized expectations and the underlying protocol's native mechanics. It can deposit assets into the protocol, holds the resulting position internally, exposes valuation through standardized functions like totalAssets, previewRedeem, and convertToAssets, and supports redemption back into the deposit asset. Wrappers can be deliberately minimal in scope to limit attack surface, and they allow the Vault to remain protocol-agnostic.

Non-Standard Strategy B 910 the underlying strategy that does not natively expose the expected interface. A non-standard strategy can be an underlying yield source whose native interface does not conform to ERC-4626. The vault may not interact with such strategies directly; instead, exposure can be achieved through a wrapper that exposes a standardized ERC-4626-style interface to the vault while internally bridging to the protocol-specific mechanics of the underlying source. A representative example is an AAVE V3 USDC lending position integrated through a dedicated wrapper that holds aUSDC internally and exposes a normalized ERC-4626 interface to the OAV. Other examples include yield sources whose accounting is based on protocol-native receipt tokens or on continuously accruing balances that do not natively follow the ERC-4626 share-and-asset model.

Normalized Deposit, Valuation, Redemption, and Reward Functions 912 can show the functional outcome of the wrapper architecture that the vault can treat both strategies consistently.

The normalized functions exposed by either native ERC-4626 strategies or wrappers can fall into two categories. The first category can be asset movement and share issuance: deposit, withdraw, mint, and redeem. These can allow the Vault to allocate deposit assets into a strategy in exchange for strategy shares and to redeem strategy shares back into deposit assets. The second category is valuation and accounting: totalAssets, previewRedeem, and convertToAssets. These can allow the Vault to value strategy positions consistently in deposit-asset terms, regardless of how the underlying protocol accounts for its own positions internally.

Together, these functions can form the abstraction layer that lets the vault manage heterogeneous yield sources as a uniform portfolio. They can also be the mechanism by which guardrails such as drift thresholds and capacity-aware allocation can be applied consistently across strategies.

For example, when the vault allocates 100,000 USDC into an AAVE wrapper, the wrapper's deposit(100000, OAV) call moves USDC into AAVE V3 and mints, say, 99,500 wrapper shares to the OAV. When the vault later needs to value that position, it calls previewRedeem(99500) on the wrapper, which returns the current redeemable USDC amount, including accrued interest. When the vault needs to recover capital, it can call redeem(99500), and the wrapper unwinds the underlying AAVE position back into USDC and transfers it to the Vault.

The logic is that the systems as described herein can support heterogeneous strategies without forcing all strategies to be architecturally identical. By normalizing the interaction layer, the vault can preserve one accounting and execution framework across diverse strategy types.

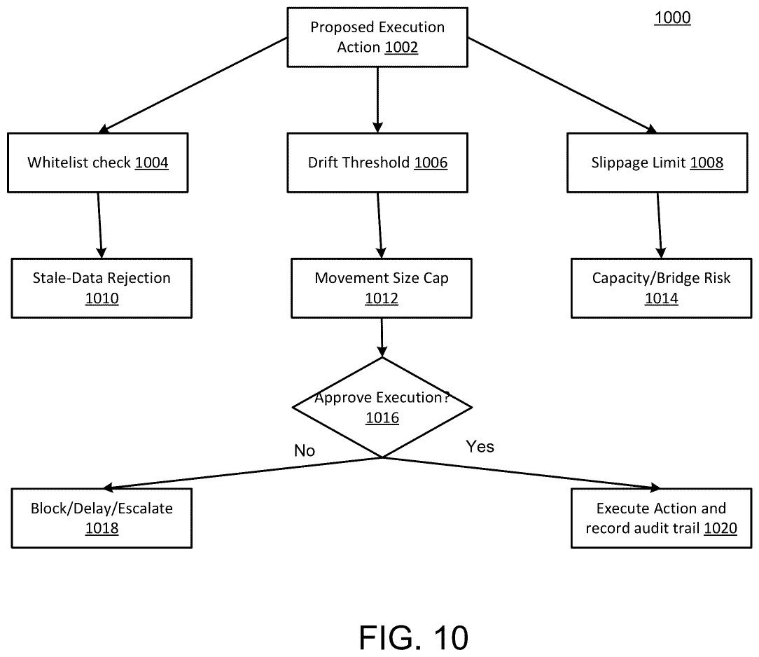

FIG. 10 is a flow diagram illustrating an example guardrail evaluation process in which a proposed execution action is tested against whitelist, drift, slippage, stale-data, movement-size, capacity, and/or bridge-risk conditions before the action is either blocked, delayed, escalated, or executed with an associated audit trail.

A proposed execution action 1002 can include the candidate action, such as a rebalance, migration, swap, or cross-chain transfer.

A whitelist check 1004 verifies whether the target strategy, destination, or route is permitted. This can include comparing the execution action 1002 with user whitelisted actions for the user.

A drift threshold 1006 can test whether the allocation difference is large enough to justify action. For example, the system can determine whether the execution action 1002 would modify the allocations such that the balance of strategies would move allocations past the drift threshold.

A slippage limit 1008 tests whether the expected execution cost is acceptable. For example, a projection of the execution action 1002 can be performed to identify projected slippage for the action and it can be determined whether the slippage exceeds a threshold value.

A stale-data rejection 1010 checks whether the input data is too old or unreliable. The input data can have related timestamps to determine whether the input data is past a threshold age indicating that the data is old and unreliable.

A movement-size cap 1012 can limit how much value can move in a given action. If the execution action would move the overall value of the user deployed tokens past a threshold, the action can be denied.

A capacity/bridge risk (1014) can evaluate whether the target strategy or bridge path is suitable from a risk/capacity perspective. Capacity can be treated as a function of TVL, strategy caps, and liquidity depth. The off-chain decision engine can use TVL as a proxy for how much capital a strategy can absorb without excessive slippage or diminishing returns, and explicitly penalizes weight assignments that would over-concentrate exposure into low-TVL strategies. Where strategies expose explicit capacity caps, those caps can also be incorporated into the allocation logic. Strategies for which TVL or APY data is missing or invalid are penalized as well, to prevent capital from flowing into opaque or unverified destinations.

Bridge risk can arise in cross-chain operation through the optional OVault layer. Cross-chain interactions can rely on messaging infrastructure (for example, LayerZero) and on share-side OFT representations. The associated risks include messaging failures, replay or proof-validation issues at the messaging endpoints, and bridging-related liquidity or capacity constraints. The system mitigates these through verified cross-chain messaging, role-restricted execution, and the same guardrail framework (allowlists, drift thresholds, slippage protection) that applies to standard rebalancing.

For example, suppose AAVE USDC quotes 4.0% APY with very deep TVL, while a smaller USDC strategy quotes 9.0% APY but with only modest TVL. A naive max-APY allocator would push capital into the higher-yielding option until slippage destroys the realized yield. The TVL-adjusted APY chaser instead caps weight in the smaller strategy by penalizing concentration relative to its TVL, leaving the bulk of capital in the deeper AAVE market. On the cross-chain side, if a LayerZero message between a spoke chain and the hub fails proof validation, the Vault rejects the message rather than minting unbacked shares, preserving accounting integrity.

An approve execution decision block 1016 can be the final decision node that consolidates the guardrail results. Execution approval can be governed by a combination of automated policy and role-based authorization. In automated mode, an operator wallet holding REBALANCER_ROLE may submit transactions to update weights and trigger rebalance( ) once the off-chain engine has produced a target allocation that exceeds the drift threshold and otherwise satisfies the guardrail policy. The operator wallet can have narrowly scoped privileges; it may not move tokens outside whitelisted strategies, grant or revoke roles, change fee parameters, or pause the vault.

In more controlled configurations, the system can support a propose-only mode and a client co-signing or sole-signer mode. In these modes, the off-chain engine can produce a proposed transaction (for example, a setWeights or rebalance call), and execution can require review and signing by a client-controlled multisig such as a Safe wallet. This allows the client to retain ultimate control over high-impact actions while still benefiting from automated optimization.

For example, a client running in fully automated mode allows the REBALANCER_ROLE wallet to autonomously execute a rebalance from 60/35 AAVE/MORPHO to 30/65 AAVE/MORPHO when the optimizer produces that target. A more conservative client running in propose-only mode can require the same change to be proposed by the off-chain engine, queued in a Safe multisig, reviewed by the client's signers, and only executed once the multisig threshold is met.

A block/delay/escalate block 1018 is the path for non-approved actions. The system can support several outcomes when an action does not meet execution criteria. Execution may be skipped when drift is below the configured threshold; in this case, the rebalance attempt is recorded in the audit snapshot with a “skipped” status and a corresponding reason. Execution may be paused through the global pause switch managed by PAUSER_ROLE, which gates deposits, withdrawals, mints, and redeems during incidents or maintenance. Execution may be delayed or escalated by routing the action through propose-only or co-signing modes, where automated execution is replaced by a review-and-sign workflow before the transaction can be broadcast.

Additional planned controls, such as maximum move-size limits per rebalance, manual-approval thresholds for large reallocations, and explicit risk-score-driven gating, can be described as forthcoming guardrails that integrate with the same role-based and snapshot-based framework.

For example, if the off-chain engine proposes a marginal rebalance with 0.5% drift, the run is logged as “skipped: below drift threshold.” If a security incident is detected at a whitelisted strategy, PAUSER_ROLE pauses the vault so that no further deposits, withdrawals, or rebalances can occur until the incident is resolved. If the optimizer proposes a very large reallocation that exceeds a planned move-size guardrail, the transaction can be escalated rather than auto-executed, that can require client multisig approval before broadcast.

An execute action and record audit trail 1020 can include the approved path, and it includes preserving an audit record of what was done. The audit record can store data relating to the execution action and specifics to how the modification to the user token allocations was made, such as the new allocations of the user tokens, smart contract data for this action, an amount of user tokens at the time of the action, etc.

The high-level logic is that execution is constrained by a formal validation framework. This helps show that the invention is designed for controlled, policy-bounded operation rather than unconstrained token movement.

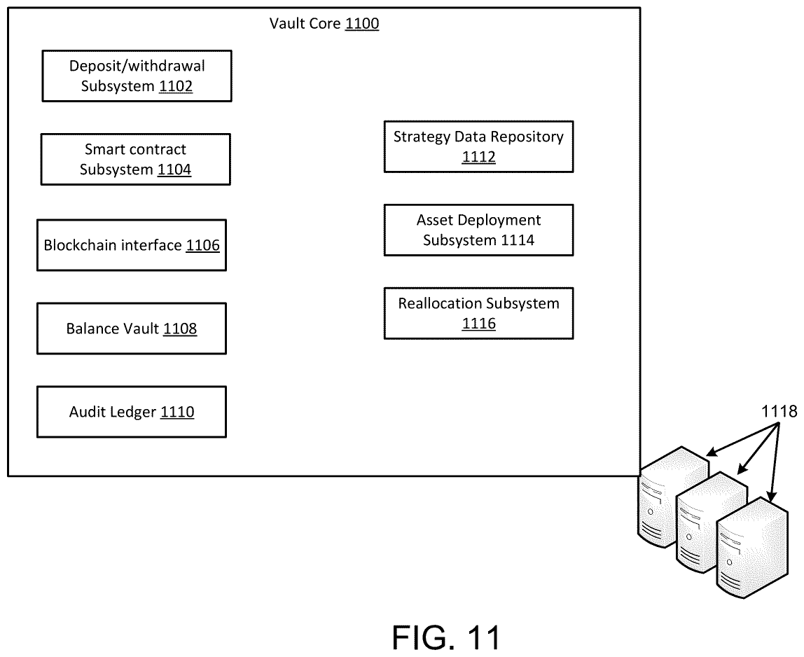

FIG. 11 illustrates an example vault core 1100. The vault core 1100 can be implemented on one or more interconnected computing devices 1118. Devices 1118 can interact with other computing devices, such as external AI model servers, data repositories, user devices, etc.

Vault core 1100 can include a deposit/withdrawal subsystem 1102. The deposit/withdrawal subsystem 1102 can facilitate cryptographic token transfers between the vault 1100 and a user device. This can include generating smart contracts via smart contract subsystem 1104 to assign or fully transfer user token assets from a user to the vault 1100. In response, vault can mint vault tokens that can be held for the user or transferred to the user device by appending a blockchain to immutably identify the transaction.

Vault core 1100 can include a smart contract subsystem 1104. Smart contract subsystem 1104 can generate smart contracts for any transaction as described herein. For instance, upon a request to withdraw tokenized assets, smart contract subsystem 1104 can generate a smart contract to unassign user token assets from a strategy and have the contract appended to the blockchain. Further, smart contract subsystem 1104 can swap vault tokens for another token type that is transferred to the user via smart contracts. Each smart contract can automatically include details relating to a transfer, such as a sender wallet address, a recipient wallet address, a token type, token amount, and other metadata.

Vault core 1100 can include a blockchain interface 1106. Blockchain interface 1106 can allow for appending data to one or more blockchains. For instance, blockchain interface 1106 can append smart contract information, minted vault tokens, tokenized assets, etc., to one or more blockchains. Blockchain interface 1106 can further swap tokens between various token types across multiple chains.

Vault core 1100 can include a balance vault 1108. The balance vault 1108 can store a portion of tokens deposited by a user based on profile data specific to the user. For instance, balance vault 1108 can hold a subset of user tokens that are to be deployed when user preferences change, environmental parameters for any strategy change, valuations for different tokenized assets change, etc. The vault 1108 can implement various cryptographic encryption to maintain security of the tokenized assets and related data.

Vault core 1100 can include an audit ledger 1110. Audit ledger 1110 can include a repository of user-related token transaction data. For instance, as user tokens are deposited to the vault, new vault tokens are minted, smart contracts are generated, tokenized assets are deployed, reallocation of tokens is performed, and withdrawal of tokenized assets, each action can be independently recorded automatically in the ledger 1110. Audit ledger 1110 can provide compliance and data retention capabilities to track all tokenized assets for the user, vault shares, etc., as tokenized assets are deployed into various strategies.

Vault core 1100 can include a strategy data repository 1112. Strategy data repository 1112 can include instructions relating to deploying tokenized assets as part of various strategies. Example strategies can include tokenized asset staking, assigning tokens to liquidity pools, translating tokens into alternative tokenized assets (e.g., altcoins) on various blockchains, etc. Each strategy can have different risk profiles and time allotments that the vault core 1100 processes in deploying the tokenized assets.

Vault core 1100 can include an asset deployment subsystem 1114. Asset deployment subsystem 1114 can determine parameters for deploying portions of user tokens as part of different strategies. This can include generating smart contracts, via smart contract subsystem 1104, to stake tokenized assets, deploy tokenized assets into liquidity pools, etc.

The asset deployment subsystem 1114 can continuously monitor each strategy and determine whether each strategy has shifted such that tokenized assets should be reallocated to or from that strategy. For example, if a first strategy has a security breach identified as part of its underlying infrastructure, the asset deployment subsystem 1114 can determine that user tokens should be moved from the first strategy to a second strategy. This can involve generating smart contracts to unassign user tokens and subsequently assign the tokens a blockchain according to the second strategy. The reallocation of the user tokens can be implemented via reallocation subsystem 1116.

Vault core 1100 can include a reallocation subsystem 1116. Reallocation subsystem 1116 can, responsive to a triggering event occurring for a given strategy, identify a new strategy to deploy tokens and reassign user tokens according to the new strategy. This can include unassigning or removing tokens from blockchains part of the first strategy, such as to generate new smart contracts and appending blocks to blockchain(s) to remove or unassign the tokens from the blockchain(s). The reallocation subsystem 1116 can further re-assign the tokenized assets to new smart contracts or blockchains that are part of the new strategy.

### Network Examples

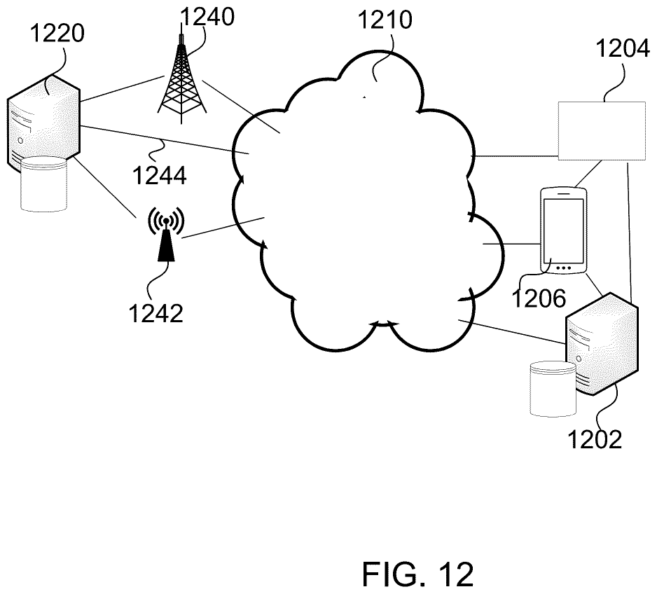

Systems and methods here may utilize a networked computing arrangement as shown in FIG. 12. The computer used for these steps could be any number of kinds of computers, such as a mobile device 1206, laptop, desktop, tablet, phablet, smartphone, or any other kind of device used to process and transmit digitized data.

Turning back to FIG. 12, the data captured from whichever computer may be analyzed on a back end system instead of or in addition to a local computer. In such examples, data may be transmitted to a back end computer 1220 and associated data storage 1202 for saving, analysis, computation, comparison, or other manipulation. The networked arrangement may further include one or more network elements 1204, such as a router, switch, gateway, or hub, coupling the back end computer 1220 and associated data storage 1202 to the network 1210. In some examples, additionally or alternatively, the transmission of data may be wireless 1240, 1242 by a cellular or Wi-Fi transmission with associated routers and hubs. In some examples, additionally or alternatively, the transmission may be through a wired connection 1244. In some examples, additionally or alternatively, the transmission may be through a network such as the internet 1210 to the back end server computer 1220 and associated data storage 1202. In some examples, additionally or alternatively, the storing, analyzing, and/or processing of data may be accomplished at the computer which is involved in the original data collection. In some examples, additionally or alternatively, the data storing, analyzing, and/or processing may be shared between the local computer 1206 and a back end computing system 1220. In such examples, networked computer resources 1220 may allow for more data processing power to be utilized than may be otherwise available at the local computers. In such a way, the processing and/or storage of data may be offloaded to the compute resources that are available. In some examples, additionally or alternatively, the networked computer resources 1220 may be virtual machines in a cloud or distributed infrastructure. In some examples, additionally or alternatively, the networked computer resources 1220 may be spread across many multiple physical or virtual computer resources by a cloud infrastructure. The example of a single computer server 1220 is not intended to be limiting and is only one example of a compute resource that may be utilized by the systems and methods described herein. In some examples, additionally or alternatively, artificial intelligence and/or machine learning may be used to perform any of the steps as described herein.

### Example Computer Devices

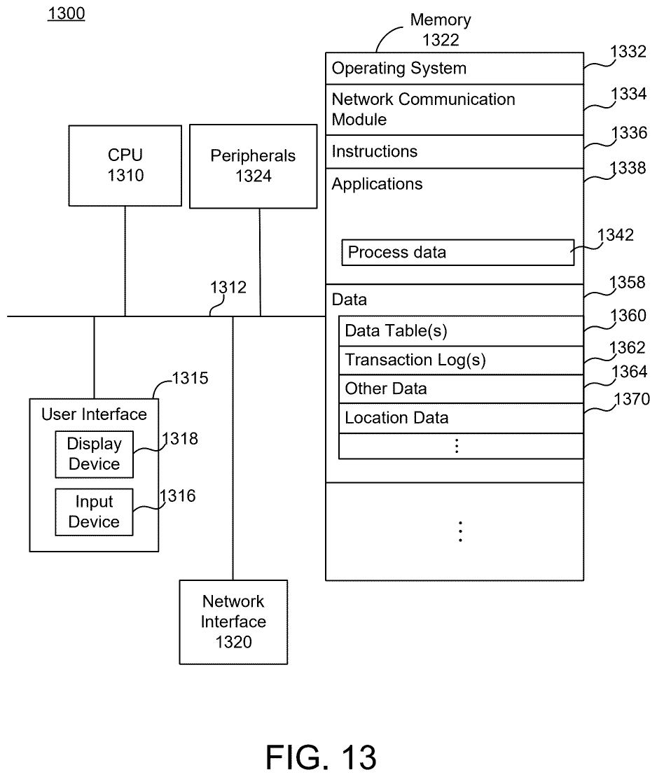

FIG. 13 shows an example computing device 1300 which may be used in the systems and methods described herein. In the example computer 1300 a CPU or processor 1316 is in communication by a bus or other communication 1312 with a user interface 1315. The user interface includes an example input device such as a keyboard, mouse, touchscreen, button, joystick, or other user input device(s). The user interface 1315 also includes a display device 1318 such as a screen. The computing device 1300 shown in FIG. 13 also includes a network interface 1320 which is in communication with the CPU 1316 and other components. The network interface 1320 may allow the computing device 1300 to communicate with other computers, databases, networks, user devices, or any other computing capable devices. In some examples, additionally or alternatively, the method of communication may be through WIFI, cellular, Bluetooth Low Energy, wired communication, or any other kind of communication. In some examples, additionally or alternatively, the example computing device 1300 includes peripherals 1324 also in communication with processor 1316. In some examples computing device 1300 a memory 1322 is in communication with the processor 1316. In some examples, additionally or alternatively, this memory 1322 may store instructions 1310 executable by the processor 1316 to carry out one or more operations described herein. In some examples, additionally or alternatively, this memory 1322 may include instructions to execute software such as an operating system 1332, network communications module 1334, other instructions 1336, applications 1338, applications to process data 1342, data storage 1358, data such as data tables 1360, transaction logs 1362, sample data 1364, sample location data 1370 or any other kind of data.

In some embodiments, the system includes one or more computing systems comprising processors, memory, and communication interfaces configured to interact with one or more blockchain networks. The computing systems may include on-chain smart contracts, off-chain execution services, or hybrid arrangements that combine smart-contract logic with off-chain data retrieval, decision computation, and transaction submission.

In some embodiments, a vault core receives deposits of the deposit asset from users and, in response, mints vault shares representing proportional interests in managed assets. The vault core may maintain a share ledger, user balances, an idle-asset balance, and one or more strategy-position records.

In some embodiments, the strategy-position records correspond to multiple approved strategies. Each strategy-position record may store a current position amount, a current redeemable value, a current or historical target allocation, one or more liquidity attributes, one or more reward attributes, one or more risk attributes, and operational metadata such as strategy status or whitelist status.

In some embodiments, the system includes a strategy interface registry identifying approved strategies and the interfaces through which the vault interacts with them. The registry may store native standardized interfaces, wrapper interfaces, or both. One strategy may expose a first valuation function, another may expose a preview redemption function, and a third may require a wrapper to transform its native state into a standardized form consumable by the vault core.

In some embodiments, the vault core determines a total asset value based on the idle-asset balance and the redeemable values of assets deployed to the approved strategies. The total asset value may be expressed in units of the deposit asset, a reference asset, or another accounting denomination selected by the system.

In some embodiments, the vault core or an associated valuation routine queries or otherwise obtains data from each strategy interface to determine redeemable value. For example, the system may use a preview function, a conversion function, a redemption estimate, a balance query, a wrapper calculation, an oracle-assisted conversion, or another valuation process to translate each strategy position into a common accounting unit.

In some embodiments, the system determines a share issuance amount for a deposit based on the deposit amount, the total asset value, and the quantity of outstanding vault shares. In an initial state, the system may use a bootstrap or seed rule. In later states, the system may mint shares in a manner that preserves proportionality between outstanding shares and the total asset value.

In some embodiments, the system processes redemptions by determining the redeeming user's proportional entitlement based on the number of shares being redeemed relative to outstanding shares and by translating that entitlement into one or more settlement actions involving idle assets, strategy exits, pending withdrawals, or combinations thereof.

In some embodiments, the system maintains an idle reserve. The idle reserve may be configurable and may serve one or more purposes, including facilitating ordinary withdrawals, reducing unnecessary churn, accommodating near-term migration actions, mitigating execution risk, or preserving optionality during periods of elevated uncertainty.

In some embodiments, one or more decision routines determine target strategy-position values or target weights. Such routines may be implemented entirely on-chain, entirely off-chain, or in a hybrid manner. Inputs may include current strategy-position values, quoted yield, realized yield, liquidity characteristics, reward rates, reward-token conversion rates, slippage estimates, total value locked, capacity, historical volatility, transaction cost, bridge cost, protocol-specific risk signals, or other data.

In some embodiments, the decision routines may include rule-based logic, threshold logic, scoring logic, optimization logic, machine-learning logic, or combinations thereof. In one example, the routine computes a target value for each approved strategy and compares the target value to the current value to determine whether an actionable drift exists.

In some embodiments, a rebalance routine generates instructions to reduce positions that exceed target values and to increase positions that fall short of target values. The rebalance routine may route value through the idle balance, may sequence withdrawals before deposits, and may limit net movement according to one or more configurable conditions.

In some embodiments, the rebalance routine does not execute unless a guardrail routine approves the proposed action. Guardrails may include, without limitation, whitelist validation, threshold drift validation, stale-data rejection, max-slippage checks, strategy capacity checks, bridge risk checks, minimum-value thresholds, movement-size caps, transaction-cost limits, and manual approval triggers for actions exceeding one or more thresholds.

In some embodiments, the system can distinguish between immediate-liquidity strategies and delayed-liquidity strategies. Immediate-liquidity strategies may permit same-transaction or near-immediate redemption. Delayed-liquidity strategies may impose cooldowns, queue periods, notice periods, or asynchronous settlement requirements.

In some embodiments, when processing a withdrawal request, the system determines a first portion that can be satisfied from the idle balance or immediately redeemable positions and a second portion that is attributable to one or more delayed-liquidity strategies. The system may immediately settle the first portion and create a pending withdrawal record for the second portion.

In some embodiments, the pending withdrawal record may identify the requesting user, the requested asset amount or share amount, an immediately satisfied amount, a deferred amount, one or more source strategies associated with the deferred amount, timestamps, status values, queue position, or other metadata.

In some embodiments, the system initiates an exit process for the deferred amount by submitting a request to a delayed-liquidity strategy, placing value into a cooldown or queue, or otherwise performing actions needed to make value available later. Once liquidity becomes available, the system completes deferred settlement by transferring value to the user or by making such value claimable.

In some embodiments, the system may reserve, escrow, burn, lock, or otherwise state-mark shares corresponding to the deferred amount in order to preserve accounting integrity while deferred settlement remains outstanding. In some embodiments, the system updates the share ledger and pending withdrawal record concurrently.

In some embodiments, the system may prioritize certain withdrawal exits according to configurable criteria, such as queue position, user tier, liquidity source, gas efficiency, strategy risk, or settlement age. In some embodiments, the system may reduce future target allocations to a delayed-liquidity strategy while outstanding pending withdrawals remain associated with that strategy.

In some embodiments, the system is configured to harvest reward assets produced by one or more strategies. Reward assets may include incentive tokens, governance tokens, fee tokens, native assets, wrapped assets, or other digital assets obtained through strategy participation.

In some embodiments, harvested reward assets are converted into the deposit asset or another selected asset through one or more swap mechanisms. The resulting value may then be added to the idle balance, redeployed to one or more strategies, allocated according to current target allocations, used to satisfy pending withdrawals, or otherwise processed by the vault.

In some embodiments, one or more fees are realized by minting vault shares to a fee recipient. The fee recipient may be an operator, protocol treasury, service provider, governance-controlled address, or another designated recipient. By minting shares rather than liquidating managed assets, the system may reduce disruption to deployed positions.

In some embodiments, fee realization may depend on deposit amounts, elapsed time, increases in total asset value, realized gains, harvested rewards, or other performance indicators. Different fee types may be implemented separately or in combination.

In some embodiments, the approved strategy set can be modified over time. A strategy-migration routine may remove a first strategy, withdraw value from the removed strategy to the idle balance, modify the strategy registry, add a replacement strategy, update target allocations, and rebalance value into the replacement strategy or among remaining strategies.

In some embodiments, strategy migration may occur in response to changing yield opportunities, strategy shutdowns, whitelist changes, risk events, compliance events, governance actions, technical issues, or other triggers. Migration may be subject to the same or additional guardrails used for rebalancing.

In some embodiments, the system further includes a risk-monitoring routine configured to detect one or more adverse conditions, such as unusual valuation changes, oracle anomalies, strategy pause states, bridge disruptions, abnormal slippage, loss of whitelist status, or other indicators of concern. In response, the system may pause deposits, pause rebalancing, exit or reduce one or more strategies, increase the idle reserve, require manual approval, or take other protective action.

In some embodiments, the system includes off-chain services that periodically or event-driven retrieve strategy data, compute proposed target allocations, generate audit records, and submit transactions. In other embodiments, more of the logic may reside on-chain. The disclosure is intended to cover either approach and combinations thereof.

In some embodiments, the system stores execution metadata for deposits, rebalances, migrations, harvests, withdrawals, pending-withdrawal settlements, and cross-chain operations. Such metadata may include timestamps, initiators, strategy identifiers, current values, target values, drift values, validation outcomes, transaction identifiers, and status indicators.

In some embodiments, the system can operate across multiple blockchain networks. A first-chain vault component may receive deposits and maintain a share ledger, while value is deployed to one or more second-chain strategies through a cross-chain coordination routine.

In some embodiments, the cross-chain coordination routine maintains a settlement record that preserves a defined accounting relationship between issued vault shares and total managed asset value across chains. The settlement record may associate first-chain shares with value represented by an idle balance, local strategy positions, remote strategy positions, pending bridge transfers, or combinations thereof.

In some embodiments, the system uses verified cross-chain messages before updating the settlement record, minting or burning shares, crediting or debiting value, or executing a rebalance or withdrawal involving remote value. Verification may include endpoint validation, replay protection, sender validation, message sequencing, threshold authorization, proof validation, or other message integrity checks.

In some embodiments, when value is returned from a remote strategy or a remote chain, the system updates the settlement record and may make such value available for a withdrawal, redeploy it into a local or remote strategy, or retain it in an idle balance. In some embodiments, a user can deposit on one chain without directly interacting with a second chain on which at least some strategy exposure is maintained.

In some embodiments, the vault shares may themselves be represented on multiple chains, or the system may instead maintain a canonical ledger on one chain with mirrored or referenced representations elsewhere. The specific cross-chain share representation may vary by implementation.

In some embodiments, the system uses standardized interfaces for some strategies and wrappers for others, thereby enabling a single vault to manage heterogeneous yield sources while using a common valuation and execution framework. This can permit a user-facing deposit-and-hold experience while the system internally handles different strategy mechanics.

In some embodiments, the disclosed architecture supports numerous operational modes, including a conservative mode with larger idle reserves and stricter guardrails, an aggressive mode with lower idle reserves and broader allocation changes, a manual-approval mode for certain migrations or bridge operations, and a fully automated mode subject to configurable thresholds.

In some embodiments, the disclosed architecture can be used with one or more user-facing interfaces that display share balances, current total asset value, current and target allocations, pending withdrawals, historical yield data, reward harvest events, and system health indicators. Such interfaces are illustrative and not limiting.

In some embodiments, a valuation routine may use one or more accounting constants, smoothing parameters, minimum-liquidity parameters, or initialization parameters. In other embodiments, simpler accounting may be used. The claims are intended to cover both mathematically formalized and less formalized implementations so long as the claimed structural and operational relationships are present.

In some embodiments, target allocations are expressed as percentages, weights, target amounts, target ranges, or threshold-based preferences. A target may apply to a single strategy, a grouped strategy class, a chain-specific bucket, a liquidity bucket, or a risk bucket.

In some embodiments, the system may preferentially route new deposits to under-allocated strategies rather than immediately moving value out of over-allocated strategies, thereby reducing unnecessary turnover. In some embodiments, the system may also use harvested rewards or returned bridge value to move allocations toward targets.

In some embodiments, the system maintains an audit trail for execution decisions. The audit trail may identify the data used to determine a proposed action, the guardrails evaluated, the approval or rejection result, and the resulting transaction or state transition.

In some embodiments, the strategy interface registry may limit interactions to whitelisted strategies only, and execution routines may reject instructions that attempt to deploy value to unapproved destinations or to transfer managed assets outside permitted flows.

In some embodiments, the disclosed subject matter may be implemented with computer-readable instructions stored in non-transitory memory and executed by one or more processors, with some functions further implemented in smart contracts or other distributed execution logic.

In an example, a digital asset management system can include one or more processors and a memory. The memory can store instructions that, when executed by the one or more processors, cause the one or more processors to operate a vault core. The vault core can be implemented on a computing device and configured to receive a deposit of a deposit asset (e.g., a crypto token asset), maintain an idle-asset balance, mint vault shares in a share ledger, maintain a plurality of strategy-position records corresponding to a plurality of approved yield-generating strategies, determine a total asset value from the idle-asset balance and redeemable values of assets deployed to the approved yield-generating strategies, and process redemption requests based on the total asset value and an amount of the vault shares.

The system can also include a strategy interface registry storing interfaces for the approved yield-generating strategies. At least one of the interfaces can include a wrapper or adapter exposing a standardized valuation or redemption function for a strategy lacking a native standardized vault interface. The interfaces can also include a rebalance routine configured to determine target strategy-position values, compare the target strategy-position values with current strategy-position values, and generate withdrawal instructions for over-allocated strategy positions and deposit instructions for under-allocated strategy positions. The interfaces can also include a guardrail routine configured to permit execution of the withdrawal instructions and the deposit instructions only after validating whitelist status and at least one operational condition comprising a drift threshold, a slippage limit, stale-data rejection, a movement-size limit, or a strategy capacity limit.

In some instances, the vault core can maintain an idle reserve as at least part of the idle-asset balance for satisfying withdrawals, facilitating migrations, or limiting execution churn.

In some instances, the vault core can harvest reward assets from one or more of the approved yield-generating strategies, convert the reward assets into the deposit asset or another selected asset, and add resulting value to the idle-asset balance or redeploy the resulting value according to current target strategy-position values.

In some instances, the vault core can realize at least one of a deposit fee, a management fee, or a performance fee by minting additional vault shares to a fee recipient.

In some instances, the target strategy-position values are determined using one or more inputs comprising quoted yield, realized yield, liquidity, reward rate, reward-token conversion rate, slippage estimate, total value locked, capacity, transaction cost, bridge cost, or risk data.

In some instances, the vault core can, in response to a withdrawal request, determine a first withdrawal portion satisfiable from currently available liquidity and a second withdrawal portion associated with a delayed-liquidity strategy, immediately settle the first withdrawal portion, create a pending withdrawal record for the second withdrawal portion, initiate an exit process for the delayed-liquidity strategy, and complete settlement of the second withdrawal portion when liquidity becomes available.

In some instances, the vault core can update the approved yield-generating strategies by withdrawing value from a removed strategy to the idle-asset balance, modifying the strategy interface registry, adding a replacement strategy, updating the target strategy-position values, and rebalancing value into one or more remaining or replacement strategies.

In some instances, the system can include a cross-chain coordination routine configured to maintain a settlement record associating issued vault shares with managed asset value deployed across at least a first blockchain network and a second blockchain network, and to update the settlement record in response to verified cross-chain messages.

In another example, a computer-implemented method of managing digital assets is provided. The method can include receiving, by a vault core executed by one or more processors, a deposit of a deposit asset. The method can also include minting vault shares in a share ledger. The method can also include maintaining an idle-asset balance and a plurality of strategy-position records corresponding to a plurality of approved yield-generating strategies.

The method can also include obtaining, through a strategy interface registry, redeemable values for assets deployed to the approved yield-generating strategies, wherein at least one strategy is accessed through a wrapper or adapter exposing a standardized valuation or redemption function. The method can also include determining a total asset value from the idle-asset balance and the redeemable values.

The method can also include determining target strategy-position values. The method can also include comparing the target strategy-position values with current strategy-position values. The method can also include validating one or more guardrails comprising whitelist status and at least one of a drift threshold, a slippage limit, stale-data rejection, a movement-size limit, or a strategy capacity limit. The method can also include, when the one or more guardrails are satisfied, executing a rebalance by withdrawing value from one or more over-allocated strategy positions and depositing value into one or more under-allocated strategy positions.

In some instances, the method can include determining a quantity of vault shares to mint for the deposit based on the deposit, the total asset value, and outstanding vault shares so as to preserve a proportional relationship between outstanding vault shares and managed asset value.

In some instances, determining the target strategy-position values comprises evaluating one or more of quoted yield, realized yield, liquidity, reward rate, reward-token conversion rate, slippage estimate, total value locked, capacity, transaction cost, bridge cost, or risk data for each of the approved yield-generating strategies.

In some instances, the method can include harvesting reward assets from one or more approved yield-generating strategies, converting the reward assets into the deposit asset or another selected asset, and adding resulting value to the idle-asset balance or redeploying the resulting value according to the target strategy-position values.

In some instances, the method can include realizing at least one of a deposit fee, a management fee, or a performance fee by minting additional vault shares to a fee recipient.

In some instances, the method can include processing a withdrawal request by determining a first withdrawal portion available from the idle-asset balance or immediately redeemable strategy positions, determining a second withdrawal portion associated with a delayed-liquidity strategy, immediately settling the first withdrawal portion, creating a pending withdrawal record for the second withdrawal portion, initiating an exit process associated with the delayed-liquidity strategy, and completing settlement of the second withdrawal portion after liquidity becomes available.

In some instances, the method can include updating an approved strategy set by withdrawing value from a removed strategy into the idle-asset balance, adding a replacement strategy to the strategy interface registry, updating the target strategy-position values, and rebalancing value into one or more remaining or replacement strategies.

In some instances, the method can include maintaining a settlement record associating issued vault shares with managed asset value deployed across a plurality of blockchain networks and updating the settlement record in response to a verified cross-chain message associated with a withdrawal, deposit, rebalance, or settlement action.

In another example embodiment, a non-transitory computer-readable medium is provided. The medium can store instructions that, when executed by one or more processors, cause the one or more processors to perform a series of steps. The steps can include receiving a deposit of a deposit asset for a vault and minting vault shares in a share ledger. The steps can include maintaining an idle-asset balance and a plurality of strategy-position records corresponding to a plurality of approved yield-generating strategies.

The steps can include obtaining, through a strategy interface registry, redeemable values for assets deployed to the approved yield-generating strategies, wherein at least one strategy is accessed through a wrapper or adapter exposing a standardized valuation or redemption function. The steps can include determining a total asset value from the idle-asset balance and the redeemable values. The steps can include determining target strategy-position values. The steps can include comparing the target strategy-position values with current strategy-position values. The steps can include validating one or more guardrails comprising whitelist status and at least one of a drift threshold, a slippage limit, stale-data rejection, a movement-size limit, or a strategy capacity limit. The steps can include, when the one or more guardrails are satisfied, executing a rebalance by withdrawing value from one or more over-allocated strategy positions and depositing value into one or more under-allocated strategy positions.

In some instances, the instructions further cause the one or more processors to process a withdrawal request by determining a first withdrawal portion satisfiable from currently available liquidity, determining a second withdrawal portion associated with a delayed-liquidity strategy, creating a pending withdrawal record for the second withdrawal portion, initiating an exit process for the delayed-liquidity strategy, and completing deferred settlement after liquidity becomes available.

In some instances, the instructions further cause the one or more processors to maintain a settlement record associating issued vault shares with managed asset value deployed across a plurality of blockchain networks and to update the settlement record in response to a verified cross-chain message.

In some instances, the instructions further cause the one or more processors to realize at least one of a deposit fee, a management fee, or a performance fee by minting additional vault shares to a fee recipient and to harvest reward assets from one or more approved yield-generating strategies for conversion into the deposit asset or another selected asset.

In some instances, a true APY (tAPY) calculation engine can include a specialized component that calculates the true annual percentage yield earned by vault depositors in the OAV by the off-chain module, reflecting real-world factors. The tAPY engine models the actual user yield by incorporating: Compounding Frequency (N) that defines how often yields are harvested and reinvested within the vault per year. Reward Token Conversion Rate (p) and Slippage (σ) can include a conversion of any reward tokens into the base deposit asset, including price differences and slippage from swapping. Reward Volatility can include a fluctuation in value of reward tokens over time, to avoid overestimating yield if those token prices decline. Base and Bonus Yields (α₀, α₁) can include a base APY from the primary yield of the strategy (α₀) and any additional APY from incentive rewards (α₁).

Using these factors, the engine can compute a more accurate effective APY (denoted as tAPY) that a user can expect to realize. This true APY can be updated continuously and presented to users, ensuring transparency and preventing the miscommunication of inflated yields common in standard DeFi advertising. It can effectively bridge the gap between theoretical yields and actual realized returns, building user trust especially for institutional adopters who require honest reporting.

A vault health status interface can provide a transparent, human-readable health status page or dashboard for the vault. This interface can aggregate and display key information about the vault's performance and status in real time. Users (and integrators, such as fintech apps connecting to the vault) can easily see the current tAPY, the allocation breakdown across strategies, current total assets under management, recent yield harvests, fee accruals, and any active alerts or risk flags raised by the sentinel. The status page may present simple indicators (e.g. a health score or color-coded status for each strategy) and plain-language messages (e.g. “All strategies operating normally” or “Withdrawal from Strategy X in progress—2 days until completion”). This transparency assures users of the vault's activities and health without requiring them to parse complex blockchain data.

In some instances, the vault can implement a fee mechanism that programmatically calculates and collects various fees-such as deposit fees, performance fees, and management fees-by minting vault shares (or tokens) to the fee recipient or directly deducting assets. All fees are codified in the smart contract, ensuring predictability and trust. For instance, if a performance fee of 20% on profits is in effect, whenever the vault realizes new profit (e.g. upon a reward harvest), the contract will mint new vault shares equal to 20% of that profit and allocate them to a designated fee address (such as the vault operator or a treasury). This increases the total supply of vault shares, effectively allocating a portion of the gain to the fee collector while the remaining 80% of profit increases the value of user-held shares. Similarly, a management fee (e.g. 2% annualized) can be implemented by periodically minting a small number of shares for the fee collector based on the vault's total assets under management. Deposit fees (e.g. 0.5% upfront) can be taken by minting a slight reduction in the depositor's initial shares and assigning that difference to the fee address. This share minting approach allows fees to be collected in a non-disruptive and transparent manner without requiring separate asset transfers; users simply see a slightly lower share of the vault, corresponding to the fees, and all calculations are open for audit on-chain.

In some instances, the system includes a persona module designed to support tiered user experiences within the vault. This module determines a user's membership tier based on on-chain signals (such as wallet holdings, staking activity, or historical participation in the protocol) and optionally off-chain data (e.g. KYC verification, referral programs, or institutional affiliation). Based on their tier, users may receive differentiated benefits, such as reduced fees (e.g. discounted performance or management fees), priority access to liquid tokens during withdrawal events, early access to new strategies or vault features, and/or customized compounding frequency or allocation weighting.

In some instances, the vault periodically (on a schedule or when triggers indicate it's optimal) account for profit, losses and harvests reward tokens accrued from each underlying strategy. The reward tokens could include governance tokens, incentive tokens, or additional yield tokens that the strategies provide. Upon harvesting, the system immediately accounts for any profits or losses since the last harvest and converts the incentive token rewards into the vault's primary deposit asset. It can implement intelligent conversion strategies to minimize slippage and trading fees, possibly using price oracles or aggregators to get the best exchange rate. After conversion, the newly obtained base assets can be reinvested into the vault—either reallocated into the various strategies in proportion to current allocations or directed by the AI rebalancer to whichever strategies are most optimal at that moment. This entire loop can occur without any user action. As a result, depositors enjoy a single-asset experience—they deposit one type of token and eventually withdraw that same token, all while the system behind the scenes handles multiple reward types and compounding. The outcome is a significantly enhanced yield (due to frequent compounding and avoidance of idle rewards) and a user experience comparable to a simple savings account (the user deposits an asset and watches their balance grow over time, with none of the intermediate steps visible or required from them).

In some instances, the system can be built to be blockchain-agnostic and can operate across multiple networks, thereby unlocking cross-chain yield opportunities. An integrated token handling subsystem can ensure compatibility and smooth transfer of assets:

In some instances, if a user deposits a native blockchain coin (such as ETH on Ethereum or MATIC on Polygon or a Stablecoin), the system will automatically wrap it into its ERC-20 equivalent (WETH, WMATIC, etc.) or an appropriate representation so that it can interact with DeFi protocols on that network. This wrapping and unwrapping is done seamlessly within the deposit and withdrawal process.

In some instances, if the vault needs to allocate tokens to a strategy that requires a different token than the deposit asset, the subsystem can swap the necessary amount using on-chain liquidity pools or decentralized exchanges. For example, if the vault is primarily a USDC vault but one whitelisted strategy accepts DAI stablecoin, the allocation engine may swap some USDC to DAI to invest in that strategy, then swap back to USDC on exit. These swaps are executed optimally to reduce slippage and fees.

In some instances, the system can support allocation to strategies on other blockchains. For instance, suppose the vault is deployed on Ethereum but a high-yield strategy exists on Binance Smart Chain or Avalanche. The system can bridge a portion of the assets to the target chain (locking the asset on the source chain and releasing a corresponding asset on the destination chain) and then deploy into the strategy on that chain via a counterpart strategy contract. The architecture may include interconnected vault contracts or adapters on each chain that communicate through cross-chain messages to coordinate deposits and withdrawals. To the user, this cross-chain activity is invisible—they interact only with the vault on their origin chain, and the system handles moving value to where it can earn the best returns. By enabling automated bridging, the system maximizes yield opportunities without confining the user to a single network's offerings. It also handles bridging back assets when needed (for example, when a user withdraws or when the rebalancer decides to pull tokens back due to changing yields or risks on the other chain).

In some instances, the system can employ predictive modeling (using techniques like time-series forecasting or even reinforcement learning). For instance, it might analyze patterns to anticipate when a liquidity mining program will end or when a competitor vault's entry might dilute yields, and proactively move tokens ahead of that event. It could simulate “what-if” scenarios—e.g., “If we move 10% more into Strategy A, how does that affect overall portfolio tAPY and risk?”—and then choose the scenario that maximizes expected utility.

In some instances, when a decision is made, the rebalancer coordinates with the smart contracts to carry it out. This might involve calling a function that withdraws a certain amount from one or more strategies and another function to deposit into others. These operations are atomic or coordinated so that the portfolio transitions smoothly from old allocation to new allocation. The system may also account for transaction costs in its decisions; for example, it won't churn small amounts back and forth if the gas fees would outweigh the yield benefit.

In some instances, the system can suggest adding new strategies or removing existing ones (with appropriate governance approval). For example, if a new DeFi protocol emerges with attractive yield and proven security, the AI might flag it as a candidate for inclusion. Conversely, if an existing strategy's risk becomes unacceptable, the AI might recommend dropping it entirely.

In an embodiment, the system can include a comprehensive quantitative risk scoring subsystem. This subsystem can continuously evaluate multiple risk vectors for each strategy and assigns each a numerical sub-score on a standardized 0-100 scale (where 0 indicates no detected risk and 100 indicates extreme risk). The risk vectors can include, but are not limited to: smart contract exploitability that can include a risk of vulnerabilities or bugs in the strategy's smart contracts being exploited; an oracle manipulation risk that can include a risk of price feed or oracle data being manipulated to affect the strategy; a governance centralization that can include a risk arising from concentrated control or admin privileges in the protocol's governance; a liquidity depth that can include a risk associated with insufficient liquidity or capacity in underlying markets to support large asset movements; a reward token volatility that can include a risk of high price volatility in any reward or yield tokens that the strategy depends on; a collateral fragility that can include a risk of underlying collateral assets failing, depegging, or losing value in a way that jeopardizes the strategy; an exit constraint that can include a risk due to limitations or delays in withdrawing from the strategy (e.g., lock-up periods or withdrawal queues); a composability/dependency chain risk that can include a risk from the strategy's reliance on other protocols or contract layers, where a failure in any dependency impacts the strategy; a cross-chain and bridge risk that can include a risk introduced by using cross-chain bridges or interactions with other blockchains, including bridge security failures; an economic exploit risk that can include a risk of economic attacks such as flash-loan exploits and MEV vulnerability that can manipulate the strategy's state or markets in a single transaction; a strategy correlation that can include a risk of similarity between multiple strategies in terms of asset, token, or protocol exposure, where high correlation may indicate that multiple strategies derive yield from the same underlying sources, making them vulnerable to a common point of failure; and a user concentration that can include a risk of how concentrated a strategy's TVL is among large holders, where a vault dominated by a few addresses may be prone to instability if even a single large user exits.

In an embodiment, the system can include a comprehensive quantitative risk scoring subsystem. This subsystem can continuously evaluate multiple risk vectors for each strategy and assigns each a numerical sub-score on a standardized 0-100 scale (where 0 indicates no detected risk and 100 indicates extreme risk). The risk vectors can include, but are not limited to, smart contract exploitability that can include a risk of vulnerabilities or bugs in the strategy's smart contracts being exploited, an oracle manipulation risk that can include a risk of price feed or oracle data being manipulated to affect the strategy, a governance centralization that can include a risk arising from concentrated control or admin privileges in the protocol's governance, a liquidity depth that can include a risk associated with insufficient liquidity or capacity in underlying markets to support large asset movements, a reward token volatility that can include a risk of high price volatility in any reward or yield tokens that the strategy depends on, a collateral fragility that can include a risk of underlying collateral assets failing, depegging, or losing value in a way that jeopardizes the strategy, an exit constraint that can include a risk due to limitations or delays in withdrawing from the strategy (e.g. lock-up periods or withdrawal queues), a composability/dependency chain risk that can include a risk from the strategy's reliance on other protocols or contract layers, where a failure in any dependency impacts the strategy, a cross-chain and bridge risk that can include a risk introduced by using cross-chain bridges or interactions with other blockchains, including bridge security failures, an economic exploit risk that can include a risk of economic attacks such as flash-loan exploits and mev vulnerability that can manipulate the strategy's state or markets in a single transaction, a strategy correlation that can include a risk of similarity between multiple strategies in terms of asset, token, or protocol exposure. high correlation may indicate that multiple strategies derive yield from the same underlying sources, making them vulnerable to a common point of failure, and a user concentration that can include a risk of how concentrated a strategy's tvl is among large holders. A vault dominated by a few addresses may be prone to instability if even a single large user exits.

Smart Contract Exploitability Risk (R_SC) can be calculated based on the security of the protocol's smart contracts. The risk score can be derived by examining security audits and the history of vulnerabilities. The security confidence level (P_secure) can be computed based on factors like audit reports, complexity, and contract age.

Oracle Manipulation Risk (R_oracle) can measure the vulnerability of the protocol to manipulated price oracles. The manipulation risk can be calculated by estimating the fraction of market liquidity an attacker would need to move the oracle price, denoted by M_frac.

Governance Centralization Risk (R_gov) can evaluate the concentration of governance power within the protocol. The centralization can be quantified by the proportion of voting power held by the largest governance entity, denoted by P_major.

Liquidity Depth Risk (R_liq) can be derived from the proportion of the protocol's position size compared to the total liquidity available in the underlying markets.

Reward Token Volatility Risk (R_vol) can be calculated based on the annualized volatility, denoted as σ_reward, which measures price fluctuations.

Collateral Fragility Risk (R_col) can evaluate the fragility of the assets used as collateral in the protocol. Each collateral asset j can have a risk factor r_j (ranging from 0 to 1) based on volatility, liquidity, and creditworthiness.

Exit Constraints Risk (R_exit) can quantify how easily assets can be withdrawn from the strategy. The delay D for withdrawal from a strategy can be normalized by a maximum threshold D_max (e.g., 30 days).

Composability/Dependency Chain Risk (R_comp) can account for the protocol's dependency on other external protocols or contracts. The more protocols the strategy depends on, the higher the risk.

Cross-Chain and Bridge Risk (R_xchain) can evaluate the vulnerabilities associated with cross-chain transactions and bridges.

Economic Exploit Risk (R_econ) can measure the likelihood of economic exploits, such as flash loan attacks. The risk score can be computed based on the required tokens to exploit the strategy (C_req) compared to the available tokens for such an attack (C_avail).

Strategy Correlation Risk (R_corr) can evaluate the similarity between multiple strategies in terms of asset, token, or protocol exposure. High correlation may indicate that multiple strategies derive yield from the same underlying sources, making them vulnerable to a common point of failure.

User Concentration Risk (R_user) can assess how concentrated a strategy's TVL is among large holders (“whales”). A vault dominated by a few addresses may be prone to instability if even a single large user exits.

Once each individual risk vector R_i is calculated, the final total risk score R_total can be computed as a weighted average of the sub-scores that includes a weight of each risk vector i, a sub-risk score for each risk vector, and the final total risk score, with values ranging from 0 (no risk) to 100 (maximum risk).

The final risk score R_total is mapped to qualitative labels based on predefined thresholds: Low Risk: 0≤R_total<30; Medium Risk: 30≤R_total<70; High Risk: R_total≥70.

If certain data is missing or unreliable (e.g., oracle feed errors), the system can default to a conservative estimate to avoid underestimating risk. The system can apply time-weighted smoothing to avoid reacting to short-term anomalies that could distort risk scores. If multiple risk factors are affected by a single root cause, the system can aggregate the affected vectors without double-counting. The system can use machine learning techniques to minimize false positives, ensuring that only substantial risks trigger high scores.

The system can include a smart fee minting mechanism embedded in the vault's smart contracts. The approach focuses on automation, transparency, and fairness in how fees are calculated and collected, using the concept of minting vault shares instead of withdrawing actual assets for fees.

A typical performance fee is a percentage of the yield generated for users (a common model is a “fee on profit”, such as 20%). In the vault, each time yields are realized (for instance, when reward tokens are harvested and converted, or interest is paid to the vault), the contract calculates the portion of that gain that is owed as a fee. Suppose the vault's assets increased by 100 units of the base token due to yield; at a 20% performance fee, 20 units worth would be the fee. Instead of siphoning 20 tokens out (which would reduce users'asset pool and could be complex if assets are spread in strategies), the vault mints new vault shares equivalent to 20 tokens and assigns those to the fee receiver's account. The overall effect is that the total supply of shares increases slightly, diluting the other shareholders by the 20-token value which now belongs to the fee receiver. Users essentially “pay” the fee through this dilution of returns rather than an out-of-pocket deduction, which is smooth and proportional.

A management fee is typically a fixed percentage of the total tokens under management taken annually (for example, 1-2% per year). The vault's contract can implement this by continuously accruing the fee and periodically minting shares for the fee collector. One implementation is to track a small, per-second fee rate (e.g., 2% per year translates to approximately 0.00000548% per block if using Ethereum 15s blocks, for instance). Every time someone interacts with the vault (deposit, withdraw, harvest, etc.), or at set intervals, the contract can compute the management fee accumulated since the last collection and mint the corresponding shares. This ensures the operator is regularly compensated for providing the service. The process is fully automated; no one can forget to charge it or overcharge it since it's formulaic in code.

Optionally, the system may have a one-time fee when a user deposits or withdraws (though many modern vaults set this to zero to encourage usage). If present, the deposit fee might be taken as a percentage of the deposited amount. For example, if a 0.5% deposit fee is set and a user deposits 1000 tokens, the user will receive vault shares worth 995 tokens, and vault shares worth 5 tokens (0.5%) are minted to the fee collector. Similarly, a withdrawal fee could deduct a percentage of the withdrawn amount by adjusting the shares or final payout. These fees are typically smaller and are mainly to cover things like immediate liquidity provision costs or discourage very frequent in-and-out movements that could game the system.

Vault shares are used because it can keep all accounting internal to the vault. The vault never needs to actually transfer base asset tokens out to pay fees until the fee collector decides to withdraw their accumulated share of assets. Meanwhile, the assets remain invested and earning yield. This is efficient because it avoids disrupting the investment compounding unnecessarily.

Vault shares can be transparent and algorithmic. The rules for fee minting are known upfront and written in the contract. Users can observe the mint events on-chain. There's no arbitrary skim or hidden charge; everything is quantified (e.g., one can see at any time how many fee shares have been minted, and thus exactly how much value has been taken as fees). By taking fees in shares, all participants (users and fee collectors alike) have aligned incentives to grow the vault's value. If the vault does well, the fee collector's share value grows; if the vault doesn't generate yield, there's no performance fee at all. Management fees still accrue with AUM, but if AUM drops due to losses or withdrawals, those fees shrink in absolute terms.

The minted fee shares typically go to a specific address designated as the fee recipient. This could be the vault developer team's address, a governance treasury (if the vault is managed by a DAO), or even split among multiple stakeholders (some to protocol insurers, some to referrers, etc., as programmed). The fee recipient can later redeem those vault shares by withdrawing from the vault just like a normal user, which then actually takes out the underlying assets corresponding to their fee profits. Essentially, they claim their portion of the vault's pooled assets when they decide to realize the fees.

For example, a user requests to withdraw 100% of their vault shares (i.e., all of their deposit plus accrued yield). At that moment, the user's share of the vault's assets might be spread across, say, four strategies. Two of those strategies allow immediate withdrawal (liquidity available on demand), but the other two have constraints (one might only allow withdrawal during a weekly window; another might require initiating an unlock and waiting 48 hours). The conditional withdrawal module manages this as follows.

First, the module can utilize any immediately withdrawable tokens to fulfill the request. It will instruct those strategies that are liquid to pull out the needed amounts. If those suffice to cover the user's request, then the withdrawal can be completed in one go (the module will take whatever small performance hit or rebalance needed internally to later refill those strategies if desired).

If the immediately liquid portion is not enough (which might often be the case if significant tokens are in locked strategies), the module can do as much as possible immediately (partial fulfillment), and then queue the remainder of the withdrawal. For the locked portions, it programmatically triggers their withdrawal processes.

For example, if Strategy X requires a cooldown, the module calls the function to initiate withdrawal from Strategy X for the needed amount. The strategy contract responds by starting the cooldown timer.

The vault notes that “User U is awaiting Y tokens from Strategy X, available at time T in the future.” For instance, the user might receive an interim confirmation (perhaps via the interface) that “Your withdrawal of 1000 tokens is partially complete: 700 tokens delivered now, 300 tokens will be delivered after the 2-day strategy unlock period. You will be notified or can claim them then.”

In some designs, the vault could issue a non-fungible token or a receipt to the user for the pending portion, representing a claim on the assets once available. However, in many cases, simply keeping an internal record and requiring the user to call the withdraw function again after the time has elapsed suffices. The user could also leave an address to be auto-credited if the system allows pushing tokens out.

The module may also batch multiple user withdrawals together if they target the same strategy unlock. For instance, if ten users are all withdrawing and collectively 1000 tokens need to come out of a particular strategy that has a weekly window, the module can aggregate those into one strategy withdrawal request (to happen at the next window) and later distribute to each user accordingly. This reduces overall gas cost and complexity.

From the user's perspective, the user can interact only with the vault. They do not have to personally juggle different timetables or go to each underlying protocol to withdraw. The vault's interface and contract handle it and provide a single completion when all parts of the withdrawal are done. If needed, the user might perform two transactions (one to initiate and later one to finalize claim), but they don't need to understand why—the system guides them (“please come back after date X to finalize withdrawal”).

To improve user experience, the vault might maintain a small buffer of idle base assets (or use recent incoming deposits) to instantly pay out withdrawals even if underlying tokens are locked, essentially front-running the locked portion. Then once the locked tokens free up, the vault uses them to replenish the buffer. This approach can make most withdrawals feel immediate except perhaps very large ones or during times of stress. The conditional withdrawal module can be tied into such logic, making decisions on whether to use the buffer based on current liquidity and trust in the underlying unlock.

By abstracting withdrawal logic into a module, the vault can support strategies that don't follow the standard deposit/withdraw model (ERC-4626 or otherwise). For example, a strategy may return a special token that is to be redeemed elsewhere, or may require calling two functions in sequence to withdraw. The module can handle those quirks internally, presenting a standard interface to the vault for withdrawal. This broadens the range of yield sources the vault can tap, including those with complex exit conditions, without burdening the end user with that complexity.

All of these features ensure that users can always get their tokens out of the vault, which is paramount for trust. Even if it's not instantaneous for certain portions, the process is managed and clear. This module effectively manages the asynchrony in a synchronous user request, smoothing over the differences among underlying strategies. As a result, the vault can combine both highly liquid and high-yield-but-illiquid opportunities, getting the best of both, while users still feel in control of their money.

### Automated Reinvestment of Incentive Tokens

One of the labor-intensive aspects of yield farming that the invention fully automates is the harvesting of incentive or reward tokens and their reinvestment. Many DeFi strategies pay out yields in the form of tokens that are not the same as the user's deposited asset. For example, a user deposits USDC into a vault strategy that lends on Compound; they earn interest in USDC but also earn COMP tokens as a reward. If left alone, those COMP tokens would just accumulate separately and not contribute to the user's USDC balance unless the user manually sells them for USDC and reinvests.

In this system, the automated incentive reward harvesting module can take care of this end-to-end. The vault either on a fixed schedule (e.g. daily at a certain time, or every X blocks) or based on thresholds (like once accumulated rewards exceed a certain value) invokes a harvest function. This can be done permissionlessly by anyone (with the contract rewarding the caller with a small incentive maybe) or by a designated bot or decentralized worker to ensure regular execution. For example, some DeFi products could distribute reward tokens that need to be vested before they can be swapped out or the protocol might pause the claim feature. Our vault could account for such edge cases and auto-vest before claiming or simply observe the contract until the claim function is unpaused.

The harvest function can iterate through each strategy that the vault has tokens in and execute whatever is needed to claim that strategy's rewards. This could be calling a getReward( ) or claim( ) function on the strategy's contract, or sometimes simply withdrawing and re-depositing to realize the accumulated interest. The result is that the vault's address receives all the reward tokens from those strategies. For example, it might collect COMP from Compound, CRV from Curve, etc., depending on each strategy.

Next, for each type of reward token gathered, the module will convert it into the vault's base asset (the asset users deposited). This can involve swapping on a decentralized exchange or aggregator. The module can integrate with platforms to get the best rate. It can consider slippage settings—for instance, it might decide to only execute if the price impact is below a certain threshold or split the swap into smaller chunks if it's a large amount relative to pool liquidity. If a reward token doesn't have a direct liquid market to the base asset, the module can do multi-hop swaps or use alternate routes (perhaps going through a major asset like WETH as intermediary).

All along, the harvesting process can attempt to minimize overhead to combine multiple small reward tokens into one transaction when possible (to save gas), avoid harvesting too frequently when rewards are negligible (to not waste gas on tiny amounts), and use the best available oracle or on-chain price to ensure the swap is executed at a fair rate (if off-chain infrastructure is available, it might even wait for favorable rate or use a TWAP oracle etc.).

Once all reward tokens are converted, the vault now can have an increased amount of the base asset in its possession. These are essentially profits ready to be reinvested. The module then can add these assets back into the active strategies. A first example method is to distribute the new tokens according to the current allocation ratios. For example, if the vault is currently 50% in Strategy A and 50% in Strategy B, it will split the new tokens likewise. This keeps the allocation proportionally the same post-harvest. Alternatively, this moment can be an opportunity for the AI rebalancer to step in. The fresh tokens can be allocated to whatever strategy is most optimal at the time without having to first withdraw from elsewhere. For instance, perhaps Strategy B's yield has improved and the AI wanted to allocate more there—it can direct 100% of the new yield to Strategy B, slightly shifting overall allocation in that direction organically. The deposit into strategies can be done via the allocation engine in a seamless way, just like initial deposits.

After deployment, the effect can be that all the yield earned (whether originally in weird token forms or not) is now translated into the base asset generating more base asset yield. The user's vault shares correspond to more underlying base assets than before (thus the share price in terms of base asset goes up). If the user queries their balance or the UI, they simply see that their deposit of e.g. 1000 USDC is now 1020 USDC (reflecting a 2% gain from yields), without having ever dealt with the intermediate COMP or CRV tokens that made it possible. They just see their USDC growing.

The frequency of these harvest-and-reinvest cycles can be tuned. More frequent compounding can marginally increase yield (especially in volatile reward token scenarios, selling quickly can reduce exposure to reward token price drops), but doing it too often could incur too high transaction fees relative to the gain. The system finds a balance, potentially guided by the tAPY engine optimizing N (compounding frequency) or by simple rules like “harvest when at least X dollars of rewards accumulated or at least Y time passed, whichever comes first.” The system may also coordinate harvests to align with strategy-specific schedules (for example, some rewards may vest or be claimable weekly; the vault can harvest right after that event).

In practice, harvesting can be gas intensive (multiple token transfers and swaps). In an environment like Ethereum, the vault might use a decentralized worker with gas sponsorship or allow anyone to call harvest and take a small fee (paid in base asset or a tiny cut of rewards) as an incentive. In layer-2 or sidechain environments with low fees, more frequent harvest is possible easily. The design is flexible to operate efficiently on various chains and also has options for socializing gas costs.

By automating the harvest and reinvest, the system can maximize yield (user's money is always working—rewards don't sit idle) and minimizes user effort (the user doesn't need to know or do anything about the multiple reward tokens and steps involved). This is a cornerstone of making the DeFi experience as easy as a traditional bank savings account, while delivering superior returns behind the scenes.

### Cross-Chain Token Handling (Wrapping, Swapping, and Bridging)

The system can implement an integrated cross-chain token handling subsystem that performs wrapping, swapping, and bridging of assets as needed to facilitate cross-chain strategy allocation.

Many blockchains distinguish between the native currency (like ETH on Ethereum, MATIC on Polygon, BNB on BSC, etc.) and ERC-20 (or equivalent standard) tokens that smart contracts typically use. If a user deposits a native coin to the vault (e.g., sends ETH to the vault contract), the system will automatically convert it into the wrapped ERC-20 form (WETH in this case). This might be done by directly calling the chain's official wrapper contract (for ETH->WETH) or using a built-in mechanism if the chain provides one. Conversely, when a user withdraws, if they prefer to receive native ETH, the vault can unwrap WETH back to ETH before sending it to the user. This ensures compatibility with DeFi protocols, as most yield strategies expect ERC-20 tokens, while also giving users the convenience of depositing/withdrawing native tokens if they choose.

If the vault's base asset is, say, USDC, but one of the strategies requires using another asset (like a certain LP token or a different stablecoin or a staking token), the system will perform a swap. For example, to invest in an ETH staking strategy, the vault might need to convert some USDC into ETH (or stETH, a staked ETH token). The token handling module would route this conversion via a DEX or other mechanism. It ensures that the correct amount is swapped and delivered to the strategy contract. On exit, any non-base assets received (like if we unstake and get back ETH or some reward token) will be swapped back into USDC. Essentially, the vault doesn't force the user to hold multiple asset types; it handles all necessary conversions in and out of strategies so that the value is always brought back to the base asset eventually.

Suppose the vault is primarily on Ethereum, but there's a lucrative yield farm on an Avalanche protocol. The vault's cross-chain module can do the following. It can lock a portion of the base asset on Ethereum (for example, send USDC to a known bridge contract that locks it) and get an equivalent representation on Avalanche (say, a bridged USDC or a native USDC if it exists on Avalanche). The system can have a corresponding strategy contract deployed on Avalanche (under the hood, when the vault was configured, strategies on multiple chains were set up). That contract receives the bridged assets and deposits them into the Avalanche protocol to earn yield.

The main vault on can track that those assets are in the Avalanche strategy. It might rely on oracle or cross-chain messaging to know what's happening (like how much yield has accumulated on Avalanche side, etc.). The AI rebalancer and sentinel monitor cross-chain positions as well, just like local ones.

Periodically, the yields on Avalanche can be harvested too (either kept on Avalanche and reinvested there, or bridged back to Ethereum if needed for compounding centrally-either design is possible). If the rebalancer decides to reduce exposure on Avalanche, the module will withdraw from that strategy, convert assets to a bridgeable token, and bring them back to Ethereum by unlocking the original asset.

Recognizing that cross-chain bridges can themselves be points of risk (they have been targets of exploits historically), the system may use only well-audited, insured, or decentralized bridges. The sentinel can also specifically watch for bridge-related issues (like if a particular bridge is compromised, it would halt using it).

To the user or even to the integrator using the vault, these cross-chain moves are behind the scenes. They deposit on Ethereum and withdraw on Ethereum; they are not required to manage keys or transactions on Avalanche. If needed, the vault interface could show that “X % of assets are deployed on Avalanche in Strategy Z” for transparency, but it's not something the user has to directly manage. They still have one vault share token that represents their claim across all that cross-chain activity.

There are different ways to implement the multi-chain vault concept. One approach is a single unified vault where one primary chain hosts the “accounting” and other chains host subordinate strategy contracts. Another approach is to deploy a separate vault instance on each chain but then have a mechanism for users to seamlessly move between them. The described invention leans towards the unified model for simplicity: one share token (on one main chain) that covers cross-chain investments. However, either could be considered within scope.

The bridging system might also carry informational messages (e.g., using something like LayerZero or Wormhole messaging) so that events on one chain (like harvest results) are communicated to the main vault or to an off-chain coordinator. This ensures the system stays in sync even while distributed across networks.

The module also can account for cross-chain bridge fees and additional transaction costs. For example, bridging often has a fee (either a small percentage or flat fee). The system would factor that into decisions (the yield on the other side can justify these costs). It could even batch cross-chain moves to amortize fees (e.g., moving a large chunk at once rather than many small ones).

Besides wrapping native coins, the vault is mindful of differing token standards (ERC-20 on Ethereum, BEP-20 on BSC, etc.). It ensures that any token representation used in strategies is compatible and that when coming back to base, it consolidates to the chosen standard.

The result of this cross-chain capability is that the vault can truly seek the best yields anywhere. If an asset has higher returns on another network, the vault can allocate some tokens there without the user even needing to know. This not only increases returns but also mitigates risk—for example, if Ethereum gas fees skyrocket making local strategies less profitable, maybe moving to a Layer-2 or sidechain yields better net returns; the vault can do that adaptively. It essentially makes the yield system omnichain and future-proof, as new chains or opportunities can be integrated in the same unified framework.

A first example can relate to a user deposit and automated yield compounding. In this example, a user can have 10,000 USDC and interacts with the vault's smart contract (e.g., via a web interface) and deposits the 10,000 USDC. The vault contract receives the tokens and mints a corresponding amount of vault share tokens (minus any small deposit amount if applicable).

Furthering this example, multi-strategy allocation engine can then use four whitelisted strategies for USDC: A lending protocol (Strategy A), a stablecoin yield farm (Strategy B), a liquidity pool on a DEX (Strategy C), and an insurance underwriting pool (Strategy D). Based on current conditions, the engine can allocate Alice's deposit among them: perhaps 4,000 USDC into A, 3,000 into B, 2,000 into C, and 1,000 into D. These transactions are executed by the vault—it calls each strategy's deposit function with the specified amounts. Alice's USDC is now distributed and earning yield in multiple places at once. She doesn't have to do anything to achieve this diversification; it's done on deposit.

Over the next days and weeks, each strategy generates returns: Strategy A (lending) accumulates interest in USDC continuously, and may also yield some reward tokens (like COMP), Strategy B yields some reward token (say, a farming token) plus a baseline interest, Strategy C earns trading fees in the form of the two assets in the pool (USDC and another token) and possibly rewards (like DEX governance tokens), Strategy D earns premiums paid in USDC. All these yields can either accrue within the strategy contracts or are claimable by the vault. Meanwhile, the vault's tAPY display might show something like 18% true APY, updating as yields come in and market prices shift.

The vault's harvest function can trigger (automatically via a decentralized worker or a bot). It claims, for example, 1 COMP token from Strategy A, 50 FARM tokens from Strategy B's farm, and 100 DEX tokens from Strategy C's pool rewards. Strategy D paid out USDC directly, say it already added 50 USDC to its stake. The vault now has these extra tokens. The automated converter swaps 1 COMP and 50 FARM and 100 DEX tokens all into USDC, yielding an additional 300 USDC (just as an example number) after conversion. Now the vault has 300 USDC profit sitting in it. The system then reinvests this 300 USDC. Perhaps it follows the current allocation ratios or uses the AI rebalancer's latest advice. Suppose now Strategy B is particularly attractive (maybe its APY increased), so the rebalancer suggests putting all 300 USDC into Strategy B. The vault does so. Alice's assets have effectively grown; that 300 USDC is shared among all vault users including her (since she owns a large portion of the vault, most of it is effectively hers). Her 10,000 VLT shares are now worth more USDC per share because the vault's total USDC grew.

In this example, Alice opens the vault's dashboard on the web interface. She sees that her 10,000 USDC deposit is now, say, 10,180 USDC (just an example reflecting about 1.8% gain in a couple of weeks). She sees tAPY at ~18%, a breakdown showing Strategy B now has a larger allocation (since we reinvested profits there), and a log that a harvest was done 2 days ago converting rewards to USDC. She's pleased that everything is happening automatically and transparently. A month later, Alice decides to withdraw her tokens (perhaps her goal was short-term). She initiates a withdrawal of all her shares. At this time, some of her assets in the vault are in a strategy with a 1-day cooldown (imagine Strategy D had a withdraw delay). The conditional withdrawal module identifies that, and instantly withdraws all from A, B, C (which are liquid), and initiates the process for D's portion. Alice immediately receives, say, 98% of her tokens (which have grown by then to maybe 10,800 USDC). The remaining 2% (around 220 USDC) is pending from Strategy D's cooldown. The interface informs her of this and in fact, since the vault had a small buffer, it even fronted her the 220 USDC so she got the full amount immediately, and the vault will itself wait to collect the 220 USDC from Strategy D the next day. Alice successfully gets all her money out, along with the yield earned (minus a small performance fee that was taken via share minting). She is satisfied that not only did the vault earn yield on multiple platforms effortlessly, but it also let her withdraw on demand.

In another example, assume there is a sudden development in the DeFi market. Perhaps a new liquidity mining program is announced on Strategy C's platform, boosting its potential APY from 10% to 30%. Simultaneously, Strategy D's protocol experiences an unrelated issue causing its yields to drop from 8% to 4% and raising questions about its risk (maybe some security concern arose, albeit not a full-blown exploit).

The AI rebalancer, continuously monitoring yields and risk, recognizes both events. Strategy C now offers a much higher yield, and Strategy D looks less attractive and slightly riskier. Based on the vault's risk-adjusted optimization goals, it decides to reallocate tokens: significantly increase allocation to Strategy C to capitalize on the new yield, and reduce exposure to Strategy D to minimize risk.

In this example, the rebalancer issues a plan to the allocation engine: move, say, 15% of the vault's assets out of Strategy D and 5% out of Strategy A, and put that 20% into Strategy C. The vault contract then carries this out. It withdraws the required amounts from D and A (for D, it might need to respect the cooldown or perhaps D's share is taken from what's liquid and will queue some if needed—the conditional withdrawal module can be invoked internally for strategy migration too). Then it routes those assets into Strategy C (if Strategy C is on another chain, the bridging sub-module would handle transferring part of these tokens cross-chain first; but let's assume all are on the same chain for simplicity in this example).

In this example, after the rebalance, Strategy C might now constitute, say, 50% of the portfolio (up from maybe 25%), whereas Strategy D is down to 5% (just keeping a toe in, or maybe zero if it was fully exited). Strategies A and B make up the rest. The vault's overall expected tAPY might have increased due to more in the high-yield C. The rebalancer ensured the move was done at an optimal time (maybe just after a harvest so tokens were available and no penalty on D beyond what's acceptable).

In this example, Bob, another user of the vault, didn't even know this happened until he checks the dashboard. He sees a notification like “Portfolio rebalanced: Increased allocation to Strategy C (now 50%) due to better yield; decreased allocation to Strategy D (now 5%) due to risk considerations.” The tAPY has gone up, and Bob's balance is unaffected by any negative event because the system proactively adjusted. He essentially benefited from a new opportunity (the yield farming program) without having to discover or act on it himself, and he avoided prolonged exposure to a now-riskier strategy without needing to understand the technical details.

In this example, this rebalance triggered no explicit fees for users—it's part of the service. The only implicit cost might have been some transaction fees from moving tokens or a small slippage if assets were converted. The vault considered those in its decision (the AI likely ensured that the expected gain outweighs costs). Over the next period, yields pour in from Strategy C's lucrative program, boosting the vault's returns. The system will eventually harvest those new rewards (which might be a new type of token from the mining program) and convert them as usual.

In another example, imagine Strategy B in the vault is participation in a decentralized stablecoin platform. One day, news spreads of a potential vulnerability in that platform's smart contracts—maybe a flaw that could be exploited to drain tokens. The AI sentinel picks up unusual on-chain patterns: a couple of large withdrawals from the platform by other participants, some erratic changes in the stablecoin's collateral ratio, and perhaps an oracle alert about a paused contract function. These anomalies trigger the sentinel's risk flags for Strategy B.

In this example, the system can immediately change the risk score of Strategy B to a critical level. According to the vault's safety rules, the sentinel's alert causes an emergency withdrawal from Strategy B. The vault contract executes a withdrawal of all tokens from that strategy (assuming they are still safe and retrievable at this moment prior to any exploit). Let's say the vault had 2 million USDC in Strategy B; it pulls all of that back into the vault's custody.

In this example, the vault's status interface updates to show a warning: “Strategy B has been temporarily exited due to potential security issues. All tokens from Strategy B are secured in the vault awaiting reallocation.” Users see that their tokens are now largely sitting unallocated (or perhaps redistributed to other strategies if the rebalancer chooses). They are also possibly alerted via email or app notification about this protective measure, ensuring transparency.

In this example, assume the vulnerability was real but the vault avoided loss by pulling out early. Now the vault has, say, an extra 2 million USDC idle that had been in B. The rebalancer may either wait for clarity or immediately spread those to other safe strategies. If other strategies have capacity, it might distribute the amount among them to keep earning (or maybe Strategy C and A get more). Alternatively, if this is a short-term precaution, the vault might hold the tokens until Strategy B is confirmed safe or replaced with an alternative. Let's say, for this example, it allocates half to Strategy A and half to C in the interim.

In this example, users did not lose tokens thanks to the quick action. They might notice a slight dip in tAPY since Strategy B (which might have been a high-yield source) is out of play, but their principal is intact and secure. If an exploit had happened and others in that platform lost money, the vault's users are relieved that the system protected them ahead of time.

In this example, assume a week later, Strategy B releases a patch and things are stable again, or a better alternative is found. The vault governance might decide to reintroduce Strategy B (or a new Strategy E) with similar yields but safer conditions. The AI sentinel resets the risk status after thorough checks. The rebalancer then moves some tokens back into that strategy to resume yield farming, or it might keep the allocation elsewhere if the trust isn't fully restored. In either case, users are kept informed via the interface about what's happening.

This scenario highlights the value of having an AI-driven watchdog integrated into the vault. Many users on their own might not have reacted in time to such news or might not even have known about the risk until it was too late. The vault did it for them, showcasing a level of fiduciary care uncommon in automated DeFi services up to now.

In some embodiments, the system can further include an AI Sentinel risk-monitoring module operatively coupled to the vault core, the strategy interface registry, the rebalance routine, and the guardrail routine. The AI Sentinel risk-monitoring module can receive, as inputs, the per-strategy risk vectors generated by the quantitative risk scoring subsystem (including, by way of example, the smart-contract exploitability vector R_SC, the oracle manipulation vector R_oracle, the governance centralization vector R_gov, the liquidity depth vector R_liq, the reward token volatility vector R_vol, the collateral fragility vector R_col, the exit constraint vector R_exit, the composability vector R_comp, the cross-chain bridge vector R_xchain, the economic exploit vector R_econ, the strategy correlation vector R_corr, and the user concentration vector R_user, as previously described), and can combine those inputs with one or more dynamic detector outputs to produce a unified risk score and, in response, to cause one or more graduated protective actions at the smart-contract level.

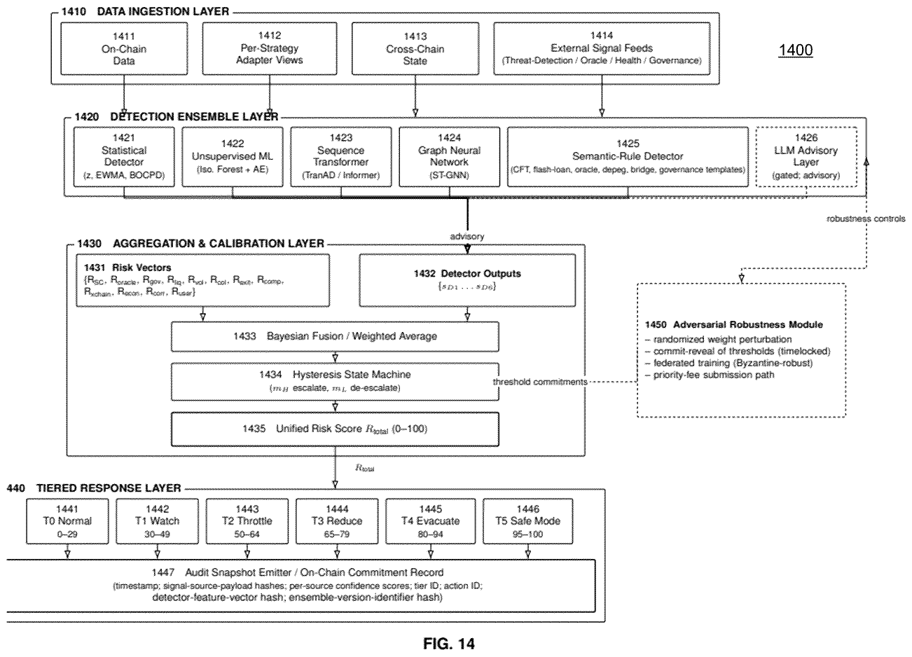

In some embodiments, the AI Sentinel module can be implemented as a layered pipeline including a data-ingestion layer, a detection ensemble layer, an aggregation-and-calibration layer, and a tiered-response layer. The pipeline may be implemented entirely on-chain, entirely off-chain with on-chain actuation, or as a hybrid arrangement, and reference is made to FIG. 14 for an example layered embodiment.

In some embodiments, the data-ingestion layer can collect, at every block or at a configurable polling interval, on-chain data including block headers, full and internal transaction traces, event logs, and pending-mempool transactions for monitored addresses; per-strategy adapter views including total value locked, utilization, reserve ratios, oracle prices consumed by the strategy, outstanding debt, supply caps, redemption-queue depth, paused-function flags, and admin-key state; cross-chain state including bridge-message attestations, validator-set state, and verified destination-chain receipts; and external signal feeds including, by way of example and not limitation, real-time third-party threat-detection services, decentralized monitoring networks, redundant decentralized price-oracle networks, curated security-research disclosures, and sanctions and compliance lists.

In some embodiments, each external signal source can be treated as an authenticated feed having an associated trust score and a freshness time-to-live, and no single source may unilaterally cause a protective action above a configured tier; activation of a protective action above the configured tier can use a consensus condition across two or more independent sources, as described below.

In some embodiments, the detection ensemble layer can include a plurality of detector classes operating in parallel on the ingested data, including any one or more of the following:

A streaming statistical detector class can operate on time-series of per-strategy features and may apply any one or more of robust median-absolute-deviation z-scoring, exponentially-weighted-moving-average control charting, autoregressive forecast-residual analysis, and Bayesian online change-point detection over a configurable run-length posterior.

An unsupervised machine-learning detector class can operate on multivariate feature vectors per strategy and may produce an anomaly score by combining an isolation-forest path-length statistic with an autoencoder reconstruction loss, where one or both models can be retrained on a rolling window of recent data with a held-out validation set targeting a configurable false-positive rate.

A multivariate sequence detector class can be implemented as a Transformer encoder -decoder operating on a sliding window of feature observations and may produce a forecast-versus-observation reconstruction loss as its anomaly signal, where the architecture may include adversarial reconstruction (TranAD-style), long-sequence sparse self-attention (Informer-style), or a variational-autoencoder-Transformer hybrid.

A graph-based detector class can operate on a heterogeneous transaction graph having nodes representing addresses and contracts and edges representing typed relations including transfer, swap, deposit, withdraw, approve, call, mint, and burn, where a spatial-temporal graph neural network may produce per-node and graph-level risk embeddings.

A semantic-rule detector class can evaluate one or more pre-defined attack templates on each protocol-relevant transaction, including, by way of example: (i) a price-manipulation template constructed by lifting raw transfers into high-level decentralized-finance actions and matching reverse-trade pairs against direct and indirect manipulation patterns; (ii) a flash-loan exploit template applied via pre-execution simulation of protocol-solvency invariants; (iii) an oracle-deviation template comparing each consumed oracle price against a robust median across at least three independent feeds; (iv) a stablecoin or liquid-staking-token depeg template combining a two-sided deviation test on cross-venue volume-weighted average price with on-chain redemption-queue depth and reserve-attestation freshness; (v) a bridge-integrity template monitoring attestation lag, validator-set churn, and bridge total-value-locked; and (vi) a governance-capture template tracking largest-holder voting share and classifying queued governance proposals.

A large-language-model advisory layer can be invoked when the aggregated output of the foregoing detector classes falls within a configurable medium-confidence band, the said advisory layer receiving a structured prompt summarizing the suspicious transaction batch and producing an attack-class classification and a machine-readable mitigation recommendation that may be treated as advisory and may be gated by deterministic invariant checks before any on-chain action is taken.

In some embodiments, the aggregation-and-calibration layer can compute a unified risk score R_total by combining the static risk vectors of the quantitative risk scoring subsystem with the dynamic detector outputs of the detection ensemble. In one embodiment, R_total can be computed as a weighted average as previously described. In another embodiment, R_total can be computed as a calibrated probabilistic posterior, for example as 100 times the output of a logistic regression over the concatenation of normalized risk vectors and detector scores, augmented with a hazard-rate term derived from a change-point posterior, with coefficients estimated by maximum likelihood on a labeled corpus of historical adverse events and recalibrated on a configurable cadence.

In some embodiments, the aggregation-and-calibration layer can apply time-weighted smoothing through a hysteresis-gated state machine, such that an escalation to a higher response tier may use R_total remaining above an upper threshold for at least m_H consecutive evaluation steps, and a de-escalation to a lower response tier may use R_total remaining below a lower threshold for at least m_L consecutive evaluation steps; this can preserve the smoothing property previously described while reducing the likelihood that single-step outliers trigger protective actions. In some embodiments, when multiple risk vectors are driven by a single root cause, a covariance-aware deflation factor can be applied to highly correlated sub-scores so as to reduce double-counting, also as previously described.

In some embodiments, the tiered-response layer can map bands of R_total to graduated, governance-bounded actions, including any one or more of: a watch tier in which polling rate may be increased and an alert may be logged without fund movement; a throttle tier in which new allocations to the affected strategy may be paused and capped at the current balance; a partial-exit tier in which a fraction of the allocation, determined by a configurable function of R_total, may be withdrawn through the manualWithdraw or equivalent path; a full-exit tier in which the manualExit or equivalent path may be invoked to evacuate the strategy to the idle balance or to a pre-approved fallback; and a safe-mode tier in which the global pause may be asserted and strategies may be pulled back to the idle balance. The tier thresholds and the partial-exit fraction function may be governance-configured parameters and may be timelock-protected.

In some embodiments, each tier transition can cause the vault to atomically emit an on-chain auditable event committing to (i) a timestamp, (ii) hashes of upstream signal-source payloads, (iii) per-source confidence scores, (iv) the tier identifier triggered, (v) the action taken, and (vi) a hash of the detector feature vector that produced the activation, with full payloads stored on a content-addressed off-chain storage system and referenced by hash on-chain. In this manner, the on-chain artifact can serve as a public, independently verifiable commitment to the off-chain Sentinel decision, such that operation of the off-chain detection ensemble can be observable from the on-chain record without disclosing the contents of the underlying signals.

In some embodiments, the AI Sentinel module can further implement one or more adversarial-robustness measures, including: randomized weight perturbation across the detector ensemble at each evaluation step; commit-reveal of risk thresholds with timelocked governance updates; and a private-mempool or priority-fee submission path for protective transactions, as further described below.

In some embodiments, the detection models of the AI Sentinel module can be trained in a federated-learning regime across multiple vault instances belonging to distinct operators, with local gradient updates aggregated by a Byzantine-robust aggregation rule (such as median or trimmed-mean aggregation), and with secure-aggregation cryptography (such as homomorphic encryption or Shamir secret sharing) protecting gradient privacy from the aggregator, so that cross-operator threat intelligence can improve the detectors without exposing any single operator's local data.

### Sentinel-Vault Single-Strategy Configuration

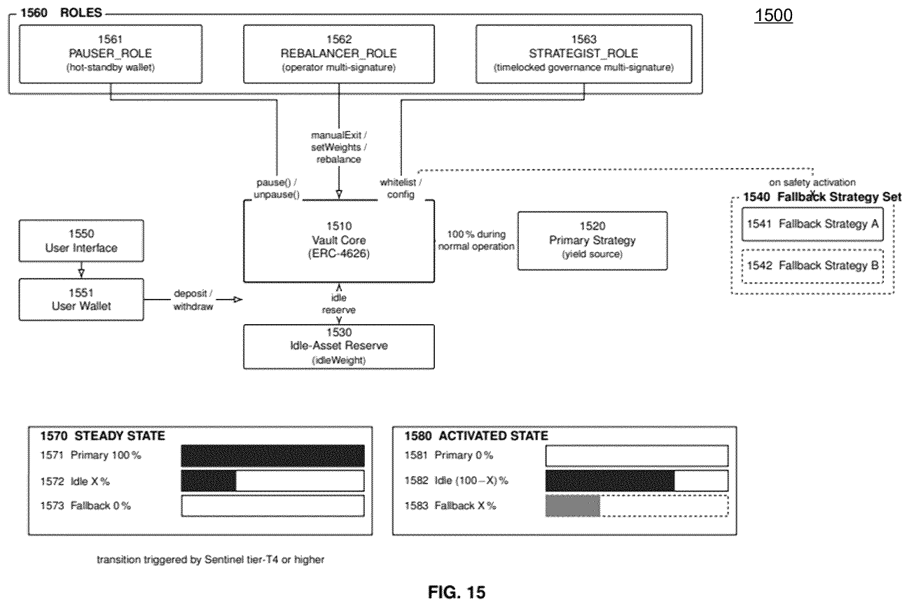

In some embodiments, the digital asset management system disclosed herein can be operated in a particular configuration referred to as a Sentinel-Vault, in which the multi-strategy allocation module is configured with a single primary yield-generating strategy and zero or more pre-approved fallback yield-generating strategies, and the AI Sentinel risk-monitoring module can provide automated risk response. Reference is made to FIG. 15 for an example Sentinel-Vault configuration.

In some embodiments, the Sentinel-Vault configuration can be implemented using the same vault core, the same strategy interface registry, the same rebalance routine, the same guardrail routine, the same reward and fee logic, and the same role-based access control as the multi-strategy embodiment described elsewhere herein, in some embodiments without separate contract deployment to operate in the Sentinel-Vault configuration. The difference between configurations may be defined by (i) the contents of the strategy whitelist, (ii) the target allocation weights, and (iii) the off-chain orchestration logic connected to the contract.

In some embodiments, the Sentinel-Vault configuration can exhibit one or more of the following operational properties: during normal operation, substantially all user-deposited capital, subject to an optional idle-reserve weight, may be deployed to the primary strategy, such that yield and user experience may be substantially similar to those of a direct deposit into the primary strategy; user-side withdrawals may not be needed to evacuate funds during a risk event, because the vault can evacuate the primary strategy on behalf of all depositors while user shares remain unchanged; the configuration may impose limited yield drag during normal operation because the AI Sentinel module can be implemented off-chain and may act on detected risk; and any pre-existing standalone yield deployment may be wrapped as the primary strategy of a Sentinel-Vault without changing the user-facing yield characteristics.

In some embodiments, the Sentinel-Vault can be parameterized at deployment with one or more of: a primary-strategy address, which may be any standardized or wrapper-exposed yield-generating strategy supported by the strategy interface registry; an idle-weight parameter, which may be expressed in basis points, defining the portion of vault assets held as un-deployed deposit asset; zero or more fallback-strategy addresses whitelisted by the strategist role and selected to be risk-decorrelated from the primary strategy with respect to one or more of underlying protocol, oracle suite, governance entity, and chain; a signal-source set and a consensus policy governing activation; tier thresholds mapping bands of R_total to graduated actions; and assignments of the pauser, rebalancer, and strategist roles to respective wallets or multi-signatures.

In some embodiments, the Sentinel-Vault can be operated in any one of: a single-strategy plus idle mode, in which funds may be held in the primary strategy during normal operation and may be evacuated to the idle balance on safety activation; a single-strategy plus fallback mode, in which funds may be held in the primary strategy during normal operation and may be redeployed into a single fallback strategy on safety activation; a single-strategy plus multiple-fallbacks mode, in which a plurality of fallback strategies may receive activated funds either according to pre-set weights or in a cascading priority order; and a graduated migration mode, in which funds may be progressively migrated from the primary strategy to one or more fallback strategies (or to idle) as R_total rises through configured tier thresholds.

In some embodiments, the consensus policy of the Sentinel-Vault may be selected from the group consisting of: a k-of-N rule that may use at least k of N independent signal sources to confirm a risk event above per-source confidence thresholds; a single-source rule that may use any one source exceeding a high-confidence threshold; a weighted-scoring rule with per-event-type source weights summing across configured signal categories; and a Bayesian fusion rule treating per-source confidences as likelihood inputs to the calibrated posterior of the AI Sentinel module. In some embodiments, the activation predicate can be evaluated under a hysteresis time-window, and no single signal source may unilaterally cause an action above a configured tier.

In some embodiments, supported signal categories can include: real-time exploit-alert services that produce confidence-scored alerts identifying active exploits, suspicious contract interactions, or flash-loan attacks; protocol-health telemetry feeds that report total-value-locked changes, utilization-rate anomalies, paused functions, and liquidity exhaustion; redundant decentralized price-oracle feeds that may be used to detect stablecoin and liquid-staking-token depegs and collateral devaluation; cross-chain bridge attestations that may be used to detect attestation lag, validator-set churn, and bridge total-value-locked drops; and governance monitors that may be used to detect high-impact parameter proposals or admin-key rotations affecting whitelisted strategies.

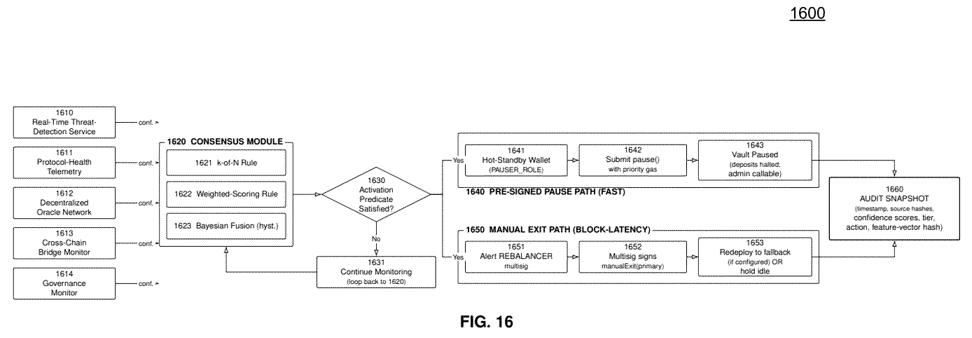

In some embodiments, the protective-action pathway of the Sentinel-Vault can be implemented as a dual-speed mechanism, reference being made to FIG. 16. A pause-class action, taking no parameters dependent on the detected event, may be held in hot-standby pre-signed by a wallet holding the pauser role, and may be broadcast upon consensus activation, optionally with a priority gas fee selected to enable confirmation in the same block as a detected malicious transaction under prevailing mempool conditions; the pause-class action can halt new user deposits and, configurably, new user withdrawals at the vault, while administrative functions including manualExit, manualWithdraw, and manualEnter may remain callable so that the operator can complete the exit pathway under a paused state. A redeployment-class action may be executed by the holder of the rebalancer role, computing the withdrawal quantity from the live strategy share-price and invoking manualExit on the primary strategy and, where a fallback is configured, invoking setWeights and rebalance to redeploy the recovered idle balance into the fallback strategy in accordance with the configured fallback weights.

In some embodiments, the role-based access control used by the Sentinel-Vault can assign three roles with bounded capabilities: a pauser role limited to pause and unpause functions and held by a hot-standby wallet operated by the off-chain safety monitor; a rebalancer role limited to manualExit, manualEnter, manualWithdraw, setWeights, and rebalance, and held by an operator multi-signature; and a strategist role limited to whitelisting and de-whitelisting strategies, configuring the consensus policy, and configuring tier thresholds, and held by a timelocked governance multi-signature; this role separation may be used in addition to, and is consistent with, the role hierarchy described elsewhere herein (including the harvester role for compounding, the configurator role for economic parameters, and the default-admin role for the role hierarchy itself).

In some embodiments, the lifecycle of a Sentinel-Vault can include an initial deployment phase in which the primary strategy and any fallback strategies are whitelisted, the consensus policy and tier thresholds are configured, role multi-signatures are assigned, the off-chain safety monitor is connected to the configured signal sources, and the vault may be funded and may begin earning on the primary strategy; a steady-state phase in which yield can accrue per the routine reward harvest and reinvestment pipeline disclosed elsewhere herein; a safety-event phase in which consensus activation may cause broadcast of the pre-signed pause-class action followed by execution of the redeployment-class action, with an audit snapshot recorded as described above and without any signature being needed from any user; a recovery phase in which the operator and client can confirm safety, the vault may be unpaused, and capital may be redeployed into the primary or replacement strategy; and a strategy-rotation phase in which the strategist role may, at any time, whitelist new primary or fallback strategies and the rebalancer role may rotate allocations using setMetaAssets, setWeights, and rebalance, in some embodiments without redeploying the contract.

In some embodiments, an existing standalone yield deployment can be upgraded to a Sentinel-Vault by a method comprising: deploying a vault core configured with the existing yield deployment as the primary strategy; configuring a plurality of independent signal sources, a consensus policy, and tier thresholds; granting the pauser role to a hot-standby wallet that holds a pre-signed pause-class transaction; granting the rebalancer and strategist roles to respective multi-signatures; accepting user redeposits from the existing yield deployment into the vault core, wherein during normal operation substantially all user capital may be forwarded to the primary strategy such that yield and user experience can be substantially similar to those of the prior standalone deployment; and, optionally, at a later time, expanding the vault to a multi-strategy configuration by whitelisting and weighting additional strategies. In some embodiments, this upgrade method can be applied to any pre-existing standardized yield deployment supported by the strategy interface registry, including yield deployments accessed through the wrapper or adapter layer disclosed elsewhere herein.

In some embodiments, a single vault contract instance can support both the Sentinel-Vault configuration and the multi-strategy configuration disclosed elsewhere herein, and may transition between configurations by way of strategist-role updates to the strategy whitelist and rebalancer-role updates to the target allocation weights, with the off-chain orchestration logic adjusted accordingly.

For example, a client operating a USDC vault may initially configure the vault as a Sentinel-Vault with AAVE USDC as the primary strategy, an idle weight of 0%, and Yearn USDC as a fallback strategy; the consensus policy may be set to use two of three independent signal sources to confirm a risk event before activation. During steady-state operation, the vault can deploy 100% of capital to AAVE USDC and earn AAVE-equivalent yield. Months later, a real-time threat-detection service may report a high-confidence exploit alert for the AAVE USDC market, a protocol-health telemetry feed may report an unusually large utilization spike, and the consensus policy may be satisfied. The hot-standby pauser wallet can broadcast the pre-signed pause-class transaction. The rebalancer multi-signature may subsequently invoke manualExit on AAVE USDC, recover approximately the full primary-strategy balance to the idle reserve, and invoke setWeights and rebalance to redeploy the recovered balance into Yearn USDC. An audit snapshot may be recorded on-chain. No user signature need be involved at any step. After the AAVE USDC market is confirmed safe, the strategist multi-signature can unpause the vault and the rebalancer can redeploy back into AAVE USDC; alternatively, the strategist may whitelist a new primary strategy and the vault can transition to operate against the new primary going forward, in some embodiments without redeployment of the vault contract.

### Implementation Notes for AI Modules

In some embodiments, the unsupervised machine-learning detector class can be implemented as an ensemble of an isolation forest having a configurable number of trees (such as 100 to 500) with a sub-sampling size selected to suit a target false-positive rate (such as 256 samples per tree), and an autoencoder having an encoder-decoder topology with a bottleneck dimension between 4 and 32, which may be trained by minimization of mean-squared reconstruction error on a rolling 30-to-90-day window of historical strategy feature vectors observed under nominal conditions; the ensemble anomaly score may be a configurable convex combination of the isolation-forest path-length statistic and the autoencoder reconstruction loss, with the combination coefficient selected to optimize area under the receiver-operating-characteristic curve on a held-out validation set.

In some embodiments, the multivariate sequence detector class can be implemented as a Transformer encoder-decoder with a sliding input window of 32 to 512 evaluation steps, a model dimension between 64 and 256, and an attention-head count between 4 and 16; in a TranAD-style embodiment, an adversarial discriminator may be jointly trained with the reconstruction loss; in an Informer-style embodiment, the encoder may employ a sparse-self-attention mechanism with a query-distillation operator to reduce sequence-length complexity to logarithmic in the window size.

In some embodiments, the graph-based detector class can be implemented as a heterogeneous spatial-temporal graph neural network having relation-specific message-passing layers for one or more of transfer, swap, deposit, withdraw, approve, call, mint, and burn relation types; the temporal aspect may be captured by either a recurrent layer applied to per-snapshot node embeddings or by attention pooling across multiple temporal distances; per-strategy and per-address risk embeddings may be read out by a graph-attention pooling layer and projected to a scalar anomaly score by a lightweight feed-forward head.

In some embodiments, the aggregation-and-calibration layer can be implemented as a logistic regression over the concatenation of normalized static risk vectors and dynamic detector outputs, with coefficients estimated by maximum-likelihood on a labeled corpus of historical adverse and benign vault events including, by way of example, publicly documented decentralized-finance incidents of the period 2020 through 2025; calibration of probability outputs may be performed by Platt scaling or by isotonic regression on a held-out portion of the corpus, and recalibration may be performed on a configurable cadence of one to three months.

In some embodiments, when the AI Sentinel module is operated in the federated-learning regime described above, the Byzantine-robust aggregation rule may be implemented as a coordinate-wise trimmed mean with a configurable trim fraction (such as 10% to 25% of participating gradient updates discarded from each coordinate, drawn from the extremes of the coordinate value distribution), or alternatively as a coordinate-wise median; secure aggregation may be implemented through a Shamir-secret-sharing-based protocol or through a homomorphic-encryption-based protocol such that the coordinator may observe only the aggregate update, not any individual operator's update.

In some embodiments, the deterministic invariant gates applied to the large-language-model advisory layer's output can include, by way of example: (i) a tier-consistency gate that may check that any recommended action is consistent with the unified risk score's current tier, such that no recommendation may cause an action above the tier corresponding to R_total; (ii) a whitelist-consistency gate that may check that any recommended fund-movement target address is on the strategist-whitelisted strategy set; (iii) a magnitude-consistency gate that may check that any recommended movement amount does not exceed the per-rebalance movement-size cap maintained by the guardrail routine; and (iv) a cooling-off-consistency gate that may check that the recommended action does not violate any cooling-off interval imposed after a recent large rebalance. In some embodiments, the LLM advisory layer's output that fails any invariant gate may be logged together with the failure reason and discarded without on-chain effect.

In some embodiments, the reinforcement-learning policy used by the AI Rebalancer engine described elsewhere herein may be parameterized as a feed-forward neural network having an input layer corresponding to a state vector comprising current weights, recent strategy-yield observations, the unified risk score from the AI Sentinel module, and one or more contextual variables, an output layer corresponding to an action vector of weight deltas constrained to the simplex, and a reward function computed as a change in portfolio tAPY net of estimated execution cost, less a penalty term proportional to the change in unified risk score.

In some embodiments, the Bayesian-optimization embodiment of the AI Rebalancer engine may use a Gaussian-process surrogate over the weight space with a Matérn kernel of smoothness parameter ν equal to 5/2, an upper-confidence-bound acquisition function, and a configurable exploration coefficient; in some embodiments, candidate weight vectors proposed by the acquisition function may be evaluated through the pre-execution stress-test layer rather than against live strategy state, so as to reduce expending principal on exploration.

In some embodiments, the digital asset management system can include instructions that further cause the processors to operate an AI Sentinel risk-monitoring module configured to (a) receive as inputs a plurality of risk vectors generated by a quantitative risk scoring subsystem, the risk vectors comprising one or more of a smart-contract exploitability vector, an oracle manipulation vector, a governance centralization vector, a liquidity depth vector, a reward-token volatility vector, a collateral fragility vector, an exit-constraint vector, a composability vector, a cross-chain bridge vector, an economic exploit vector, a strategy correlation vector, and a user concentration vector; (b) receive as further inputs one or more dynamic detector outputs from a detection ensemble comprising at least one of a streaming statistical detector, an unsupervised machine-learning detector, a Transformer-based multivariate sequence detector, a graph-based detector operating on a heterogeneous transaction graph, a semantic-rule detector configured to match decentralized-finance attack templates, and a large-language-model advisory layer; (c) compute a unified risk score by combining the risk vectors and the dynamic detector outputs; and (d) cause one or more graduated protective actions to be performed when the unified risk score exceeds one or more configured thresholds.

In some embodiments, the AI Sentinel risk-monitoring module can be configured to apply a hysteresis-gated tiered response policy mapping bands of the unified risk score to graduated actions including one or more of a watch action, a throttle action, a partial-exit action, a full-exit action, and a safe-mode action, and wherein each tier transition can cause the vault to emit an on-chain auditable event committing one or more of a timestamp, hashes of upstream signal-source payloads, per-source confidence scores, a tier identifier, an action identifier, and a hash of a detector feature vector.

In some embodiments, the digital asset management system can be configured as a Sentinel-Vault, wherein the one or more strategies comprise a single primary yield-generating strategy and at least one of (i) an idle-asset reserve having a configurable idle weight expressed in basis points and (ii) one or more pre-approved fallback yield-generating strategies whitelisted by a strategist role, wherein during normal operation substantially all of the second portion of the tokens may be deployed to the primary strategy subject to the idle weight, and wherein the AI Sentinel risk-monitoring module can be configured to: (a) on consensus activation across a plurality of independent signal sources, broadcast a pre-signed pause transaction held in hot-standby by a wallet holding a pauser role; and (b) cause a wallet holding a rebalancer role to execute a manual exit of the primary strategy and, where a fallback is configured, to redeploy the recovered balance into the fallback strategy according to pre-set fallback weights.

In some embodiments, the consensus activation may be satisfied by a rule selected from the group consisting of: a k-of-N rule across at least three independent signal sources, a weighted-scoring rule across configured signal categories, and a Bayesian fusion rule with a hysteresis time-window; and wherein under each of said k-of-N rule and said Bayesian fusion rule, no single signal source may unilaterally cause an action above a configured tier.

In some embodiments, administrative functions comprising manual exit, manual entry, and manual withdrawal may remain callable while the vault is paused with respect to user deposits and withdrawals, thereby enabling completion of the exit pathway during a paused state.

In some embodiments, an existing standalone yield deployment may be upgraded into a protected vault by: configuring the vault to use the existing yield deployment as a primary strategy of a single-strategy configuration; configuring a plurality of independent signal sources and a consensus activation policy; granting a pauser role to a hot-standby wallet that holds a pre-signed pause transaction; granting a rebalancer role and a strategist role to respective multi-signatures; accepting user redeposits into the vault, wherein during normal operation substantially all user capital may be forwarded to the primary strategy; and, at a later time, expanding the vault to a multi-strategy configuration by whitelisting and weighting additional strategies through the strategist and rebalancer roles.

In some embodiments, the detection ensemble of the AI Sentinel risk-monitoring module may be implemented at least in part by an off-chain computing process, and the system may further cause the vault smart contract to emit, for each protective action above a configured tier, an on-chain commitment record comprising one or more of: (i) a cryptographic hash committing to the inputs of the off-chain detection ensemble at the time of the action, (ii) a cryptographic hash committing to a configuration version identifier of the off-chain detection ensemble at the time of the action, (iii) the unified risk score value at the time of the action, and (iv) the action identifier, such that the on-chain commitment record can provide a publicly verifiable artifact corresponding to the off-chain decision without requiring disclosure of the underlying signal payloads.

FIG. 14 is a schematic diagram illustrating an example AI Sentinel risk-monitoring module 1400. The module 1400 can include a data-ingestion layer 1410, a detection ensemble layer 1420, an aggregation-and-calibration layer 1430, a tiered-response layer 1440, and an adversarial robustness module 1450.

Data ingestion layer 1410 can collect on-chain data 1411, per-strategy adapter views 1412, cross-chain state 1413, and external signal feeds 1414 including threat-detection, oracle, health, and governance feeds.

Detection ensemble layer 1420 can include a streaming statistical detector 1421 (e.g., z-score, EWMA, BOCPD), an unsupervised machine-learning detector 1422 (e.g., isolation forest plus autoencoder), a multivariate sequence Transformer detector 1423 (e.g., TranAD or Informer), a graph neural network detector 1424 (e.g., ST-GNN), a semantic-rule detector 1425 (e.g., CFT, flash-loan, oracle, depeg, bridge, and governance templates), and a large-language-model advisory layer 1426 that may be gated and treated as advisory.

Aggregation and calibration layer 1430 can receive per-strategy risk vectors 1431 (e.g., R_SC, R_oracle, R_gov, R_liq, R_vol, R_col, R_exit, R_comp, R_xchain, R_econ, R_corr, and R_user) and detector outputs 1432 (e.g., SD1 . . . SD6), and may apply a Bayesian fusion or weighted-average combiner 1433 and a hysteresis state machine 1434 (with escalation parameter m_H and de-escalation parameter m_L) to produce a unified risk score R_total 1435 on a configurable scale (e.g., 0-100).

Tiered response layer 1440 can map bands of R_total to graduated tiers including a normal tier T0 1441, a watch tier T1 1442, a throttle tier T2 1443, a reduce tier T3 1444, an evacuate tier T4 1445, and a safe-mode tier T5 1446. Each tier transition can cause an audit snapshot emitter 1447 to record an on-chain commitment record (e.g., a timestamp, signal-source-payload hashes, per-source confidence scores, a tier identifier, an action identifier, a detector-feature-vector hash, and an ensemble-version-identifier hash).

Adversarial robustness module 1450 can implement controls including randomized weight perturbation across the detector ensemble, commit-reveal of risk thresholds with timelocked governance updates, federated training with Byzantine-robust aggregation, and a priority-fee submission path for protective transactions.

FIG. 15 is a schematic diagram illustrating an example Sentinel-Vault single-strategy configuration 1500. The configuration 1500 can include a vault core 1510 (e.g., ERC-4626), a primary strategy 1520 representing the yield source, an idle-asset reserve 1530 governed by an idle-weight parameter, a fallback strategy set 1540, a user interface 1550, and a set of roles 1560.

Fallback strategy set 1540 can include a first fallback strategy 1541 and a second fallback strategy 1542. While two fallback strategies are described, any number of fallback strategies may be implemented. User interface 1550 can be coupled to a user wallet 1551 supporting deposits and withdrawals.

Roles 1560 can include a pauser role 1561 held by a hot-standby wallet and limited to pause and unpause functions, a rebalancer role 1562 held by an operator multi-signature and limited to manualExit, setWeights, and rebalance functions on safety activation, and a strategist role 1563 held by a timelocked governance multi-signature and limited to whitelist and configuration changes.

FIG. 15 further illustrates a steady state 1570 in which the primary strategy holds 100% of allocated capital 1571, the idle reserve holds X % 1572, and the fallback holds 0% 1573, and an activated state 1580 in which the primary holds 0% 1581, the idle reserve holds (100−X) % 1582, and the fallback holds X % 1583. The transition from steady state 1570 to activated state 1580 may be triggered by a Sentinel tier-T4 or higher response.

FIG. 16 is a flow diagram illustrating an example multi-source signal-consensus and pre-signed pause execution path 1600 used by the AI Sentinel risk-monitoring module. The execution path 1600 can include a plurality of independent signal sources, a consensus module 1620, an activation predicate 1630, a pre-signed pause path 1640, a manual exit path 1650, and an audit snapshot 1660.

The independent signal sources can include a real-time threat-detection service 1610, a protocol-health telemetry feed 1611, a decentralized oracle network 1612, a cross-chain bridge monitor 1613, and a governance monitor 1614, each supplying a confidence score to the consensus module 1620.

Consensus module 1620 can apply a consensus rule selected from a k-of-N rule 1621, a weighted-scoring rule 1622, or a Bayesian fusion rule with hysteresis 1623. The consensus output can be evaluated at activation predicate 1630; if the predicate is not satisfied, monitoring may continue 1631 and processing may loop back to consensus module 1620.

If the activation predicate 1630 is satisfied, pre-signed pause path 1640 (fast) can be invoked, in which a hot-standby wallet 1641 holding the pauser role submits a pre-signed pause( ) transaction with a priority gas fee, transitioning the vault to a paused state 1642 in which user deposits are halted while administrative functions remain callable. Manual exit path 1650 (block-latency) can subsequently be invoked, in which a rebalancer multi-signature 1651 signs a manualExit(primary) call 1652 and, where a fallback is configured, redeploys recovered value to the fallback or holds it as idle 1653. An audit snapshot 1660 can be recorded with a timestamp, source hashes, confidence scores, tier identifier, action identifier, and feature-vector hash.

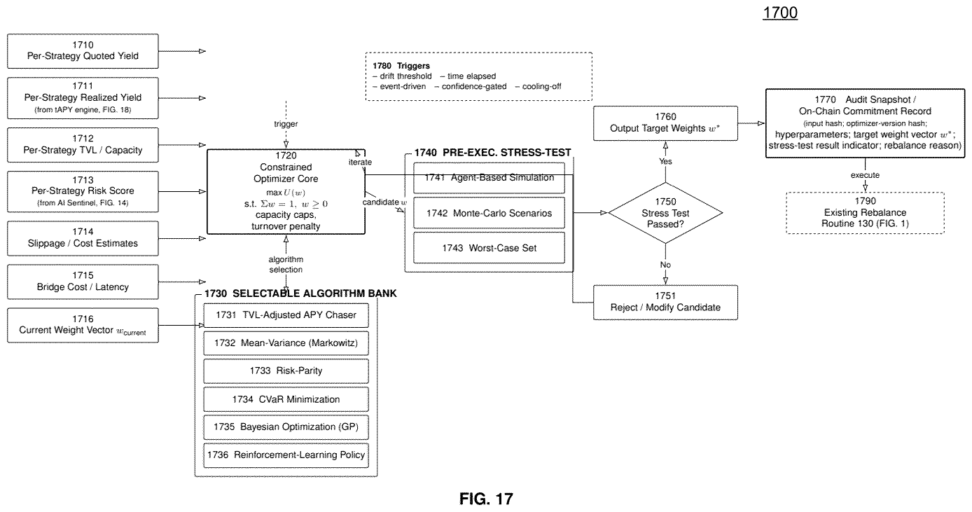

FIG. 17 is a schematic diagram illustrating an example AI Rebalancer engine 1700. The engine 1700 can receive a plurality of inputs, can apply a constrained optimizer core 1720 selecting from a selectable algorithm bank 1730, can apply a pre-execution stress test 1740 gated by a pass/fail decision 1750, can output a target weight vector 1760, can record an audit snapshot or on-chain commitment record 1770, can be invoked by one or more triggers 1780, and can drive an existing rebalance routine 1790 (e.g., the rebalance routine 130 of FIG. 1).

Inputs to the AI Rebalancer engine 1700 can include per-strategy quoted yield 1710, per-strategy realized yield 1711, per-strategy total value locked or capacity 1712, per-strategy risk score 1713 (e.g., from the AI Sentinel module of FIG. 14), slippage and cost estimates 1714, bridge cost and latency 1715, and a current weight vector w_current 1716.

Constrained optimizer core 1720 can maximize a utility function U(w) over a weight vector w subject to one or more constraints (e.g., Σw=1, w≥0, capacity caps, turnover penalty). Selectable algorithm bank 1730 can include a TVL-adjusted APY chaser 1731, a mean-variance (Markowitz) formulation 1732, a risk-parity formulation 1733, a CVaR minimization 1734, a Bayesian optimization with a Gaussian-process surrogate 1735, and a reinforcement-learning policy 1736.

Pre-execution stress test 1740 can include an agent-based simulation 1741, Monte-Carlo scenarios 1742, and a worst-case scenario set 1743. The candidate weight vector can be evaluated at decision 1750; if the candidate does not pass, the candidate may be rejected or modified 1751 and iterated back to optimizer core 1720, and if the candidate passes, target weights w* 1760 can be output and committed via audit snapshot 1770 (e.g., recording an input hash, an optimizer-version hash, hyperparameters, the target weight vector w*, a stress-test result indicator, and a rebalance reason).

Triggers 1780 for invoking the AI Rebalancer engine 1700 can include a drift threshold, a time-elapsed trigger, an event-driven trigger, a confidence-gated trigger, and a cooling-off rule. Existing rebalance routine 1790 can correspond to the rebalance routine 130 of FIG. 1, which can execute the output target weights subject to the guardrail routine.

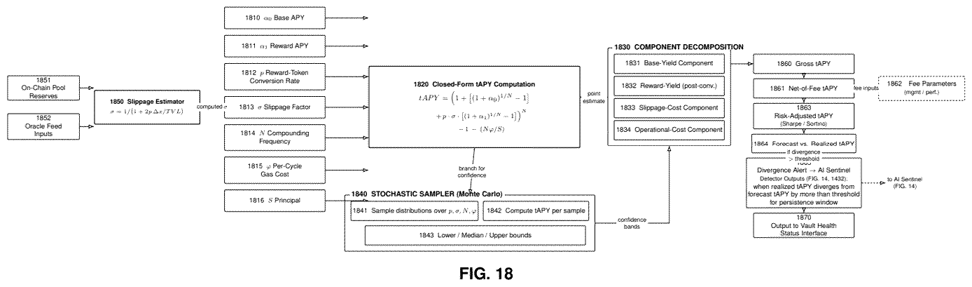

FIG. 18 is a schematic diagram illustrating an example True APY (tAPY) calculation engine 1800. The engine 1800 can receive a set of inputs, can apply a closed-form tAPY computation 1820, can produce a component decomposition 1830, can apply a stochastic sampler 1840, can use additional inputs 1850 to estimate slippage, can produce gross and adjusted tAPY outputs 1860, and can produce an output to a vault health status interface 1870.

Inputs to the tAPY calculation engine 1800 can include a base APY α₀ 1810, a reward APY α₁ 1811, a reward-token conversion rate p 1812, a slippage factor σ 1813, a compounding frequency N 1814, a per-cycle gas cost φ 1815, and a principal investment amount S 1816.

Closed-form tAPY computation 1820 can apply the closed-form expression tAPY=(1+[(1+α₀)\hat{ }(1/N)−1]+p·σ·[(1+α₁)\hat{ }(1/N)−1])\hat{ }N−1−(N·φ)/S to produce a point estimate of tAPY. Component decomposition 1830 can include a base-yield component 1831, a reward-yield component (post-conversion) 1832, a slippage-cost component 1833, and an operational-cost component 1834. Stochastic sampler 1840 (e.g., a Monte Carlo sampler) can sample distributions over p, σ, N, and φ 1841, can compute tAPY per sample 1842, and can output lower, median, and upper confidence bounds 1843.

Inputs 1850 to a slippage estimator computing σ=1/(1+2pΔx/TVL) can include on-chain pool reserves 1851 and an oracle feed 1852. The closed-form tAPY computation 1820 can produce a gross tAPY 1860 (point estimate). The engine 1800 can further produce a net-of-fee tAPY 1861 by applying fee parameters 1862 (e.g., management and performance fees), a risk-adjusted tAPY 1863 (e.g., Sharpe or Sortino ratio), and a forecast-versus-realized tAPY comparison 1864 that may emit a divergence alert to the AI Sentinel detector outputs of FIG. 14 when the realized tAPY diverges from the forecast tAPY by more than a threshold for a persistence window. Output to vault health status interface 1870 can present one or more of the gross tAPY 1860, the net-of-fee tAPY 1861, the risk-adjusted tAPY 1863, the component decomposition 1830, and the confidence bounds 1843 to users and integrators of the system.

The technical environment of decentralized-finance yield aggregation further presents a problem that other automated rebalancing arrangements have not adequately addressed. Although individual building blocks have been described, such as multi-strategy vault primitives that allocate by quoted annual percentage yield, real-time decentralized-finance monitoring services, agent-based simulation methodologies for parameter selection, and academic frameworks for portfolio optimization including mean-variance, risk-parity, and conditional-value-at-risk formulations, these building blocks may not be integrated into a single rebalance pathway in which (a) the optimization objective is expressed in terms of a user-realized effective annual yield computed by a closed-form yield engine that accounts for compounding frequency, reward-token conversion, slippage, and per-cycle operational cost, (b) the optimization is gated by a pre-execution stress-test layer that simulates the candidate weight vector under one or more scenarios prior to permitting on-chain execution, (c) the optimization is directly coupled to a per-strategy unified risk score from a contemporaneous risk-monitoring module such that strategies whose risk is rising are penalized or excluded, and (d) every rebalance decision is committed on-chain through an audit record that allows the off-chain decision to be independently reproduced and reviewed. The interaction of these features produces a rebalance pathway whose outputs reflect realized rather than quoted yields, whose execution is constrained by stress-test consequences rather than by quoted yield differentials alone, and whose conduct is publicly auditable rather than privately determined.

Other automated rebalancing arrangements have generally taught away from each of these integrations: pre-execution simulation has been avoided as gas-prohibitive when conducted on-chain and as opaque when conducted off-chain without a corresponding on-chain commitment; coupling of a rebalance objective to a contemporaneous risk score has been avoided because of the absence of a unified risk-score primitive at the vault layer; and tAPY-based objectives have been avoided in favor of quoted-APY heuristics because no closed-form yield engine accounting for slippage and compounding has been embedded in the vault control loop. The arrangements described herein address these concerns through, among other features, an off-chain decision engine that consumes the unified risk score and the per-strategy effective annual yield as inputs to a constrained optimization, a pre-execution stress-test layer whose results are committed on-chain together with the resulting target weight vector, and a closed-form tAPY engine whose component-wise outputs are exposed for inspection and for use as objective-function terms by the rebalancer.

In some embodiments, the True APY (tAPY) calculation engine described above can implement the user's net effective yield as the closed-form expression tAPY=(1+[(1+α₀)\hat{ }(1/N)−1 ]+p·σ·[(1+α₁)\hat{ }(1/N)−1 ])\hat{ }N−1−(N·φ)/S, where α₀ is the base APY of the underlying strategy, α₁ is the bonus APY arising from any incentive reward tokens, p is the conversion rate of the reward token to the deposit asset (or another selected accounting asset), σ is a slippage factor associated with converting reward tokens to the deposit asset, N is the compounding frequency expressed as the number of harvest-and-reinvest cycles per year, φ is a per-cycle operational cost (such as gas and transaction cost), and S is the principal investment amount. In some embodiments, when φ is small relative to (S/N) or when N is small, the engine may use a simplified expression of the form tAPY≈α₀+p·σ·α₁. Reference is made to FIG. 18 for an example embodiment of the engine.

In some embodiments, the slippage factor σ is not held constant, but is estimated as a function of pool depth and conversion size by the relation σ=1/(1+(2·p·Δx)/TVL ), where Δx is the amount of reward token to be converted, TVL is the total value locked in the pool used for the conversion, and p is the prevailing market price of the reward token. In some embodiments, σ is recomputed at each evaluation step using current on-chain pool reserves obtained through the strategy interface registry, or through one or more decentralized oracle feeds (such as Chainlink-style, Pyth-style, or RedStone-style feeds), so that the displayed tAPY reflects real-time liquidity conditions rather than a static assumption.

In some embodiments, the tAPY engine produces a component-wise decomposition of yield rather than a single scalar, the decomposition comprising at least: (i) a base-yield component derived from α₀; (ii) a reward-yield component derived from α₁ and discounted by the conversion factor p·σ; (iii) a slippage-cost component computed as the difference between the gross reward yield α₁ and the realized reward yield p·σ·α₁; and (iv) an operational-cost component computed as N·φ/ S. In some embodiments, this decomposition is exposed by the vault health status interface so that users and integrators can inspect not only the aggregate tAPY but also the contribution and erosion attributable to each component.

In some embodiments, the tAPY engine computes a confidence interval around the point estimate by stochastic sampling. By way of example and not limitation, the engine draws Monte-Carlo samples from distributions over (a) reward-token price p, (b) slippage factor σ given current and projected pool depth, (c) compounding-frequency irregularities that perturb the effective N, and (d) per-cycle gas cost φ; computes tAPY for each sample using the closed-form expression above; and reports a lower-bound, point estimate, and upper-bound credible interval at a configurable confidence level (such as the 5th, 50th, and 95th percentiles of the sample distribution). In some embodiments, the confidence interval is presented to users as “tAPY=X % (range Y %−Z %)” rather than as a single point estimate, thereby preventing the miscommunication of inflated yields.

In some embodiments, the tAPY engine further computes one or more net-of-fee yields by applying the fee parameters of the smart fee minting mechanism described elsewhere herein, including any one or more of a deposit fee, a management fee, and a performance fee. The engine may report both gross tAPY and after-fee tAPY, the latter being the figure most relevant to a depositor.

In some embodiments, the tAPY engine further computes one or more risk-adjusted yield metrics, including any one or more of: a Sharpe-style ratio computed as (tAPY−r_f)/σ_returns, where r_f is a configurable risk-free rate and σ_returns is the realized standard deviation of vault returns over a configurable look-back window; a Sortino-style ratio using only downside deviation; and a Calmar-style ratio using maximum drawdown. The risk-adjusted metrics may be displayed alongside the tAPY through the vault health status interface.

In some embodiments, the tAPY engine maintains both a forecast tAPY (computed from the closed-form expression as above) and a realized tAPY (computed from observed vault share-price growth over a recent look-back window), and exposes the divergence between forecast and realized as a per-strategy signal. In some embodiments, when the realized tAPY for a strategy diverges below its forecast tAPY by a configurable threshold for a configurable persistence window, the engine emits a divergence alert to the AI Sentinel risk-monitoring module described elsewhere herein, where the alert is treated as an additional dynamic input to the Sentinel's detection ensemble. In this manner, the tAPY engine provides both a user-facing transparency function and an internal risk-anomaly function within the same calculation.

In some embodiments, the tAPY engine produces a per-strategy tAPY for each strategy in the strategy interface registry and a portfolio-level tAPY computed as a weight-aware aggregation of per-strategy tAPYs, the weights corresponding to the current target strategy-position weights. The per-strategy tAPYs are made available as inputs to the AI Rebalancer engine described elsewhere herein, so that the rebalancer's optimization objective is expressed in units that correspond to user-realized yield rather than quoted APY alone.

In some embodiments, the tAPY engine supports a continuous-compounding limit by taking N→∞ in the closed-form expression, yielding tAPY≈exp(ln(1+α₀)+p·σ·ln(1+α₁))−1, when the gas-cost term N·φ/S is either negligible or otherwise modeled separately. In some embodiments, the engine supports a stochastic-process embodiment in which the reward-token price p is modeled as a stochastic process (such as a geometric-Brownian-motion or a mean-reverting process) and tAPY is computed as the expected value of a path-integral under that process; this embodiment may be used for yield-curve forecasting and for the AI Rebalancer's predictive optimization.

In some embodiments, the AI Rebalancer engine introduced above is implemented as a constrained optimization core that consumes time-series strategy metrics (including quoted yield, realized yield, total value locked, capacity, transaction cost, bridge cost, and slippage estimates as previously described), the per-strategy and portfolio-level tAPY outputs of the True APY calculation engine described above, and the per-strategy unified risk score produced by the AI Sentinel risk-monitoring module described below, and produces a target weight vector that is provided to the rebalance routine for guardrail-validated execution. Reference is made to FIG. 17 for an example embodiment of the engine.

In some embodiments, the optimization is formalized as the maximization of a scalar utility function U(w) over a weight vector w whose entries are non-negative and sum to one (with an idle-weight entry, if applicable, included in the vector), subject to per-strategy capacity caps, per-rebalance turnover penalties, and one or more risk constraints. The utility function U(w) may be selected from any one or more of the following formulations, with the choice configurable per deployment:

A heuristic TVL-adjusted APY chaser, in which U(w) is approximated as a sum of per-strategy quoted APY adjusted by a slippage penalty that grows with the deployed amount relative to TVL, as previously described, and the optimizer alternates a gradient-ascent step with a projection step onto the simplex.

A mean-variance formulation, in which U(w)=w^{T}μ−(λ/2)·w^{T}Σw, where μ is the vector of per-strategy expected returns (which may be the per-strategy tAPYs from the True APY calculation engine), Σ is a covariance matrix of strategy returns estimated from a rolling look-back window, and λ is a configurable risk-aversion coefficient.

A risk-parity (equal-risk-contribution) formulation, in which the weights are chosen so that each strategy contributes substantially equal marginal risk to the portfolio, computed using Σ and a configurable risk measure.

A conditional-value-at-risk (CVaR) formulation, in which U(w) is the negative of the expected loss conditional on losses exceeding a configurable confidence threshold, computed by Monte-Carlo sampling from a joint return distribution of the strategies.

A Bayesian optimization formulation employing a Gaussian-process surrogate over the weight space, in which the optimizer iteratively proposes candidate weight vectors using an acquisition function (such as expected improvement or upper confidence bound), evaluates them through a stress-test simulator, and updates the surrogate; this formulation is particularly useful when the yield surface is non-convex with respect to capacity constraints.

A reinforcement-learning formulation, in which the rebalancer is a learned policy π_θ(s) that maps an observed state s (comprising current weights, recent strategy metrics, recent risk scores, recent realized tAPY divergence, and contextual variables) to a target weight vector, where θ is trained by policy-gradient or actor-critic methods on historical and simulated data and is updated on a configurable cadence.

A contextual-bandits formulation, in which the rebalancer treats each rebalance opportunity as an arm-selection problem with regret bounds, suitable for online learning when the yield surface is non-stationary.

In some embodiments, the optimization is multi-objective, jointly considering at least two of: realized yield (via per-strategy tAPY), portfolio risk (via Σ or via the AI Sentinel's per-strategy risk scores), turnover cost (proportional to the L1 norm of the change in weights times an estimated execution cost), gas cost (a function of the number and size of strategy transactions), and bridge cost (when the optimization is cross-chain). In some embodiments, the multi-objective problem is scalarized using a weighted sum, an ε-constraint method, or a Chebyshev distance to an ideal point; in other embodiments, the optimizer maintains and reports a Pareto frontier of non-dominated allocations from which the strategist or governance role selects.

In some embodiments, the AI Rebalancer engine includes a pre-execution stress-test layer that simulates the candidate target weight vector through one or more scenarios prior to execution. By way of example and not limitation, the stress-test layer may employ agent-based simulation tuned to recent on-chain data (in which agents representing borrowers, liquidators, liquidity providers, and arbitrageurs are simulated under stressed market conditions), Monte-Carlo simulation over a calibrated joint return distribution, or a deterministic worst-case scenario set. The candidate weight vector is rejected or modified if the stress-test layer reports any one of: an unacceptable insolvency probability, an unacceptable expected liquidation, an unacceptable post-stress drift from target, or an unacceptable gas-or-bridge-cost overrun. In some embodiments, the stress-test layer is implemented off-chain and produces an auditable snapshot recorded together with the rebalance execution decision.

In some embodiments, the AI Rebalancer engine is directly coupled to the AI Sentinel risk-monitoring module described below, in any one or more of the following ways: (i) the per-strategy unified risk score from the Sentinel is incorporated as a coefficient in the optimization objective, increasing the penalty applied to allocations into strategies whose risk is rising; (ii) the per-strategy unified risk score is incorporated as a hard constraint, forbidding any allocation into a strategy whose risk score exceeds a configurable cutoff; (iii) when the Sentinel asserts a tier-T2 or higher action with respect to a strategy, the rebalancer's reachable-allocation set excludes that strategy from the optimization domain until the action is cleared; and (iv) when the realized-versus-forecast tAPY divergence emitted by the True APY calculation engine for a strategy crosses a configured threshold, the rebalancer treats that strategy as risk-flagged for purposes of the optimization until the divergence is resolved.

In some embodiments, the AI Rebalancer engine selects rebalance trigger events from any one or more of: the drift threshold previously described; a time-elapsed trigger that schedules a baseline rebalance at a configurable cadence; an event-driven trigger that fires on specified state changes (such as a material change in a strategy's quoted APY, capacity, or whitelist status); a confidence-gated trigger that fires only when the rebalance is expected, under the stress-test layer, to improve the chosen utility function by at least a configurable margin net of execution cost; and a cooling-off rule that delays a subsequent rebalance for a configurable interval after a large rebalance, in order to limit churn.

In some embodiments, the AI Rebalancer engine extends to cross-chain rebalancing through the cross-chain coordination routine and cross-chain token handling subsystem disclosed elsewhere herein, by treating bridge cost, bridge latency, and bridge risk score (as supplied by the AI Sentinel's cross-chain bridge vector R_xchain) as additional inputs to the optimization. In some embodiments, when the optimizer recommends a cross-chain reallocation, the candidate weight vector is annotated with a bridge plan specifying the bridge to be used, the amount to be bridged, and the expected confirmation horizon, and the bridge plan is itself subject to the guardrail routine.

In some embodiments, the AI Rebalancer engine operates in any one of: a fully automated mode in which the off-chain optimizer, on satisfying the trigger conditions and stress test, causes a wallet holding a rebalancer role to submit setWeights and rebalance transactions on-chain; a propose-only mode in which the optimizer publishes a proposed transaction (such as to a multi-signature queue) but does not execute it; and a co-signing mode in which the optimizer publishes a proposed transaction that is executed only after review and signing by a client-controlled multi-signature.

In some embodiments, every output of the AI Rebalancer engine—including its inputs, the selected utility function and its hyperparameters, the optimizer's algorithm version, the candidate weight vector, the stress-test result, the selected execution mode, and a human-readable rebalance reason—is committed to an auditable snapshot record as previously described, so that each rebalance decision can be independently reproduced and reviewed. In some embodiments, the auditable snapshot is committed on-chain as a cryptographic hash record together with the rebalance transaction itself, such that the on-chain artifact constitutes a public, independently verifiable commitment to the off-chain Rebalancer decision and its inputs, parameters, and stress-test result, without requiring disclosure of the underlying private payloads.

In some embodiments, the reinforcement-learning policy used by the AI Rebalancer engine is parameterized as a feed-forward neural network having an input layer corresponding to a state vector comprising at least: current weights, recent per-strategy quoted yield observations, recent per-strategy tAPY observations, the unified risk score from the AI Sentinel module for each strategy, the current drift between current and target weights, recent realized-versus-forecast tAPY divergence, recent transaction cost observations, and one or more configurable contextual variables; an output layer corresponding to an action vector of weight deltas constrained to the simplex; and a reward function computed as the change in portfolio tAPY between the current and proposed allocations net of estimated execution cost, less a penalty term proportional to the change in unified risk score and less an additional penalty term proportional to the L1 norm of the weight change. The policy is trained by an actor-critic method or a proximal-policy-optimization method on a corpus of historical on-chain data and on rollouts from the pre-execution stress-test layer described above, and is updated on a configurable cadence of one to four weeks.

In some embodiments, the Bayesian-optimization embodiment of the AI Rebalancer engine uses a Gaussian-process surrogate over the weight space with a Matérn kernel of smoothness parameter ν equal to 5/2 and an upper-confidence-bound acquisition function with a configurable exploration coefficient β; in some embodiments, candidate weight vectors proposed by the acquisition function are evaluated through the pre-execution stress-test layer rather than against live strategy state, so as to avoid expending principal on exploration; and in some embodiments, the surrogate is reset on a configurable cadence to accommodate non-stationarity in the underlying yield surface.

In some embodiments, the agent-based-simulation embodiment of the pre-execution stress-test layer is calibrated to recent on-chain data through one or more of: matching of empirical distributions of borrow-and-repayment volumes, calibration of liquidator behavioral parameters to observed liquidation transactions, calibration of arbitrageur behavioral parameters to observed cross-venue price differentials, and matching of empirical distributions of liquidity-provider deposit and withdrawal flows. The simulator runs a configurable number of trajectories (such as 100 to 10,000 trajectories per scenario set) under each stress scenario, and the candidate weight vector is rejected or modified if any one or more of the following thresholds is breached across the trajectory ensemble: an insolvency probability above a configured cutoff, an expected liquidation above a configured cutoff, a post-stress drift from target above a configured cutoff, or a probability-weighted gas-or-bridge-cost above a configured cutoff.

In some embodiments, the Monte-Carlo sampler of the True APY calculation engine draws samples from configurable distributions over the inputs of the closed-form tAPY expression, including without limitation: a log-normal distribution over reward-token price p with parameters fitted to a recent rolling window of observed prices; a beta or truncated-normal distribution over the slippage factor σ with parameters set by recent pool-depth observations; a Poisson or geometric distribution over compounding-cycle inter-arrival times that perturbs the effective compounding frequency N; and a log-normal distribution over per-cycle gas cost φ fitted to recent observed gas prices. The number of samples is configurable (such as 1,000 to 100,000) and the resulting tAPY distribution is summarized by configurable percentiles (such as the 5th, 50th, and 95th percentiles).

In some embodiments, the deterministic invariant gates applied to the AI Rebalancer engine's output (whether produced by the reinforcement-learning policy, the Bayesian-optimization embodiment, or another optimization formulation) include, without limitation: (i) a whitelist-consistency gate verifying that every weighted target strategy is on the strategist-whitelisted set; (ii) a magnitude-consistency gate verifying that the L1 norm of the weight change does not exceed a per-rebalance movement-size cap maintained by the guardrail routine; (iii) a risk-tier-consistency gate verifying that no strategy carrying a unified risk score in a tier above a configured cutoff receives a non-zero target weight; and (iv) a stress-pass gate verifying that the candidate weight vector has passed the pre-execution stress-test layer. Any candidate weight vector that fails an invariant gate is logged together with the failure reason and discarded without on-chain effect.

In some embodiments, the on-chain commitment record described above for each rebalance decision is implemented as a fixed-size cryptographic hash digest (such as a 256-bit SHA-256 digest) of a structured payload comprising at least: the inputs of the off-chain decision engine at the time of the decision, the version identifier of the optimization algorithm used, the hyperparameters of the optimization, the proposed target weight vector, the stress-test layer result, and a timestamp. The structured payload is stored on a content-addressed off-chain storage system and referenced by hash on-chain, such that the off-chain decision is independently reproducible from the committed payload while not requiring the on-chain ledger to bear the full payload.

In some instances, the instructions further cause the processors to operate a True APY calculation engine configured to compute, for a strategy or for the vault, an effective annual yield expressed as a closed-form function of: a base annual percentage yield α₀ of the strategy, an incentive-reward annual percentage yield α₁ of the strategy, a conversion rate p between an incentive reward token and the deposit asset, a slippage factor σ associated with converting the incentive reward token to the deposit asset, a compounding frequency N representing harvest-and-reinvest cycles per year, and a per-cycle operational cost φ; and to expose, through a transparency interface, at least one output selected from the group consisting of: a component-wise decomposition of the effective annual yield, a stochastic-sampling-derived confidence interval around the effective annual yield, a net-of-fee effective annual yield, and a risk-adjusted yield ratio computed from the effective annual yield and a measure of return variability.

In some instances, the slippage factor σ is computed by a relation of the form σ=1/(1+(2·p·Δx)/TVL), where Δx is a conversion size and TVL is a total value locked in a liquidity pool used for the conversion, and wherein σ is recomputed at each evaluation step from current on-chain pool state or from one or more decentralized oracle feeds.

In some instances, the True APY calculation engine maintains both a forecast effective annual yield and a realized effective annual yield, and emits a divergence signal to a risk-monitoring module of the system when the realized effective annual yield deviates from the forecast effective annual yield for a strategy by more than a configurable threshold for a configurable persistence window.

In some instances, the rebalance routine is driven by an AI Rebalancer engine implementing a constrained optimization over per-strategy target weights and selecting a utility function from the group consisting of: a heuristic total-value-locked-adjusted yield maximization, a mean-variance formulation employing a covariance matrix of strategy returns, a risk-parity formulation, a conditional-value-at-risk minimization, a Bayesian optimization with a Gaussian-process surrogate, a reinforcement-learning policy, and a contextual-bandit formulation; wherein the optimization further employs a pre-execution stress-test layer that simulates a candidate weight vector under one or more scenarios prior to permitting execution; and wherein the optimization is coupled to a risk-monitoring module of the system such that a per-strategy risk score from the said module is incorporated as at least one of an objective-function coefficient and a hard constraint.

In some instances, the method can include computing, by a True APY calculation engine, an effective annual yield as a closed-form function of base yield α₀, reward yield α₁, conversion rate p, slippage factor σ, compounding frequency N, and per-cycle operational cost φ; computing, by an AI Rebalancer engine, a target strategy-position weight vector as the output of a constrained optimization in which at least one of (a) the per-strategy effective annual yield from the True APY calculation engine and (b) a per-strategy risk score from a risk-monitoring module is consumed as an input to an objective function; subjecting the candidate weight vector to a pre-execution stress test prior to executing the rebalance; and committing inputs, parameters, optimizer outputs, and stress-test results to an audit snapshot.

In some instances, the AI Rebalancer engine is implemented at least in part by an off-chain computing process, and wherein the system further causes the vault smart contract to emit, contemporaneously with each on-chain rebalance transaction, an on-chain commitment record comprising at least: (i) a cryptographic hash committing to the inputs of the off-chain optimizer at the time of the rebalance, (ii) a cryptographic hash committing to a configuration version identifier of the off-chain optimizer at the time of the rebalance, (iii) the proposed target weight vector, and (iv) a result indicator of the pre-execution stress-test layer, such that the on-chain commitment record provides a publicly verifiable artifact corresponding to the off-chain rebalance decision without requiring disclosure of the underlying optimizer payloads.

In some instances, the continuous monitoring step is implemented by reading on-chain state of each determined strategy through the strategy interface registry and combining said on-chain state with at least one external signal feed obtained from a real-time threat-detection service, a decentralized monitoring network, or a redundant decentralized price-oracle feed, and the triggering event is identified when a multi-source consensus condition is satisfied across at least two independent signal sources. In some embodiments, the determination of a reallocation amount, when reallocation is permitted by the reallocation guidelines, is computed by an off-chain decision engine using as inputs at least a per-strategy effective annual yield computed by a True APY calculation engine according to a closed-form function of compounding frequency, reward-token conversion rate, slippage factor, and per-cycle operational cost, and a per-strategy unified risk score computed by a risk-monitoring module of the system, and an on-chain commitment record corresponding to the off-chain decision is emitted contemporaneously with the resulting on-chain reallocation transaction.

In some instances, the rebalance control process disclosed herein is distinguished from generic portfolio rebalancing in that each step is bound to a blockchain-rooted technical operation: current strategy-position values are obtained by reading on-chain strategy share balances and translating them through the strategy interface registry's standardized previewRedeem or convertToAssets functions; target strategy-position values are computed by an off-chain decision engine that consumes per-strategy effective annual yields from the True APY calculation engine and per-strategy unified risk scores from the AI Sentinel risk-monitoring module; guardrail validation is enforced by smart-contract-level access-control restrictions, allowlists, and structural constraints rather than by external supervision; and execution is recorded as an on-chain transaction whose audit trail is publicly verifiable and immutable. The rebalance process therefore operates as a technical solution to the problem of coordinating heterogeneous on-chain yield positions under role-bounded automated control, rather than as a computer implementation of a financial concept.

In some embodiments, the wrapper architecture disclosed herein is distinguished from generic adapter-pattern implementations in that it solves a problem inherent to the blockchain context: namely, that decentralized-finance protocols natively expose heterogeneous, non-standardized accounting interfaces (such as continuously-accruing receipt tokens, native interest-bearing positions, or bespoke deposit-and-withdraw mechanics), and that the absence of a canonical interface across protocols would otherwise prevent a single vault contract from valuing, allocating, or rebalancing across multiple protocols under one accounting framework. By translating each protocol-specific mechanic into a standardized share-and-asset model exposed to the vault core, the wrapper architecture enables uniform on-chain valuation, allocation, and redemption across a heterogeneous strategy set, an improvement that has no analog outside the blockchain context.

In some embodiments, the conditional withdrawal module disclosed herein is distinguished from conventional withdrawal handling in that it operates as a technical solution to a blockchain-finality-rooted problem: many on-chain yield strategies impose cooldowns, queue periods, or asynchronous-settlement constraints that are determined by the underlying smart contracts rather than by the vault, and that cannot be circumvented by the vault. The module accommodates these constraints by partitioning a withdrawal request into immediately satisfiable and deferred portions, escrowing or state-marking shares corresponding to the deferred portion to preserve accounting integrity across blocks, programmatically initiating the underlying-strategy exit process, and completing settlement when on-chain liquidity becomes available, in each case without requiring user-side interaction with the underlying strategy contracts. The module thereby enables the vault to combine instant-liquidity strategies with delayed-liquidity strategies under a single user-facing redemption interface, an improvement that has no analog outside the blockchain context.

The embodiments described herein provide several technical improvements over other digital asset management arrangements that arise specifically from the blockchain context. These can include, without limitation: a uniform on-chain valuation framework that translates heterogeneous protocol-specific accounting models into a single share-based balance through wrapper-exposed standardized interfaces; a rebalance control framework whose execution is bound by smart-contract-level role and allowlist restrictions rather than by external supervision; a withdrawal handling framework that accommodates asynchronous on-chain liquidity constraints through deferred-settlement records and share state-marking; an automated risk-monitoring framework that combines on-chain state reads with multi-source authenticated external feeds under a consensus condition no single feed can satisfy alone; an off-chain decision engine whose outputs are publicly committed on-chain through cryptographic digest emission; and a cross-chain coordination framework that maintains share-to-value accounting integrity across distinct blockchain networks through verified message attestations. Each of these features is enabled by, and only meaningful within, the blockchain-rooted architecture disclosed herein.

### Conclusion

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various machines may be used with programs written in accordance with teachings of the embodiments, or it may be more convenient to construct a specialized apparatus or system to perform the methods and techniques described herein.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the description pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a processor, the program code segments combine with the processor to provide a unique device that operates analogously to specific logic circuits.

The software is stored in a machine readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

1. A digital asset management system comprising:
one or more processors; and
memory storing instructions that, when executed by the one or more processors, cause the one or more processors to:
obtain, at a vault, a request to transfer a number of tokens for a user from a user device and a set of parameters specific to the user;
generate a first smart contract to transfer the number of tokens from a wallet associated with the user device and a wallet associated with the vault;
append a blockchain to include information relating to the first smart contract;
mint a number of vault tokens that correspond to the number of tokens deposited by the user and a first value for the number of tokens;
append the blockchain to include the number of minted vault tokens;
assign a first portion of the tokens to be held in an idle asset balance at the vault and a second portion of the tokens to be deployed via one or more strategies based on the set of parameters specific to the user;
determine a subset of the second portion of the tokens to be deployed according to each of the one or more strategies, each of the one or more strategies having a target value for the subset of the second portion of the tokens to be deployed for each strategy;
for each determined strategy:
generating a second smart contract for the subset of the second portion of tokens to be deployed according to each strategy; and
appending the second smart contract to the blockchain;
continuously monitor each of the determined strategies to determine whether a triggering event is present;
responsive to determining that a triggering event is detected for a first strategy:
determine whether the first strategy is within a set of reallocation guidelines;
if the first strategy is within the reallocation guidelines:
generate a third smart contract to disassociate the subset of the second portion of tokens associated with the first strategy; and
append information relating to the third smart contract to the blockchain; and
if the first strategy is not within the reallocation guidelines:
deny reallocation of the subset of the second portion of tokens associated with the first strategy.

2. The digital asset management system of claim 1, wherein the instructions further cause the processors to:
record the number of tokens, the first smart contract, and the number of vault tokens to a vault record;
responsive to generating the second smart contract, update the vault record to include the second smart contract; and
responsive to generating the third smart contract or determining that the first strategy is not within the reallocation guidelines, update the vault record to include the third smart contract or information relating to the denial of the reallocation of the first strategy.

3. The digital asset management system of claim 1, wherein the triggering event comprises a determination that any of the determined strategies has a value that exceeds a target value threshold or determining that any of the determined strategies have one or more risk parameters that exceed a threshold.

4. The digital asset management system of claim 1, wherein the set of reallocation guidelines include whether a slippage amount exceeds a threshold or whether a reallocation of the subset of the second portion of tokens exceeds a threshold percentage of tokens relative to a total of the number of tokens.

5. The digital asset management system of claim 1, wherein the instructions further cause the processors to:
generate a strategy interface registry that stores a number of interfaces for each strategy, wherein at least one of the interfaces comprises a wrapper or adapter exposing a standardized valuation or redemption function for any strategy lacking a native standardized vault interface.

6. The digital asset management system of claim 1, wherein the instructions further cause the processors to:
obtain a number of reward tokens from any of the one or more strategies;
mint a new set of vault tokens that corresponds with the number of reward tokens; and
append the blockchain to add the new set of vault tokens to the blockchain.

7. The digital asset management system of claim 6, wherein the instructions further cause the processors to:
store the number of reward tokens to the idle-asset balance or identifying any of the one or more strategies to deploy the number of reward tokens based on the set of parameters specific to the user.

8. The digital asset management system of claim 1, wherein the instructions further cause the processors to:
obtain a request to withdraw the number of tokens;
determine whether all of the number of tokens are capable of being unassigned from any of the one or more strategies;
responsive to determining that all of the number of tokens are capable of being unassigned, generate a fourth smart contract to unassign the tokens from the one or more strategies;
append the fourth smart contract to the blockchain; and
initiate a withdrawal of the number of tokens that corresponds with vault shares associated with the user.

9. The digital asset management system of claim 1, wherein the target value is determined using one or more inputs comprising a quoted yield, a realized yield, a current liquidity, a reward rate, a reward-token conversion rate, a slippage estimate, a total value locked, a total capacity, a transaction amount, a bridge amount, or risk data.

10. The digital asset management system of claim 1, wherein the instructions further cause the processors to:
implement a cross-chain coordination routine configured to maintain a settlement record associating issued vault shares with the number of tokens deployed across at least a first blockchain network and a second blockchain network, and to update the settlement record in response to verified cross-chain communications.

11. A computer-implemented method comprising:
assigning, at a vault, a first portion of the tokens to be held in an idle asset balance at the vault and a second portion of the tokens to be deployed via one or more strategies based on the set of parameters specific to the user;
determining a subset of the second portion of the tokens to be deployed according to each of the one or more strategies, each of the one or more strategies having a target value for the subset of the second portion of the tokens to be deployed for each strategy;
for each determined strategy:
generating a second smart contract for the subset of the second portion of tokens to be deployed according to each strategy; and
appending the second smart contract to the blockchain;
continuously monitoring each of the determined strategies to determine whether a triggering event is present;
responsive to determining that a triggering event is detected for a first strategy:
determining whether the first strategy is within a set of reallocation guidelines;
if the first strategy is within the reallocation guidelines:
generating a third smart contract to disassociate the subset of the second portion of tokens associated with the first strategy; and
appending information relating to the third smart contract to the blockchain; and
if the first strategy is not within the reallocation guidelines:
denying reallocation of the subset of the second portion of tokens associated with the first strategy.

12. The computer-implemented method of claim 11, further comprising:
obtaining a request to transfer a number of tokens for a user from a user device and a set of parameters specific to the user;
generating a first smart contract to transfer the number of tokens from a wallet associated with the user device and a wallet associated with the vault; and
appending a blockchain to include information relating to the first smart contract.

13. The computer-implemented method of claim 12, further comprising:
minting a number of vault tokens that correspond to the number of tokens deposited by the user and a first value for the number of tokens; and
appending the blockchain to include the number of minted vault tokens.

14. The computer-implemented method of claim 12, further comprising
recording the number of tokens, the first smart contract, and the number of vault tokens to a vault record;
responsive to generating the second smart contract, updating the vault record to include the second smart contract; and
responsive to generating the third smart contract or determining that the first strategy is not within the reallocation guidelines, updating the vault record to include the third smart contract or information relating to the denial of the reallocation of the first strategy.

15. The computer-implemented method of claim 11, wherein the triggering event comprises a determination that any of the determined strategies has a value that exceeds a target value threshold or determining that any of the determined strategies have one or more risk parameters that exceed a threshold.

16. The computer-implemented method of claim 11, wherein the set of reallocation guidelines include whether a slippage amount exceeds a threshold or whether a reallocation of the subset of the second portion of tokens exceeds a threshold percentage of tokens relative to a total of the number of tokens.

17. The computer-implemented method of claim 12, further comprising
generating a strategy interface registry that stores a number of interfaces for each strategy, wherein at least one of the interfaces comprises a wrapper or adapter exposing a standardized valuation or redemption function for any strategy lacking a native standardized vault interface.

18. The computer-implemented method of claim 12, further comprising
obtaining a number of reward tokens from any of the one or more strategies;
minting a new set of vault tokens that corresponds with the number of reward tokens; and
appending the blockchain to add the new set of vault tokens to the blockchain.

19. The computer-implemented method of claim 17, further comprising
storing the number of reward tokens to the idle-asset balance or identifying any of the one or more strategies to deploy the number of reward tokens based on the set of parameters specific to the user.

20. The computer-implemented method of claim 12, further comprising
obtaining a request to withdraw the number of tokens;
determining whether all of the number of tokens are capable of being unassigned from any of the one or more strategies;
responsive to determining that all of the number of tokens are capable of being unassigned, generating a fourth smart contract to unassign the tokens from the one or more strategies;
appending the fourth smart contract to the blockchain; and
initiating a withdrawal of the number of tokens that corresponds with vault shares associated with the user.

21. The computer-implemented method of claim 11, wherein the target value is determined using one or more inputs comprising a quoted yield, a realized yield, a current liquidity, a reward rate, a reward-token conversion rate, a slippage estimate, a total value locked, a total capacity, a transaction amount, a bridge amount, or risk data.

22. The computer-implemented method of claim 11, further comprising
implementing a cross-chain coordination routine configured to maintain a settlement record associating issued vault shares with the number of tokens deployed across at least a first blockchain network and a second blockchain network, and to update the settlement record in response to verified cross-chain communications.
